(19) United States
(12) Patent Application Publication
(10) Pub. No.: US 2025/0351141 A1
(43) Pub. Date: Nov. 13, 2025

(54) TRANSMISSION AND MULTIPLEXING OF UL CONTROL INFORMATION

(71) Applicant: Samsung Electronics Co., Ltd., Suwon-si (KR)

(72) Inventors: Emad Nader Farag, Flanders, NJ (US); Aristides Papasakellariou, Houston, TX (US); Eko Onggosanusi, Coppell, TX (US); Dalin Zhu, Allen, TX (US)

(21) Appl. No.: 19/186,526

(22) Filed: Apr. 22, 2025

Related U.S. Application Data
(60) Provisional application No. 63/644,339, filed on May 8, 2024.
(60) Provisional application No. 63/650,281, filed on May 21, 2024.
(60) Provisional application No. 63/694,577, filed on Sep. 13, 2024.
(60) Provisional application No. 63/753,701, filed on Feb. 4, 2025.

(51) Int. Cl. H04W 72/21; H04L 5/00; H04W 72/1268

(52) U.S. Cl. CPC H04W 72/21; H04L 5/0012; H04L 5/0044; H04W 72/1268

(57) ABSTRACT

Methods and apparatuses for uplink (UL) control information transmission and multiplexing. A method of operating a user equipment (UE) includes determining uplink control information (UCI), which is organized into N UCI type blocks, where N≥1 and each of the N UCI type blocks include one or more UCIs, determining an uplink shared channel (UL-SCH) transport block, and encoding and rate matching each of the encoded and rate matched N UCI type blocks. The method further includes multiplexing the N UCI type blocks with the UL-SCH transport block to generate block A, segmenting, encoding, rating match and concatenating block A to generate block B, mapping block B to resource elements of a physical uplink shared channel (PUSCH), and transmitting the PUSCH.

### CROSS-REFERENCE TO RELATED AND CLAIM OF PRIORITY

The present application claims priority under 35 U.S.C. § 119 (e) to U.S. Provisional Patent Application No. 63/644,339 filed on May 8, 2024; U.S. Provisional Patent Application No. 63/650,281 filed on May 21, 2024; U.S. Provisional Patent Application No. 63/694,577 filed on Sep. 13, 2024; and U.S. Provisional Patent Application No. 63/753,701 filed on Feb. 4, 2025, which are hereby incorporated by reference in their entirety.

### TECHNICAL FIELD

The present disclosure relates generally to wireless communication systems and, more specifically, the present disclosure relates to methods and apparatuses for uplink (UL) control information transmission and multiplexing.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to UL control information transmission and multiplexing.

In one embodiment, a user equipment (UE) is provided. The UE includes a processor configured to determine uplink control information (UCI), which is organized into N UCI type blocks, where N≥1 and each of the N UCI type blocks includes one or more UCIs, determine an uplink shared channel (UL-SCH) transport block, encode and rate match each of the encoded and rate matched N UCI type blocks, multiplex the N UCI type blocks with the UL-SCH transport block to generate block A, and segment, encode, rate match and concatenate block A to generate block B. The UE further includes a transceiver operably coupled to the processor. The transceiver is configured to map block B to resource elements of a physical uplink shared channel (PUSCH) and transmit the PUSCH.

In another embodiment, a base station (BS) is provided. The BS includes a transceiver configured to receive a PUSCH and extract from the PUSCH a block B corresponding to UCI. The BS further includes a processor operably coupled to the transceiver. The processor is configured to de-concatenate, de-rate match, decode and de-segment, block B to generate block A, de-multiplex block A to generate N UCI type blocks and UL-SCH transport block, de-rate match and decode each of the N UCI type blocks, extract one or more UCIs from each of the de-rate matched and decoded N UCI type blocks.

In yet another embodiment, a method of operating a UE is provided. The method includes determining UCI, which is organized into N UCI type blocks, where N≥1 and each of the N UCI type blocks include one or more UCIs, determining an UL-SCH transport block, and encoding and rate matching each of the encoded and rate matched N UCI type blocks. The method further includes multiplexing the N UCI type blocks with the UL-SCH transport block to generate block A, segmenting, encoding, rating match and concatenating block A to generate block B, mapping block B to resource elements of a PUSCH, and transmitting the PUSCH.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates a diagram of example physical uplink control channel (PUCCH) resource sets associated with uplink control information (UCI) according to embodiments of the present disclosure;

FIGS. 6A and 6B illustrate an example of a downlink (DL) medium access control (MAC) protocol data unit (PDU) and uplink (UL) MAC PDU according to embodiments of the present disclosure;

FIGS. 7A, 7B, 7C, and 7D illustrate timelines of example mapping according to embodiments of the present disclosure;

FIGS. 8A, 8B, and 8C illustrate diagrams of example UL transmission configurations according to embodiments of the present disclosure;

FIGS. 9A, 9B, and 9C illustrate diagrams of example UL transmission configurations according to embodiments of the present disclosure;

FIGS. 10A, 10B, and 10C illustrate diagrams of example UL transmission configurations according to embodiments of the present disclosure;

FIG. 11 illustrates a diagram of an example UL transmission configuration according to embodiments of the present disclosure;

FIGS. 12A, 12B, and 12C illustrate diagrams of example UL transmission configurations according to embodiments of the present disclosure;

FIGS. 13A, 13B, and 13C illustrate diagrams of example UL transmission configurations according to embodiments of the present disclosure;

FIGS. 14A, 14B, and 14C illustrate diagrams of example UL transmission configurations according to embodiments of the present disclosure;

FIG. 15 illustrates a diagram of an example UL transmission configuration according to embodiments of the present disclosure;

FIGS. 16A, 16B, and 16C illustrate diagrams of example UL transmission configurations according to embodiments of the present disclosure;

FIG. 17 illustrates a diagram of an example UL transmission configuration according to embodiments of the present disclosure;

FIG. 18 illustrates a diagram of an example dynamic UL transmission configuration according to embodiments of the present disclosure;

FIG. 19 illustrates a diagram of an example dynamic UL transmission configuration according to embodiments of the present disclosure;

FIG. 20 illustrates a diagram of an example dynamic UL transmission configuration according to embodiments of the present disclosure;

FIG. 21 illustrates a diagram of example channel coding for UL transmission according to embodiments of the present disclosure;

FIG. 22 illustrates a diagram of example channel coding for UL transmission according to embodiments of the present disclosure;

FIG. 23 illustrates a diagram of example physical uplink shared channel (PUSCH) processing according to embodiments of the present disclosure;

FIG. 24 illustrates a diagram of example multiplexing according to embodiments of the present disclosure;

FIG. 25 illustrates a diagram of example multiplexing according to embodiments of the present disclosure;

FIG. 26 illustrates a diagram of an example MAC PDU configuration according to embodiments of the present disclosure;

FIG. 27 illustrates a diagram of example UL multiplexing/processing according to embodiments of the present disclosure;

FIG. 28 illustrates a diagram of an example PUSCH block configuration according to embodiments of the present disclosure;

FIGS. 29A and 29B illustrate diagrams of example PUSCH block configurations according to embodiments of the present disclosure;

FIG. 30 illustrates a diagram of an example PUSCH block configuration according to embodiments of the present disclosure;

FIG. 31 illustrates a diagram of an example PUSCH block configuration according to embodiments of the present disclosure;

FIG. 32 illustrates a diagram of an example PUSCH block configuration according to embodiments of the present disclosure;

FIG. 33 illustrates a diagram of an example PUSCH block configuration according to embodiments of the present disclosure;

FIG. 34 illustrates a diagram of example UL multiplexing/processing according to embodiments of the present disclosure;

FIG. 35 illustrates a diagram of an example PUSCH block configuration according to embodiments of the present disclosure;

FIGS. 36A and 36B illustrate diagrams of example PUSCH block configurations according to embodiments of the present disclosure;

FIG. 37 illustrates diagrams of example of multiplexing uplink shared channel (UL-SCH) and uplink control information (UCI) types according to embodiments of the present disclosure;

FIG. 38 illustrates a diagram of an example of multiplexing UL-SCH and UCI type according to embodiments of the present disclosure; and

FIG. 39 illustrates an example method performed by a UE in a wireless communication system according to embodiments of the present disclosure.

### DETAILED DESCRIPTION

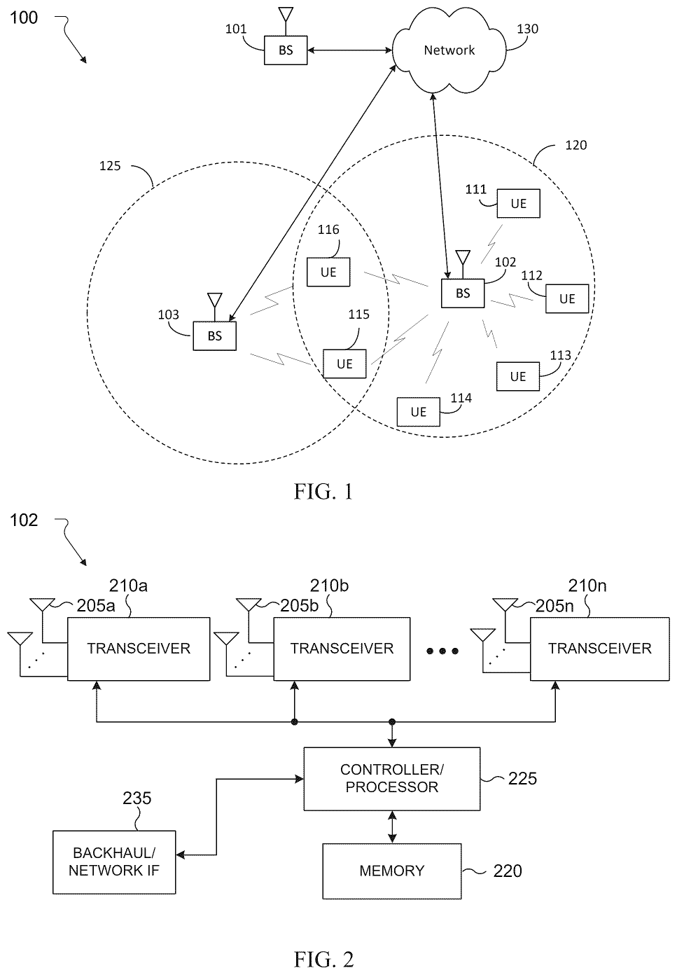

FIGS. 1-39, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mm Wave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 38.211 v18.2.0 and v18.5.0, “NR; Physical channels and modulation;” [REF 2] 3GPP TS 38.212 v18.2.0 and v18.5.0, “NR; Multiplexing and Channel coding;” [REF 3] 3GPP TS 38.213 v18.2.0 and v18.5.0, “NR; Physical Layer Procedures for Control;” [REF 4] 3GPP TS 38.214 v18.2.0 and v18.5.0, “NR; Physical Layer Procedures for Data;” [REF 5] 3GPP TS 38.321 v18.1.0 and v18.4.0, “NR; Medium Access Control (MAC) protocol specification;” and [REF 6] 3GPP TS 38.331 v18.1.0 and v18.4.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing UL control information transmission and multiplexing. In certain embodiments, one or more of the BSs 101-103 include circuitry, programing, or a combination thereof to support reception and demultiplexing of UL control information.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as to support reception and demultiplexing of UL control information. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

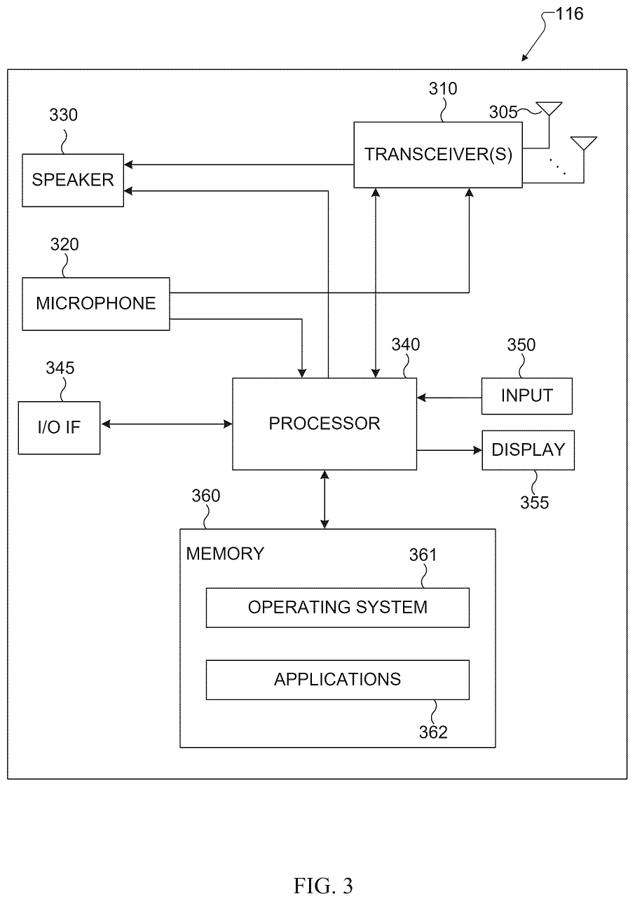

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for performing UL control information transmission and multiplexing as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

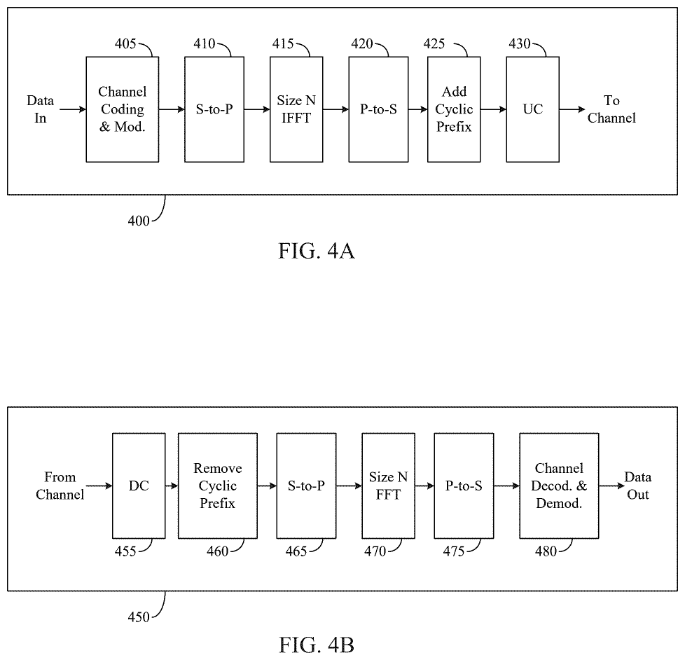

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured to transmit multiplexed UL control information as described in embodiments of the present disclosure. In some embodiments, the receive path 450 is configured to receive multiplexed UL control information as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems (see also [REF 1]).

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE (e.g., the UE 116) can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB (e.g., the BS 102) transmits one or more of multiple types of RS including channel state information RS (CSI-RS) and demodulation RS (DMRS)—see also [REF 1]. A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used (see also [REF 3]). A CSI process includes NZP CSI-RS and CSI-IM resources. A UE can determine CSI-RS transmission parameters through DL control signaling or higher layer signaling, such as radio resource control (RRC) signaling from a gNB (see also [REF 5]). Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access (see also REF 1). A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in its buffer, link recovery request (LRR) for beam failure recovery, UE initiated (UEI) indicator for initiated beam report, and CSI reports enabling a gNB to select appropriate parameters for PDSCH or PDCCH transmissions to a UE. A CSI report can include a single part, or for two parts (e.g., part 1 CSI and part 2 CSI). HARQ-ACK information can be configured to be with a smaller granularity than per TB and can be per data code block (CB) or per group of data CBs where a data TB includes a number of data CBs. A CSI report from a UE can include a channel quality indicator (CQI) informing a gNB of a largest modulation and coding scheme (MCS) for the UE to detect a data TB with a predetermined block error rate (BLER), such as a 10% BLER (see also [REF 3]), of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random access channel (physical random access channel (PRACH), see also [REF 3] and [REF 4]).

The UL control information (UCI) can be multiplexed on physical uplink control channel (PUCCH). There are 5 PUCCH formats, depending on the length of the PUCCH format (number of symbols of the PUCCH format), and the UCI payload size as illustrated in Table 1.

TABLE 1

| | UCI payload 1 | UCI payload more |
|---|---|---|
| | or 2 bit | than 2 bits |
| PUCCH length 1 or 2 symbols | PUCCH Format 0 | PUCCH Format 2 |
| PUCCH length 4 to 14 | PUCCH Format 1 | PUCCH Format 3 or 4 |
| symbols | | |

PUCCH Format 4, has 1 physical resource block (PRB), and multiplex 2 or 4 users on the same physical resource using different spreading codes.

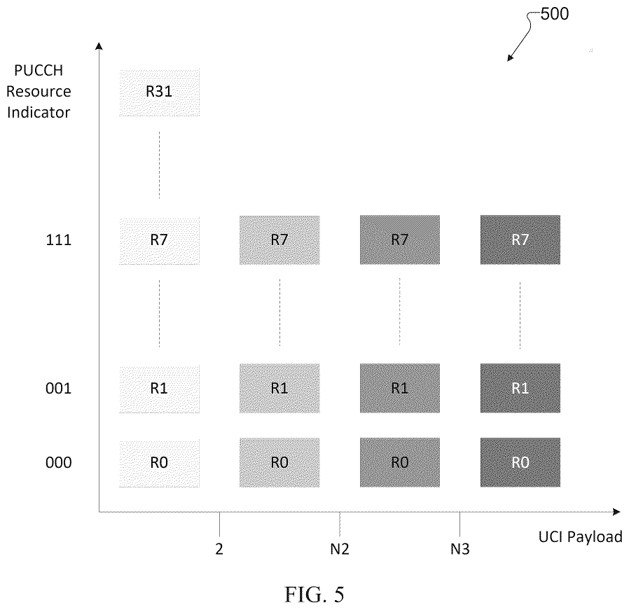

FIG. 5 illustrates a diagram of example PUCCH resource sets 500 associated with UCI according to embodiments of the present disclosure. For example, PUCCH resource sets 500 can be utilized by any of the UEs 111-116 of FIG. 1. This example is for illustration only and other embodiments can be used without departing from the scope of the present disclosure.

The network (e.g., the network 130) can configure 4 PUCCH resource sets, where each PUCCH resource set is associated with a UCI payload size. The first PUCCH resource set is used for payload size ≤2 bits and can have up to 32 PUCCH resources. The second PUCCH resource set is used for 2<payload size ≤N₂. The third PUCCH resource set is used for N₂<payload size≤N₃. The fourth PUCCH resource set is used for payload size >N₃. Each of the second, third and fourth PUCCH resource sets can have 8 PUCCH resources. This is illustrated in FIG. 5. A PUCCH resource is determined by PUCCH resource index (PRI), channel control element (CCE) index (when payload size is 1 or 2 bits) and payload size. The maximum UCI payload size is 1706 bits.

When the CSI report is a single part, the UE multiplexes, the HARQ-ACK information, the scheduling request and the CSI information into a single UCI message, this message is then encoded, rate-matched, scrambled, modulated and mapped to the resource elements of PUCCH not used for DMRS. When the CSI report has two parts, a first part CSI and a second part CSI. The first part UCI information includes HARQ-ACK information, scheduling request and first part CSI. The second part UCI information includes a second part CSI. The mapping of UCI information to PUCCH resource element is performed as follows:
First, the first part UCI information is mapped to PUCCH OFDM symbols that are closest to DMRS symbols.
Next, the second part UCI information is mapped to the remaining PUCCH resource elements.

When a PUCCH transmission overlaps with a PUSCH transmission, the UCI information is multiplexed onto the PUSCH channel:
First HARQ-ACK information is multiplexed into PUSCH starting from the first OFDM symbol after the first DMRS symbol in each frequency hop.
Next, the first part CSI is multiplexed into PUSCH starting from the first OFDM symbol of each frequency hop.
Next, the second part CSI is multiplexed into PUSCH after the first part CSI.
Finally, the transport block from higher layers is multiplexed into the remaining PUSCH resource elements not used for other purposes.

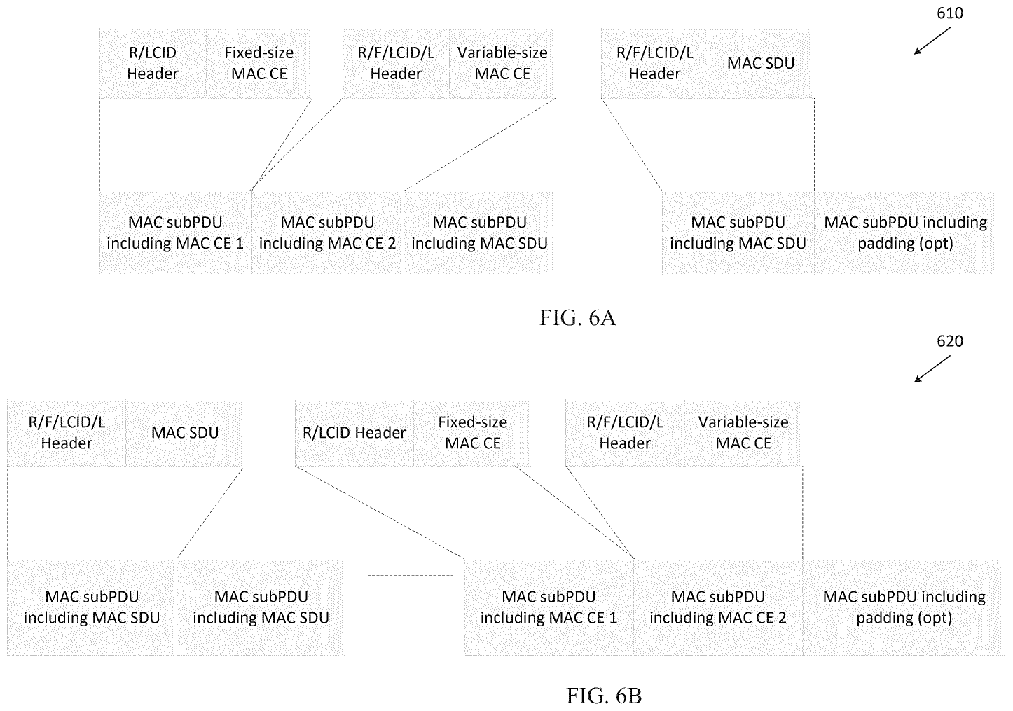

FIGS. 6A and 6B illustrate an example of DL MAC PDU 610 and UL MAC PDU 620, respectively, according to embodiments of the present disclosure. For example, DL MAC PDU 610 may be transmitted by any BS, such as the BS 102 of FIG. 1, while UL MAC PDU 620 may be transmitted by any of the UEs 111-116 of FIG. 1, such as the UE 111. This example is for illustration only and other embodiments can be used without departing from the scope of the present disclosure.

A transport block from higher layers includes MAC PDU, which can include one or more of
Fixed-size MAC CE(s).
Variable size MAC CE(s).
MAC SDU(s)
Optional padding.

A DL MAC PDU (e.g., transport block) is shown in FIG. 6A. An UL MAC PDU (e.g., transport block) is shown in FIG. 6B.

This disclosure provides various mapping and multiplexing options of UL control information on to UL physical channels to simplify UL control information transmission.

As mentioned herein, in NR, there are different PUCCH formats for transmission of UL control information, in addition to transmitting UL control information in PUSCH, when a PUCCH channel overlaps in time with a PUSCH channel. Embodiments of the present disclosure recognizes that this increases the complexity of the multiplexing and transmitting of the UL control information. To address this issue, using PUCCH when the UCI payload is small is provided. For larger payloads, UCI can be mapped to and multiplexed on PUSCH channel or a PUSCH-like channel. Different types of UL control channel information can have different characteristics, e.g., different error protection requirements, or different latency requirements. In this disclosure the container used for UL control information is provided. For example, the container can be a MAC CE-like message, or UCI-like message, each can have its own transport characterises. In some instances, different types of control information and other UL data can be multiplexed together, for example, the control information elements and the UL data have similar transport characteristics (latency, BLER, etc.). In other instances, the transport characteristics of the control information elements and UL data can be different, hence different containers can be used. In this disclosure a flexible design is proposed to cater for different scenarios.

The present disclosure relates to a 5G/NR and/or 6G communication system.

This disclosure provides aspects related to mapping and multiplexing of UL control information onto UL physical channels. This disclosure includes the following:
Type of physical UL channel used for UL control information can depend on the UCI payload size, and on whether UCI is being multiplexed with other UL traffic.
When control information elements and/or other UL data are multiplexed onto the same physical channel with different transport characteristics, different containers can be used that can be encoded with different code rates and that can be mapped differently on the physical channel.

In the following, both frequency division duplexing (FDD) and time division duplexing (TDD) are regarded as duplex methods for DL and UL signaling. In addition, full duplex (XDD) operation is possible, e.g., sub-band full duplex (SBFD) or single frequency full duplex (SFFD).

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure provides several components that can be used in conjunction or in combination with one another or can operate as standalone schemes.

In this disclosure, RRC signaling (e.g., configuration by RRC signaling) includes (1) common information provided by common signaling, e.g., this can be system information block (SIB)-based RRC signaling (e.g., SIB1 or other SIB) or (2) RRC dedicated signaling that is sent to a specific UE wherein the information can be common/cell-specific information or dedicated/UE-specific information or (3) UE-group RRC signaling.

In this disclosure MAC CE signaling can be UE-specific e.g., to one UE or can be UE common (e.g., to a group of UEs). MAC CE signaling can be DL MAC CE signaling or UL MAC CE signaling.

In this disclosure L1 control signaling includes: (1) DL control information (e.g., DCI on PDCCH or DL control information on PDSCH) and/or (2) UL control information (e.g., UCI on PUCCH or PUSCH). L1 control signaling be UE-specific e.g., to one UE or can be UE common (e.g., to a group of UEs).

In this disclosure, configuration can refer to configuration by semi-static signaling (e.g., RRC or SIB signaling). In one example, a configuration can be applicable to multiple transmission instances, until a new configuration is received and applied.

In this disclosure, indication can refer to indication by dynamic signaling (e.g., L1 control (e.g., DCI Format) or MAC CE signaling). In one example, an indication can be for an associated occasion(s) (e.g., an occasion or multiple occasions associated with the indication).

In this disclosure a list with N elements can be denoted as L(i), where i can take N values, and L(i) can correspond to the element or entry associated with index i. In one example, i can take N arbitrary values. In one example, i=0, 1, . . . , N−1. In one example, i=1, 2, . . . , N. In one example, i is an identity of an element in the list.

In the present disclosure, the term “activation” describes an operation wherein a UE receives and decodes first information provided by a first signal from the network (or gNB (e.g., the BS 102)) and, based on the first information, the UE determines a starting point in time. The starting point can be a present or a future slot/subframe or symbol and the exact location is either implicitly or explicitly indicated or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and, based on the second information from the signal, the UE determines a stopping point in time. The stopping point can be a present or a future slot/subframe or symbol and the exact location is either implicitly or explicitly indicated or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group of RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

Terminology such as UCI, MAC CE, PUCCH, PUSCH, transport block and other terms are used for illustrative purposes and is therefore not normative. Other terms that refer to the same functions can also be used.

In this disclosure, UL control information can include the following UL control information types:
HARQ-ACK for DL transport blocks.
Scheduling request (SR).
Channel state information (CSI). In one example, CSI can be a single part CSI. In another example, CSI can be a two-part CSI, e.g., a first part CSI and a second part CSI.
Link recovery request (LRR), this can be similar to SR.
Beam indication/report (introduced in 3GPP Rel-19), e.g., UEI indicator and UEI beam report.
Transport format indication information, e.g., indicating modulation coding scheme (e.g., modulation order and/or code rate), and/or transport block size and/or resource allocation and/or HARQ related parameters and/or MIMO related parameters of data conveyed in the UL physical channel.

In one example, the information corresponding to each of the UL control information types mentioned herein can be transmitted independently, e.g., the information for each UL control information type is separately encoded and multiplexed or mapped onto the physical UL channel.

In another example, information corresponding to each of the UL control information types mentioned herein can be first multiplexed, and then jointly encoded, rate-matched, scrambled and/or modulated and mapped to resource elements of the corresponding physical UL channel. For example, in NR, when CSI has one part, the HARQ-ACK, SR and CSI information are multiplexed, and jointly pass through the encoding and transmission stages and are transmitted on PUCCH.

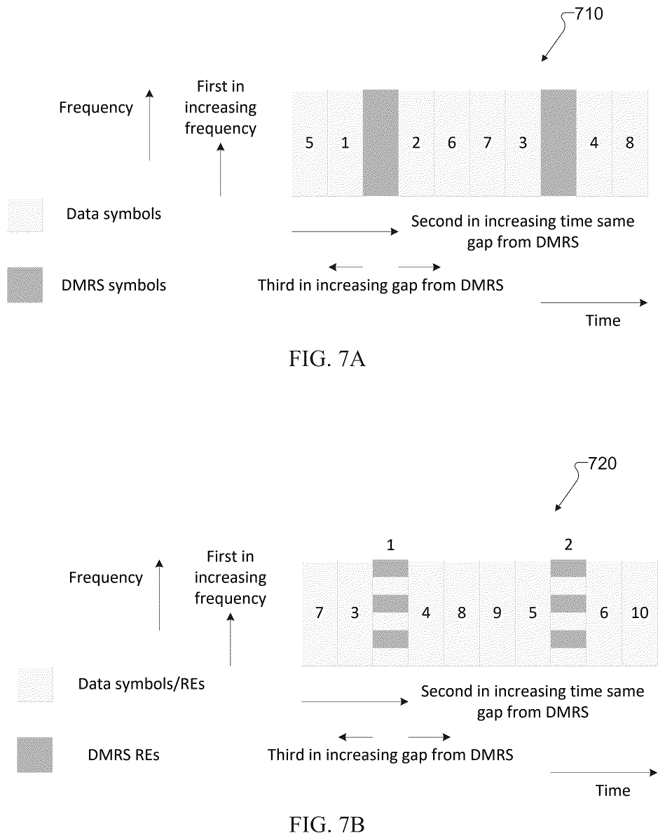

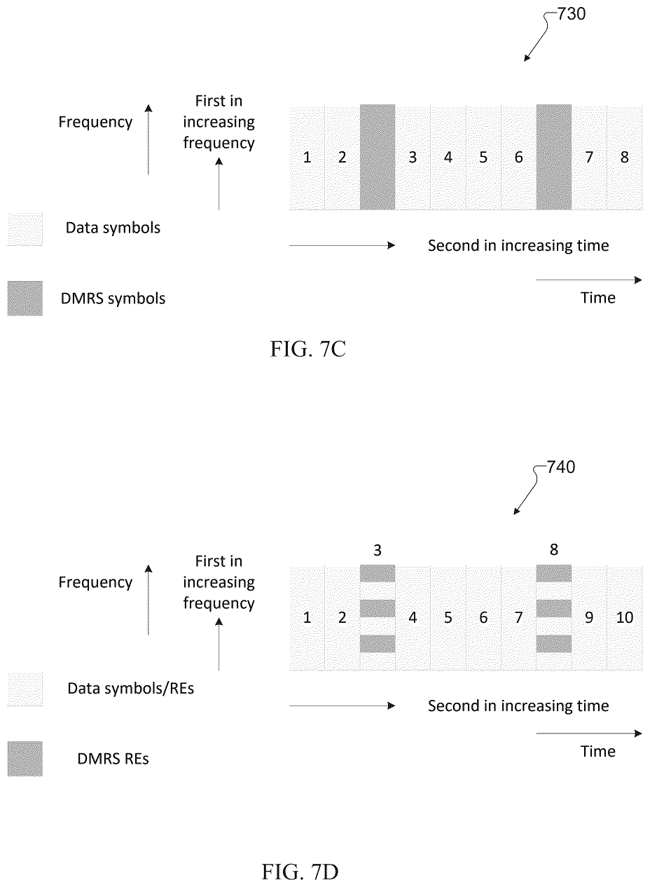

FIGS. 7A, 7B, 7C, and 7D illustrate timelines 710, 720, 730, and 740 respectively, of example mapping according to embodiments of the present disclosure. For example, timelines 710, 720, 730, and 740 respectively, can be followed by any of the UEs 111-116 of FIG. 1, such as the UE 112. This example is for illustration only and other embodiments can be used without departing from the scope of the present disclosure.

In another example, the UL control information types are divided into groups, where information corresponding to each group of UL control information types can be first multiplexed, and then jointly encoded, rate-matched, scrambled and/or modulated and mapped to resource elements of the corresponding physical UL channel. For example, in NR, when CSI has two parts, the HARQ-ACK, SR and first part CSI information are multiplexed to give first part of UCI, and jointly pass through the encoding and transmission stages and are transmitted on PUCCH. The second part CSI can be separately encoded and mapped to the remaining PUCCH resources. UL control information types that are multiplexed together and jointly encoded and transmitted can have similar transport characteristics. In one example, the first part UCI is mapped closer to the DMRS symbols, and then the second part UCI is mapped to DMRS symbols that are further out. Mapping order can be also as follows, as illustrated in FIG. 7A and FIG. 7B:

First in increasing order of frequency resources within each OFDM symbol.
Next in increasing symbol number for symbols that have the same time gap to closest DMRS symbol in the same frequency hop.
Finally, in increasing time gap from closest DMRS in the same frequency hop.
Mapping performed first for UCI part one symbols. Then for UCI part two symbols.

In FIG. 7A, as an example, REs of a symbol are allocated to DMRS, or there are no REs available for data, the first symbol selected for mapping is the first data symbol before the first DMRS symbol, starting with the first part UCI, first part UCI modulation symbols are mapped in increasing order of frequency, then first data symbol after the first DMRS symbol, then the first data symbol before the second DMRS symbol, then the first data symbol after the second DMRS symbol, then the second data symbol before the first DMRS symbol and so on. After the modulation symbols of the first part UCI are mapped, the modulation symbols of the second part UCI are mapped continuing in the same order.

In FIG. 7B, as an example, there are resource elements (REs) in the DMRS symbols available for data, the first symbol selected for mapping is the first DMRS symbol, starting with the first part UCI, first part UCI modulation symbols are mapped in increasing order of frequency, then second DMRS symbol, then first data symbol before the first DMRS symbol, then first data symbol after the first DMRS symbol, then the first data symbol before the second DMRS symbol, then the first symbol data after the second DMRS symbol, then the second data symbol before the first DMRS symbol and so on. After the modulation symbols of the first part UCI are mapped, the modulation symbols of the second part UCI are mapped continuing in the same order.

While the example given is for two parts, there can be multiple UL control information parts, for example a first part can include HARQ-ACK and SR, a second part can include part 1 CSI, and a third part can include part 2 CSI. In one example, the first UCI part is mapped to symbols that are closest to DMRS, followed by a second part UCI that are mapped following first UCI part to symbols that are closest to DMRS, followed by third part UCI to remaining resource elements and symbols. Mapping order to resource elements can be also as follows, as illustrated in FIG. 7A and FIG. 7B:
First in increasing order of frequency resources within each OFDM symbol.
Next in increasing symbol number for symbols that have the same time gap to closest DMRS symbol in the same frequency hop.
Finally, in increasing time gap from closest DMRS in the same frequency hop.
Mapping performed first for UCI part one symbols. Then for UCI part two symbols. Then for UCI part three symbols, and so on.

In an alternative to the mapping order of FIG. 7A, and FIG. 7B, the UCI modulation symbols are mapped to OFDM symbols with REs available for data transmission starting from the first OFDM symbol of the allocation as illustrated in FIG. 7C and FIG. 7D. Mapping order can be:
First in increasing order of frequency resources within each OFDM symbol.
Next in increasing symbol number.

In one example, the container for UL control information can be UCI-like message. One part UCI, or two part UCI or multiple part UCI, contents of each part are as previously described. In one example, the UCI messages can be multiplexed together, and with other UCI messages such as power headroom (PHR) UCI message and buffer status report (BSR) UCI message, hence have same transport characteristic with no distinction. In another example, each UCI message or each group of UCI messages is separately encoded and hence can have different transport characteristics.

In one example, the container for UL control information can be MAC CE message. One MAC CE corresponds to one part. Two MAC CEs correspond to two parts respectively. Multiple MAC CEs correspond to multiple parts respectively. Contents of each part can be as previously described. In one example, the MAC CEs can be multiplexed together, and with other MAC CEs such as power headroom (PHR) MAC CE and buffer status report (BSR) MAC CE, hence have same transport characteristic with no distinction. In another example, each MAC CE or each group of MAC CEs is separately encoded and hence can have different transport characteristics.

In one example, the container for UL control information can be RRC-like message. One RRC message corresponding to one part. Two RRC messages correspond to two parts respectively. Multiple RRC messages correspond to multiple parts respectively. Contents of each part can be as previously described. In one example, the RRC messages can be multiplexed together, and with other RRC messages such as power headroom (PHR) RRC message and buffer status report (BSR) RRC message, hence have same transport characteristic with no distinction. In another example, each RRC message or each group of RRC messages is separately encoded and hence can have different transport characteristics. In one example, RRC message ASN.1 format is used for UL control information. In the rest of this disclosure MAC CE message can refer to a MAC message or RRC message (e.g., message from higher layers).

In one example, the physical channel to use can depend on the size of the UCI payload and/or on whether UL data is transmitted with UCI.

In one example, if the size of UL control information is less than or equal to N₁ (e.g., N₁=2 or N₁=11) PUCCH format 0 or PUCCH Format 1 or a PUCCH Format X is used.

In one example, if size of UL control information is greater than N₁ (e.g., N₁=2) and less than or equal to N₂, e.g., N₂=11, PUCCH Format 4 in used.
In one example, PUCCH format 4 can have one PRB in frequency domain.
In one example, PUCCH format 4 can have 4 to 14 symbols.
In one example PUCCH format 4 can have 1 or 2 or 3 symbols.
In one example if N₁=N₂ and there is no PUCCH format 4

In one example, if the size of UL control information is greater than N₂ PUSCH can be used.

In one example, if physical channel to use for UL control information overlaps with a PUSCH (e.g., the PUSCH is carrying higher layer data, the UL control information is multiplexed onto the PUSCH.

In one example, SR can be multiplexed on a PUCCH Format.

In one example, SR can be multiplexed on PUCCH or on PUSCH, if PUSCH has no UL-SCH.

In one example, if SR occasion overlaps a PUSCH transmission, a buffer status report (BSR) can be transmitted in the PUSCH.

In one example, if the HARQ-ACK payload is less than or equal to N₂ bits, e.g., N₂=11, HARQ-ACK information is transmitted on PUCCH.

In one example, if the HARQ-ACK payload is more than N₂ bits, e.g., N₂=11, HARQ-ACK information is transmitted on PUSCH.

In one example, if the HARQ-ACK+SR payload is less than or equal to N₂ bits, e.g., N₂=11, HARQ-ACK and SR information are transmitted on PUCCH.

In one example, if the HARQ-ACK+SR payload is more than N₂ bits, e.g., N₂=11, HARQ-ACK and SR information are transmitted on PUSCH.

In one example, if the HARQ-ACK+SR payload is more than N₂ bits, e.g., N₂=11, HARQ-ACK and buffer status report are transmitted on PUSCH.

In one example, there can be more than one bit for SR in order to also indicate the logical channel (LCH) but if only 1-2 HARQ-ACK bits (PF0/PF1 used), the SR is identified by the SR resource used for PUCCH transmission.

In one example, if the HARQ-ACK+UEI indicator payload is less than or equal to N₂ bits, e.g., N₂=11, HARQ-ACK and SR information are transmitted on PUCCH.

In one example, if the HARQ-ACK+UEI indicator payload is more than N₂ bits, e.g., N₂=11, HARQ-ACK and SR information are transmitted on PUSCH.

In one example, if the HARQ-ACK+SR+UEI indicator payload is less than or equal to N₂ bits, e.g., N₂=11, HARQ-ACK and SR information are transmitted on PUCCH.

In one example, if the HARQ-ACK+SR+UEI indicator payload is more than N₂ bits, e.g., N₂=11, HARQ-ACK and SR information are transmitted on PUSCH.

In one example, if the CSI payload is less than or equal to N₂ bits, e.g., N₂=11, CSI information is transmitted on PUCCH.

In one example, if the CSI payload is more than N₂ bits, e.g., N₂=11, CSI information is transmitted on PUSCH.

In one example, regardless of CSI payload size, CSI can be transmitted on PUSCH. This can simplify resolution of PUCCH overlapping and multiplexing rules.

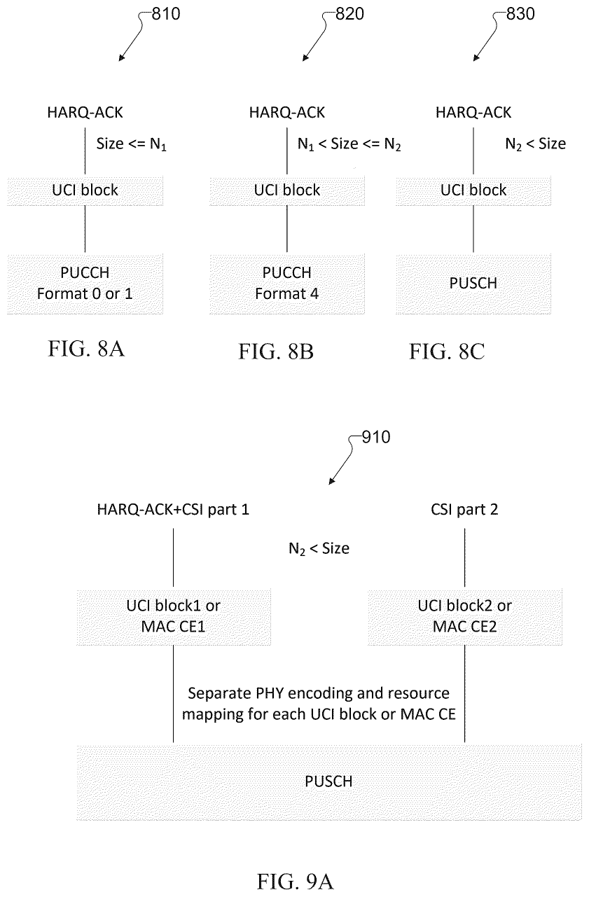

FIGS. 8A, 8B, and 8C illustrate diagrams of example UL transmission configurations 810, 820, and 830, respectively, according to embodiments of the present disclosure. For example, UL transmission configurations 810, 820, and 830, respectively, can be implemented by any of the UEs 111-116 of FIG. 1, such as the UE 113 of FIG. 1. This example is for illustration only and other embodiments can be used without departing from the scope of the present disclosure.

In one example in FIG. 8, UL control information includes HARQ-ACK information. The HARQ-ACK information is mapped to UCI block. If the HARQ-ACK information is less than or equal to N₁ bits (e.g., N₁=2), PUCCH format 0 or PUCCH format 1 is used to transmit the HARQ-ACK information (FIG. 8A). If the HARQ-ACK information is less than or equal to N₂ and more than N₁, PUCCH format 4 or PUCCH Format X is used to transmit the HARQ-ACK information. If the HARQ-ACK information is more than N₂, PUSCH is used to transmit the HARQ-ACK information.

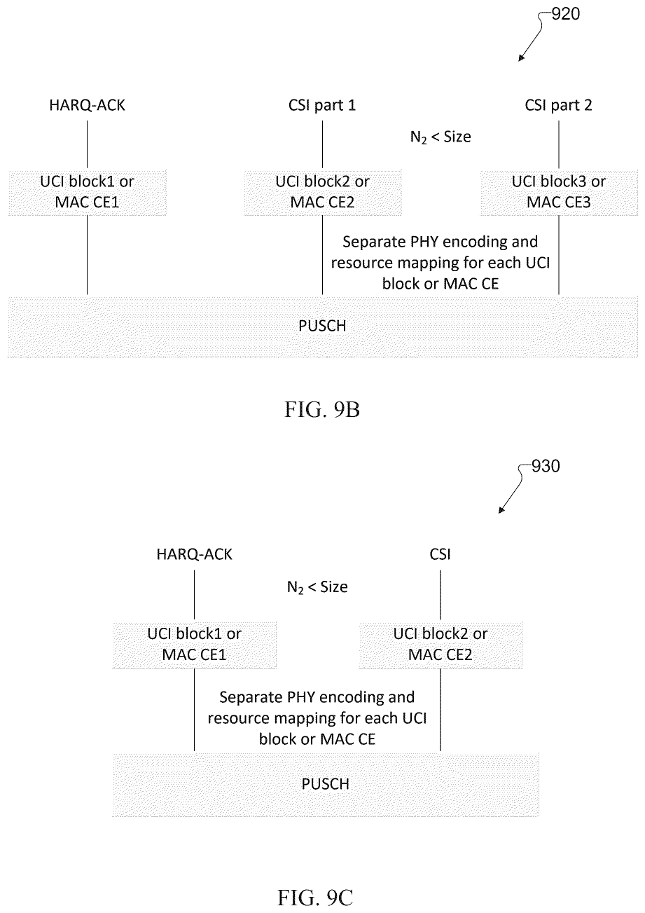

FIGS. 9A, 9B, and 9C illustrate diagrams of example UL transmission configurations 910, 920, and 930, respectively, according to embodiments of the present disclosure. For example, UL transmission configurations 910, 920, and 930, respectively, can be implemented by any of the UEs 111-116 of FIG. 1, such as the UE 114 of FIG. 1. This example is for illustration only and other embodiments can be used without departing from the scope of the present disclosure.

In one example in FIG. 9A, UL control information can include HARQ-ACK information and CSI information. CSI information can include part 1 CSI and part 2 CSI. In one example, there are two UCI blocks or two MAC CE blocks or one UCI block and one MAC CE block, wherein the first UCI block or MAC CE is for HARQ-ACK+part 1 CSI and the second UCI block or MAC CE is for part 2 CSI. Each UCI block or MAC CE can be separately encoded and mapped to resource elements of PUSCH in the physical layer (hence different code rates).

In one example in FIG. 9B, UL control information can include HARQ-ACK information and CSI information. CSI information can include part 1 CSI and part 2 CSI. In one example, there are three UCI blocks or three MAC CE blocks or a combination of three UCI blocks and MAC CE blocks, wherein the first UCI block or MAC CE is for HARQ-ACK and the second UCI block or MAC CE is for part 1 CSI and the third UCI block or MAC CE is for part 2 CSI. Each UCI block or MAC CE can be separately encoded and mapped to resource elements of PUSCH in the physical layer (hence different code rates).

In one example in FIG. 9C, UL control information can include HARQ-ACK information and CSI information. In one example CSI information can be a single part. In one example, CSI information can include part 1 CSI and part 2 CSI. In one example, there are two UCI blocks or two MAC CE blocks or one UCI block and one MAC CE block, wherein the first UCI block or MAC CE is for HARQ-ACK and the second UCI block or MAC CE is for CSI (single part or two part CSI (part1 CSI+part 2 CSI)). Each UCI block or MAC CE can be separately encoded and mapped to resource elements of PUSCH in the physical layer (hence different code rates).

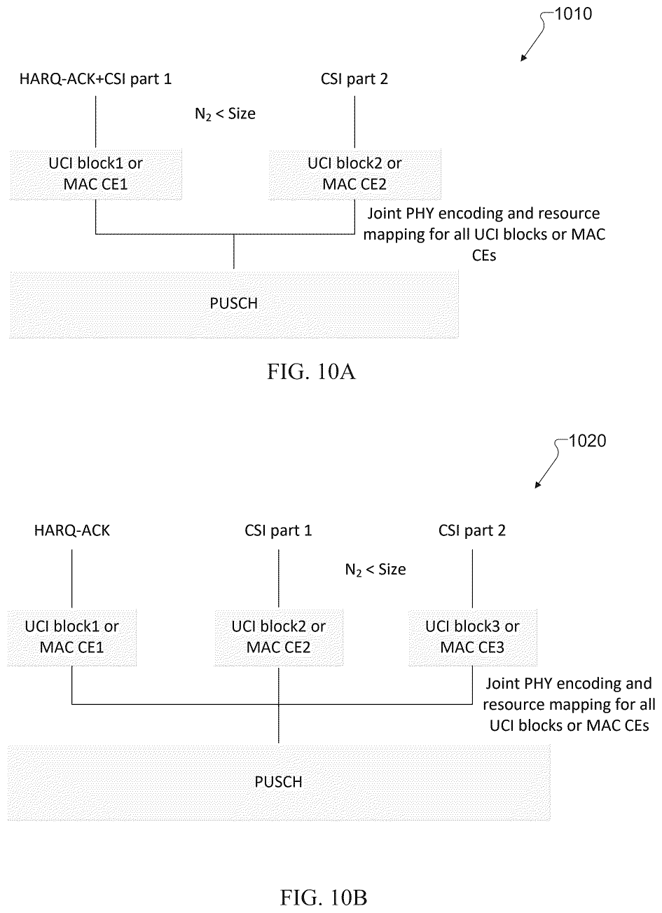

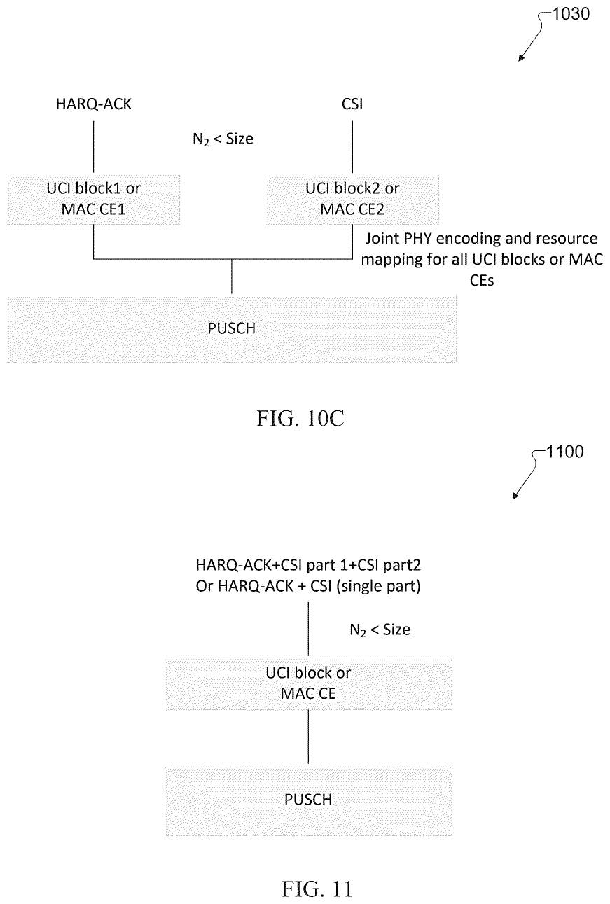

FIGS. 10A, 10B, and 10C illustrate diagrams of example UL transmission configurations 1010, 1020, and 1030, respectively, according to embodiments of the present disclosure. For example, UL transmission configurations 1010, 1020, and 1030, respectively, can be implemented by any of the UEs 111-116 of FIG. 1, such as the UE 115 of FIG. 1. This example is for illustration only and other embodiments can be used without departing from the scope of the present disclosure.

In one example in FIG. 10A, UL control information can include HARQ-ACK information and CSI information. CSI information can include part 1 CSI and part 2 CSI. In one example, there are two UCI blocks or two MAC CE blocks or one UCI block and one MAC CE block, wherein the first UCI block or MAC CE is for HARQ-ACK+part 1 CSI and the second UCI block or MAC CE is for part 2 CSI. The UCI block(s) or MAC CE(s) are multiplexed together and can be jointly encoded and mapped to resource elements of PUSCH in the physical layer (hence same code rate).

In one example in FIG. 10B, UL control information can include HARQ-ACK information and CSI information. CSI information can include part 1 CSI and part 2 CSI. In one example, there are three UCI blocks or three MAC CE blocks or a combination of three UCI blocks and MAC CE blocks, wherein the first UCI block or MAC CE is for HARQ-ACK and the second UCI block or MAC CE is for part 1 CSI and the third UCI block or MAC CE is for part 2 CSI. The UCI block(s) or MAC CE(s) are multiplexed together and can be jointly encoded and mapped to resource elements of PUSCH in the physical layer (hence same code rate).

In one example in FIG. 10C, UL control information can include HARQ-ACK information and CSI information. In one example CSI information can be a single part. In one example, CSI information can include part 1 CSI and part 2 CSI. In one example, there are two UCI blocks or two MAC CE blocks or one UCI block and one MAC CE block, wherein the first UCI block or MAC CE is for HARQ-ACK and the second UCI block or MAC CE is for CSI (single part or two part CSI (part1 CSI+part 2 CSI)). The UCI block(s) or MAC CE(s) are multiplexed together and can be jointly encoded and mapped to resource elements of PUSCH in the physical layer (hence same code rate).

FIG. 11 illustrates a diagram of an example UL transmission configuration 1100 according to embodiments of the present disclosure. For example, UL transmission configuration 1100 can be implemented by any of the UEs 111-116 of FIG. 1, such as the UE 116 of FIG. 1. This example is for illustration only and other embodiments can be used without departing from the scope of the present disclosure.

In one example in FIG. 11, UL control information can include HARQ-ACK information and CSI information. In one example, CSI information can include part 1 CSI and part 2 CSI. In one example, CSI information can be a single part. In one example, there is one UCI block or one MAC CE block, wherein the UCI block or MAC CE is for HARQ-ACK+part 1 CSI+part 2 CSI or HARQ-ACK+CSI. The UCI block or MAC CE is encoded and mapped to resource elements of PUSCH in the physical layer (hence same code rate).

In the following examples, an UL transmission can include (1) UL control information which can include HARQ-ACK information and/or CSI information and/or UEI indicator (2) other MAC CEs (e.g., BSR and PHR) and UL data.

In a variant of the following examples, HARQ-ACK is in a first CB, CSI is in a second CB, each CB can have its own code rate, UL SCH with other MAC CEs is in another one or more CBs. In one example, CSI can have a variable size, but the CB can be dimensioned for a given maximum size and the UE (e.g., the UE 116) can drop CSI or part of it if exceeded (this can be similar, not same, to PUCCH with max number of RBs).

In a variant of the following examples, HARQ-ACK is in a first CB, CSI part 1 is in second CB, CSI part 2 is in a third CB, each CB can have its own code rate, UL SCH with other MAC CEs is in another one or more CBs. In one example, CSI part 2 can have a variable size, but the CB can be dimensioned for a given maximum size and the UE can drop CSI part 2 or part of it if exceeded (this can be similar, not same, to PUCCH with max number of RBs).

In a variant of the following examples, HARQ-ACK+CSI part 1 are in one CB, and CSI part 2 is in a second CB, each CB can have its own code rate, UL SCH with other MAC CEs is in another one or more CBs. In one example, CSI part 2 can have a variable size, but the CB can be dimensioned for a given maximum size and the UE can drop CSI part 2 or part of it if exceeded (this can be similar, not same, to PUCCH with max number of RBs).

In a variant of the following examples, HARQ-ACK+CSI part 1/part 2 are in one CB, which can have its own code rate, UL SCH with other MAC CEs is in another one or more CBs. In one example, CSI part 2 can have a variable size, but the CB can be dimensioned for a given maximum size and the UE can drop CSI part 2 or part of it if exceeded (this can be similar, not same, to PUCCH with max number of RBs).

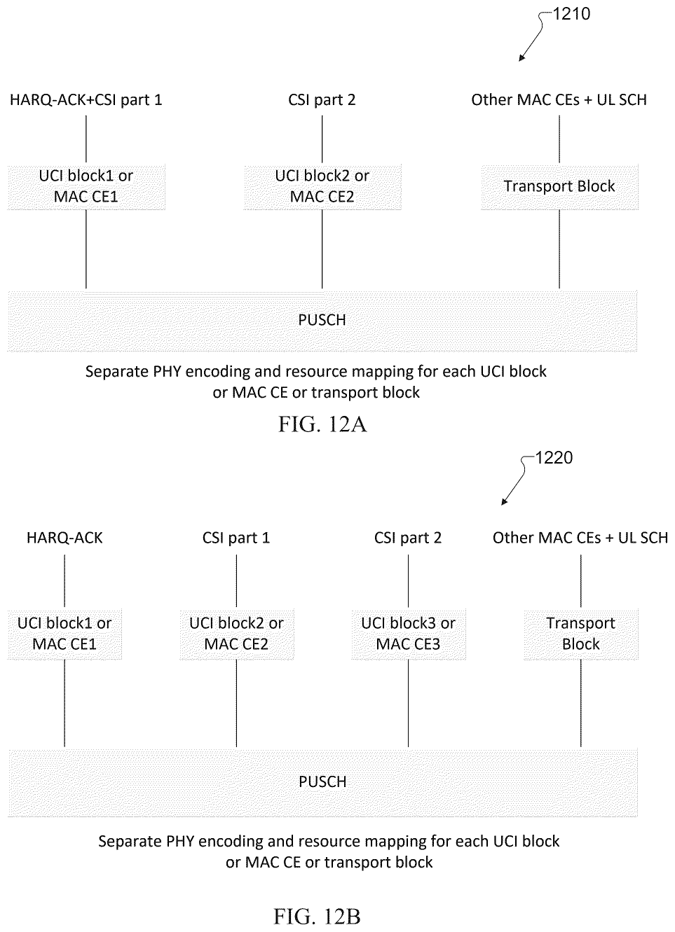

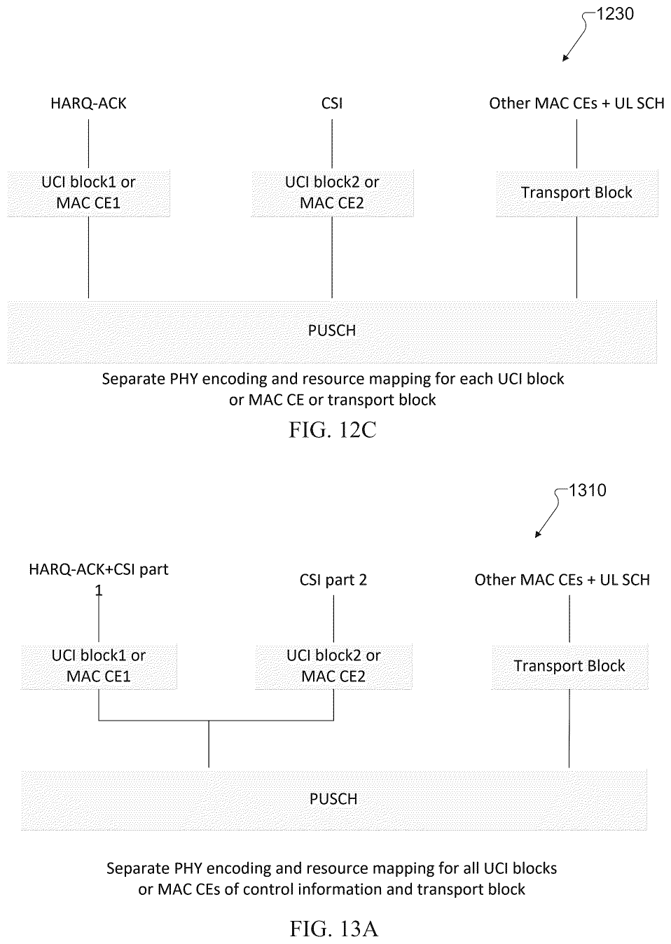

FIGS. 12A, 12B, and 12C illustrate diagrams of example UL transmission configurations 1210, 1220, and 1230, respectively, according to embodiments of the present disclosure. For example, UL transmission configurations 1210, 1220, and 1230, respectively, can be implemented by the UE 116 of FIG. 3. This example is for illustration only and other embodiments can be used without departing from the scope of the present disclosure.

In one example in FIG. 12A, UL transmission can include (1) UL control information, wherein UL control information can include HARQ-ACK information and CSI information and/or UEI indicator, and (2) UL-SCH with other MAC CEs e.g., BSR and/or PHR. CSI information can include part 1 CSI and part 2 CSI. In one example, there are two UCI blocks or two MAC CE blocks or one UCI block and one MAC CE block, wherein the first UCI block or MAC CE is for HARQ-ACK+part 1 CSI and/or UEI indicator and the second UCI block or MAC CE is for part 2 CSI, in addition to a transport block for the UL-SCH with other MAC CEs. Each UCI block or MAC CE and transport block can be separately encoded and mapped to resource elements of PUSCH in the physical layer (hence different code rates).

In one example in FIG. 12B, UL transmission can include, (1) UL control information, wherein UL control information can include HARQ-ACK information and CSI information and/or UEI indicator, and (2) UL-SCH with other MAC CEs e.g., BSR and/or PHR. CSI information can include part 1 CSI and part 2 CSI. In one example, there are three UCI blocks or three MAC CE blocks or a combination of three UCI blocks and MAC CE blocks, wherein the first UCI block or MAC CE is for HARQ-ACK and/or UEI indicator and the second UCI block or MAC CE is for part 1 CSI and the third UCI block or MAC CE is for part 2 CSI, in addition to a transport block for the UL-SCH with other MAC CEs. Each UCI block or MAC CE and transport block can be separately encoded and mapped to resource elements of PUSCH in the physical layer (hence different code rates).

In one example in FIG. 12C, UL transmission can include, (1) UL control information, wherein UL control information can include HARQ-ACK information and CSI information and/or UEI indicator, and (2) UL-SCH with other MAC CEs e.g., BSR and/or PHR. In one example CSI information can be a single part. In one example, CSI information can include part 1 CSI and part 2 CSI. In one example, there are two UCI blocks or two MAC CE blocks or one UCI block and one MAC CE block, wherein the first UCI block or MAC CE is for HARQ-ACK and/or UEI indicator and the second UCI block or MAC CE is for CSI (single part or two part CSI (part1 CSI+part 2 CSI)), in addition to a transport block for the UL-SCH with other MAC CEs. Each UCI block or MAC CE and transport block can be separately encoded and mapped to resource elements of PUSCH in the physical layer (hence different code rates).

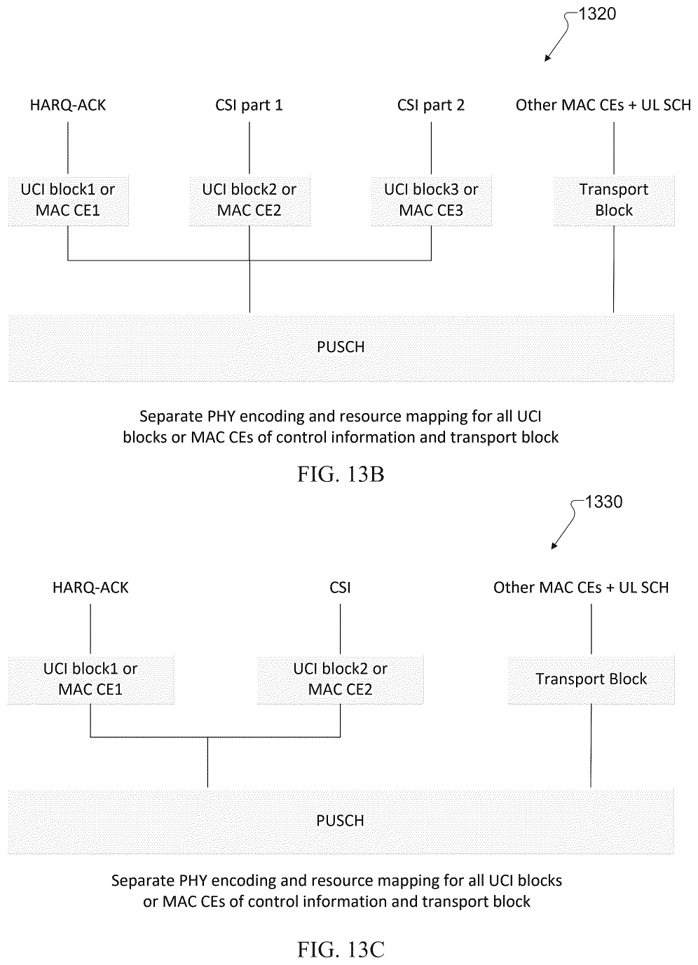

FIGS. 13A, 13B, and 13C illustrate diagrams of example UL transmission configurations 1310, 1320, and 1330, respectively, according to embodiments of the present disclosure. For example, UL transmission configurations 1310, 1320, and 1330, respectively, can be implemented by any of the UEs 111-116 of FIG. 1, such as the UE 111 of FIG. 1. This example is for illustration only and other embodiments can be used without departing from the scope of the present disclosure.

In one example in FIG. 13A, UL transmission can include, (1) UL control information, wherein UL control information can include HARQ-ACK information and CSI information and/or UEI indicator, and (2) UL-SCH with other MAC CEs e.g., BSR and/or PHR. CSI information can include part 1 CSI and part 2 CSI. In one example, there are two UCI blocks or two MAC CE blocks or one UCI block and one MAC CE block, wherein the first UCI block or MAC CE is for HARQ-ACK+part 1 CSI and/or UEI indicator and the second UCI block or MAC CE is for part 2 CSI, in addition to a transport block for the UL-SCH with other MAC CEs. The UCI block(s) or MAC CE(s) are multiplexed together and can be jointly encoded and mapped to resource elements of PUSCH in the physical layer (hence same code rate for UCI). However, transport block can be separately encoded and mapped to resource elements of PUSCH in the physical layer (hence different code rates for UL-SCH and UCI).

In one example in FIG. 13B, UL transmission can include, (1) UL control information, wherein UL control information can include HARQ-ACK information and CSI information and/or UEI indicator, and (2) UL-SCH with other MAC CEs e.g., BSR and/or PHR. CSI information can include part 1 CSI and part 2 CSI. In one example, there are three UCI blocks or three MAC CE blocks or a combination of three UCI blocks and MAC CE blocks, wherein the first UCI block or MAC CE is for HARQ-ACK and/or UEI indicator and the second UCI block or MAC CE is for part 1 CSI and the third UCI block or MAC CE is for part 2 CSI, in addition to a transport block for the UL-SCH with other MAC CEs. The UCI block(s) or MAC CE(s) are multiplexed together and can be jointly encoded and mapped to resource elements of PUSCH in the physical layer (hence same code rate for UCI). However, transport block can be separately encoded and mapped to resource elements of PUSCH in the physical layer (hence different code rates for UL-SCH and UCI).

In one example in FIG. 13C, UL transmission can include, (1) UL control information, wherein UL control information can include HARQ-ACK information and CSI information and/or UEI indicator, and (2) UL-SCH with other MAC CEs e.g., BSR and/or PHR. In one example CSI information can be a single part. In one example, CSI information can include part 1 CSI and part 2 CSI. In one example, there are two UCI blocks or two MAC CE blocks or one UCI block and one MAC CE block, wherein the first UCI block or MAC CE is for HARQ-ACK and/or UEI indicator and the second UCI block or MAC CE is for CSI (single part or two part CSI (part1 CSI+part 2 CSI)), in addition to a transport block for the UL-SCH with other MAC CEs. The UCI block(s) or MAC CE(s) are multiplexed together and can be jointly encoded and mapped to resource elements of PUSCH in the physical layer (hence same code rate for UCI). However, transport block can be separately encoded and mapped to resource elements of PUSCH in the physical layer (hence different code rates for UL-SCH and UCI).

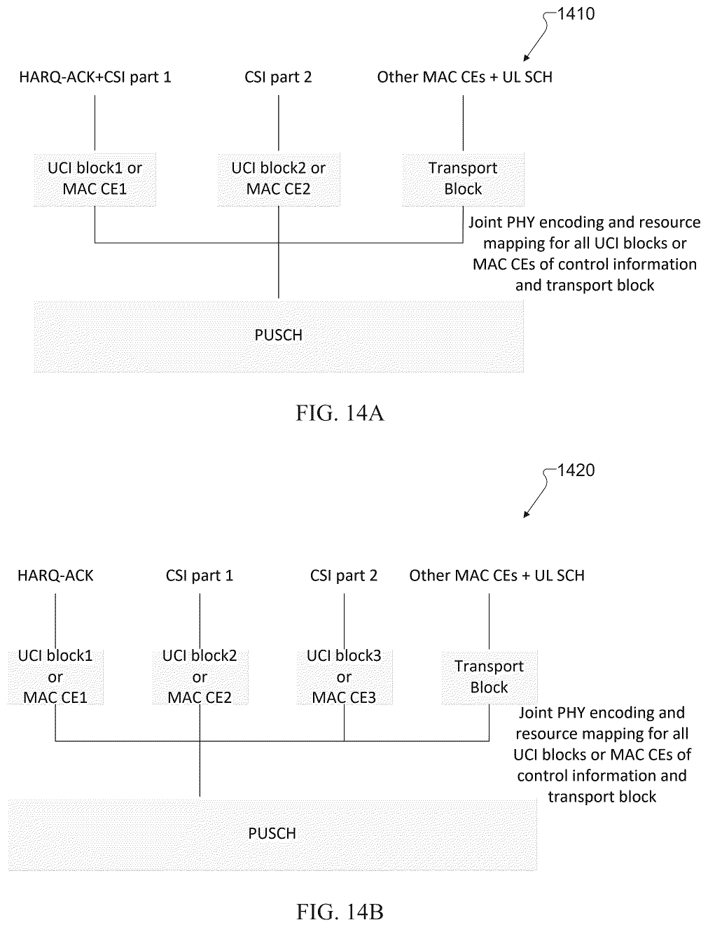

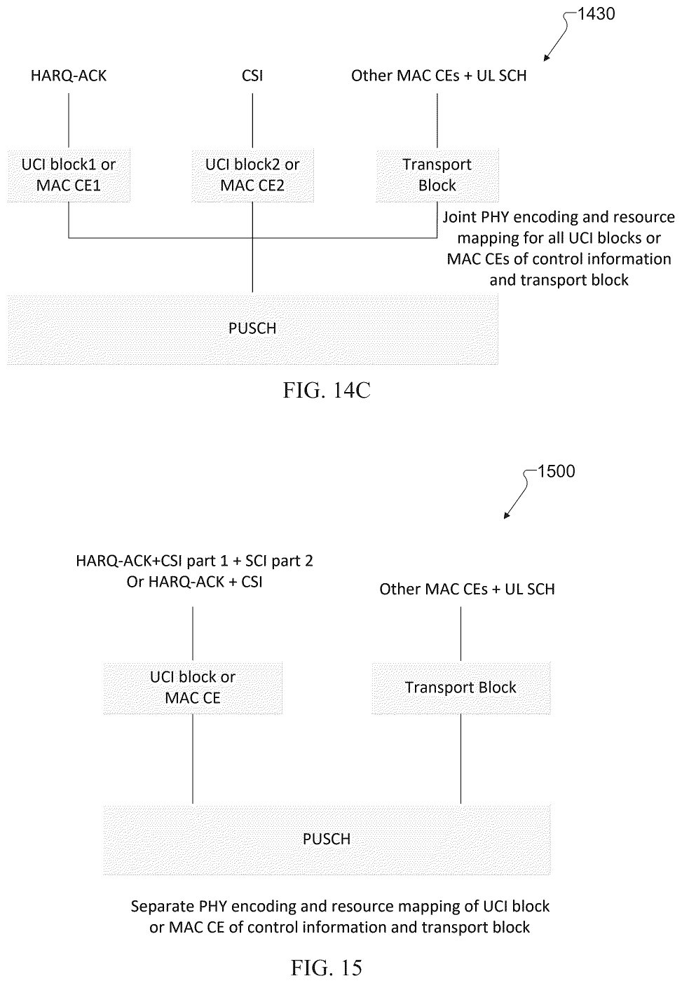

FIGS. 14A, 14B, and 14C illustrate diagrams of example UL transmission configurations 1410, 1420, and 1430, respectively, according to embodiments of the present disclosure. For example, UL transmission configurations 1410, 1420, and 1430, respectively, can be implemented by any of the UEs 111-116 of FIG. 1, such as the UE 112 of FIG. 1. This example is for illustration only and other embodiments can be used without departing from the scope of the present disclosure.

In one example in FIG. 14A, UL transmission can include, (1) UL control information, wherein UL control information can include HARQ-ACK information and CSI information and/or UEI indicator, and (2) UL-SCH with other MAC CEs e.g., BSR and/or PHR. CSI information can include part 1 CSI and part 2 CSI. In one example, there are two UCI blocks or two MAC CE blocks or one UCI block and one MAC CE block, wherein the first UCI block or MAC CE is for HARQ-ACK+part 1 CSI and/or UEI indicator and the second UCI block or MAC CE is for part 2 CSI, in addition to a transport block for the UL-SCH with other MAC CEs. The UCI block(s) or MAC CE(s) and transport are multiplexed together and can be jointly encoded and mapped to resource elements of PUSCH in the physical layer (hence same code rate for UCI and UL-SCH).

In one example in FIG. 14B, UL transmission can include, (1) UL control information, wherein UL control information can include HARQ-ACK information and CSI information and/or UEI indicator, and (2) UL-SCH with other MAC CEs e.g., BSR and/or PHR. CSI information can include part 1 CSI and part 2 CSI. In one example, there are three UCI blocks or three MAC CE blocks or a combination of three UCI blocks and MAC CE blocks, wherein the first UCI block or MAC CE is for HARQ-ACK and/or UEI indicator and the second UCI block or MAC CE is for part 1 CSI and the third UCI block or MAC CE is for part 2 CSI, in addition to a transport block for the UL-SCH with other MAC CEs. The UCI block(s) or MAC CE(s) and transport are multiplexed together and can be jointly encoded and mapped to resource elements of PUSCH in the physical layer (hence same code rate for UCI and UL-SCH).

In one example in FIG. 14C, UL transmission can include, (1) UL control information, wherein UL control information can include HARQ-ACK information and CSI information and/or UEI indicator, and (2) UL-SCH with other MAC CEs e.g., BSR and/or PHR. In one example CSI information can be a single part. In one example, CSI information can include part 1 CSI and part 2 CSI. In one example, there are two UCI blocks or two MAC CE blocks or one UCI block and one MAC CE block, wherein the first UCI block or MAC CE is for HARQ-ACK and/or UEI indicator and the second UCI block or MAC CE is for CSI (single part or two part CSI (part1 CSI+part 2 CSI)), in addition to a transport block for the UL-SCH with other MAC CEs. The UCI block(s) or MAC CE(s) and transport are multiplexed together and can be jointly encoded and mapped to resource elements of PUSCH in the physical layer (hence same code rate for UCI and UL-SCH).

FIG. 15 illustrates a diagram of an example UL transmission configuration 1500 according to embodiments of the present disclosure. For example, UL transmission configuration 1500 can be implemented by the UE 116 of FIG. 3. This example is for illustration only and other embodiments can be used without departing from the scope of the present disclosure.

In one example in FIG. 15, UL transmission can include, (1) UL control information, wherein UL control information can include HARQ-ACK information and CSI information and/or UEI indicator, and (2) UL-SCH with other MAC CEs e.g., BSR and/or PHR. In one example, CSI information can include part 1 CSI and part 2 CSI. In one example, CSI information can be a single part. In one example, there is one UCI block or one MAC CE block, wherein the UCI block or MAC CE is for HARQ-ACK+part 1 CSI+part 2 CSI or HARQ-ACK+CSI and/or UEI indicator, in addition to a transport block for the UL-SCH with other MAC CEs. The UCI block or MAC CE and transport block can be separately encoded and mapped to resource elements of PUSCH in the physical layer (hence different code rate for UCI and UL-SCH).

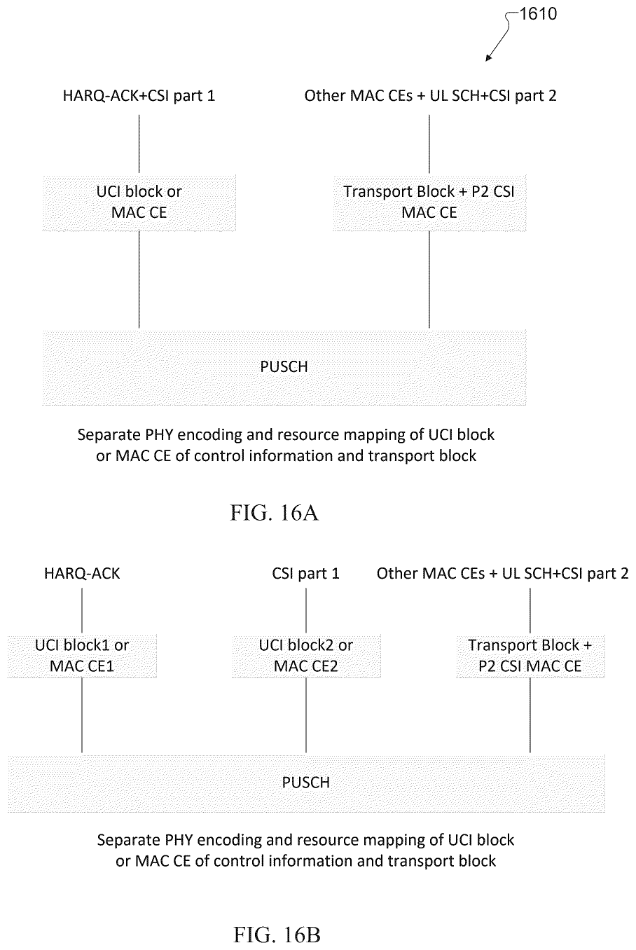

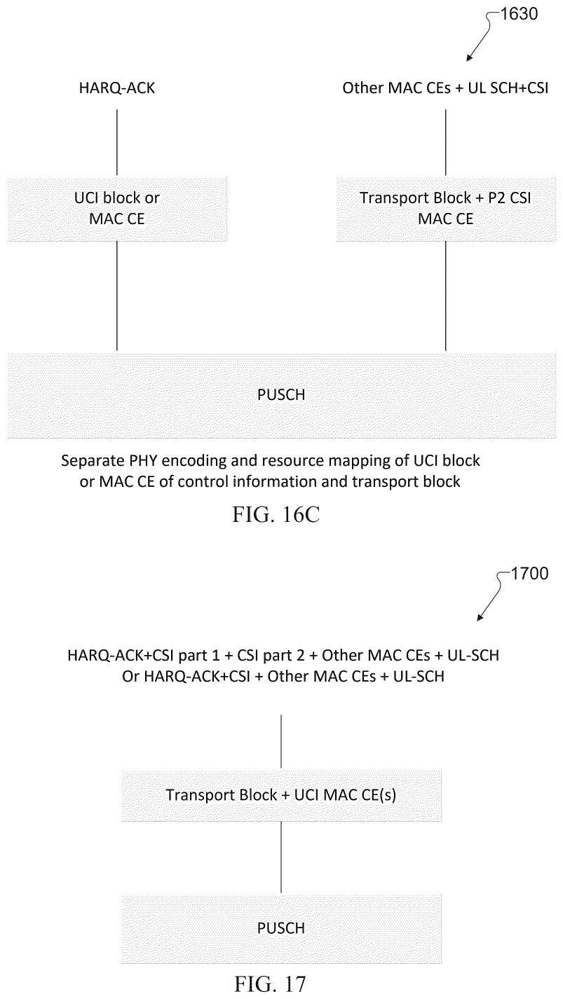

FIGS. 16A, 16B, and 16C illustrate diagrams of example UL transmission configurations 1610, 1620, and 1630, respectively, according to embodiments of the present disclosure. For example, UL transmission configurations 1610, 1620, and 1630, respectively, can be implemented by any of the UEs 111-116 of FIG. 1, such as the UE 113 of FIG. 1. This example is for illustration only and other embodiments can be used without departing from the scope of the present disclosure.

In one example in FIG. 16A, UL transmission can include, (1) UL control information, wherein UL control information can include HARQ-ACK information and CSI information and/or UEI indicator, and (2) UL-SCH with other MAC CEs e.g., BSR and/or PHR. CSI information can include part 1 CSI and part 2 CSI. In one example, there is one UCI block or one MAC CE block, wherein the UCI block or MAC CE is for HARQ-ACK+part 1 CSI and/or UEI indicator, in addition to a part 2 CSI MAC CE and a transport block for the UL-SCH with other MAC CEs. The UCI block or MAC CE for HARQ-ACK/part 1 CSI and/or UEI indicator and transport block with part 2 CSI MAC CE can be separately encoded and mapped to resource elements of PUSCH in the physical layer (hence different code rate for HARQ-ACK/part 1 CSI and UL-SCH/part 2 CSI).

In one example in FIG. 16B, UL transmission can include, (1) UL control information, wherein UL control information can include HARQ-ACK information and CSI information and/or UEI indicator, and (2) UL-SCH with other MAC CEs e.g., BSR and/or PHR. CSI information can include part 1 CSI and part 2 CSI. In one example, there are two UCI blocks or two MAC CE blocks or one UCI block and one MAC CE block, wherein the first UCI block or MAC CE is for HARQ-ACK and/or UEI indicator and the second UCI block or MAC CE is for CSI part 1, in addition to a part 2 CSI MAC CE and a transport block for the UL-SCH with other MAC CEs. The UCI blocks or MAC CEs for HARQ-ACK and/or UEI indicator and part 1 CSI and transport block with part 2 CSI MAC CE can be separately encoded and mapped to resource elements of PUSCH in the physical layer (hence different code rate for HARQ-ACK/part 1 CSI and UL-SCH/part 2 CSI).

In one example in FIG. 16C, UL transmission can include, (1) UL control information, wherein UL control information can include HARQ-ACK information and CSI information and/or UEI indicator, and (2) UL-SCH with other MAC CEs e.g., BSR and/or PHR. In one example CSI information can be a single part. In one example, CSI information can include part 1 CSI and part 2 CSI. In one example, there is one UCI block or one MAC CE block, wherein the UCI block or MAC CE is for HARQ-ACK and/or UEI indicator, in addition to a CSI (single part or two part CSI (part1 CSI+part 2 CSI)) MAC CE and a transport block for the UL-SCH with other MAC CEs. The UCI block or MAC CE for HARQ-ACK and/or UEI indicator and transport block with CSI MAC CE can be separately encoded and mapped to resource elements of PUSCH in the physical layer (hence different code rate for HARQ-ACK and UL-SCH/CSI).

FIG. 17 illustrates a diagram of an example UL transmission configuration 1700 according to embodiments of the present disclosure. For example, UL transmission configuration 1700 can be implemented by any of the UEs 111-116 of FIG. 1, such as the UE 114 of FIG. 1. This example is for illustration only and other embodiments can be used without departing from the scope of the present disclosure.

In one example in FIG. 17, UL transmission can include, (1) UL control information, wherein UL control information can include HARQ-ACK information and CSI information and/or UEI indicator, and (2) UL-SCH with other MAC CEs e.g., BSR and/or PHR. In one example, CSI information can include part 1 CSI and part 2 CSI. In one example, CSI information can be a single part. In one example, there is one transport block with MAC CE(s) for UCI, wherein the MAC CE(s) is for HARQ-ACK+part 1 CSI+part 2 CSI or HARQ-ACK+CSI and/or UEI indicator, the transport block also includes UL-SCH with other MAC CEs. The transport block is encoded and mapped to resource elements of PUSCH in the physical layer (hence same code rate for UCI and UL-SCH).

In a variant of the examples mentioned herein, there can be one or more MAC CEs and/or one or more UCI blocks and/or one or more transport blocks each of which can be encoded and mapped to resource elements separately, hence transmitted with different transport characteristics.

In one example, if HARQ-ACK and/or UEI indicator is 1 or 2 bits and multiplexed in PUSCH the following options can be evaluated:
Reserved resources in PUSCH (like NR)
Piggy-backed in other MAC CE as one or two bits
Separate MAC CE (this would be quite inefficient).

Examples of multiplexing are provided. Periodic or aperiodic PUSCH or PUCCH carrying CSI overlaps with PUCCH or PUSCH carrying HARQ-ACK.

In one example, multiplexing options:
CSI dropped, and HARQ-ACK transmitted on PUCCH or PUSCH
Separate transmission for PUSCH or PUCCH carrying CSI and PUSCH or PUCCH carrying HARQ-ACK, at least when the transmissions are on different cells.
HARQ-ACK multiplexed into PUSCH or PUCCH carrying CSI. Part of CSI may be dropped, e.g., if code rate can't be satisfied due to limited time frequency resources.
CSI multiplexed into PUSCH or PUCCH carrying HARQ-ACK. Part of CSI may be dropped, e.g., if code rate can't be satisfied due to limited time frequency resources.
HARQ-ACK and CSI are multiplexed in a PUCCH or a PUSCH.

In one example, SR request overlaps with PUSCH or PUCCH carrying CSI and/or PUCCH or PUSCH carrying HARQ-ACK.

Multiplexing options:
CSI dropped, and HARQ-ACK/SR transmitted on PUCCH or PUSCH
Separate transmission for PUSCH or PUCCH carrying CSI and PUSCH or PUCCH carrying HARQ-ACK/SR.
Separate transmission for PUSCH or PUCCH carrying CSI and PUSCH or PUCCH carrying HARQ-ACK and PUCCH with SR.
HARQ-ACK/SR multiplexed into PUSCH or PUCCH carrying CSI. Part of CSI may be dropped.
CSI/SR multiplexed into PUSCH or PUCCH carrying HARQ-ACK. Part of CSI may be dropped.

In one example, if CSI is only on PUSCH, then HARQ-ACK is multiplexed into PUSCH and SR is dropped (or SR is included if no UL-SCH). If a code rate for HARQ-ACK would exceed an RRC-configured code rate for HARQ-ACK, or a code rate for CSI would exceed an RRC-configured code rate for CSI, part of CSI can be dropped until the code rates mentioned herein become smaller than or equal to the corresponding configured code rates.

In one example, UL SCH overlaps with PUSCH or PUCCH carrying CSI and/or PUCCH or PUSCH carrying HARQ-ACK.

Multiplexing options:
CSI dropped. HARQ-ACK and UL-SCH can be transmitted with or without multiplexing.
Separate transmission for PUSCH or PUCCH carrying CSI and PUSCH or PUCCH carrying HARQ-ACK and PUSCH with UL shared channels.
HARQ-ACK/CSI multiplexed into PUSCH carrying UL-SCH. Part of CSI may be dropped.

In one example, by having separate encoding for transport block, MAC CE(s) and UCI block(s), there can be different retransmission behavior. For example, if a first transmission has a first transport block and first MAC CE that are multiplexed onto the same physical channel, if the first transport block fails decoding, but the MAC CE decodes successfully, or the information in the MAC CE becomes stale and new information is available, the network (e.g., the network 130) can request the UE to re-transmit the first transport block with a new second MAC CE in the same physical channel. The receiver can apply HARQ combining to the transport block as it is separately encoded from the MAC CE.

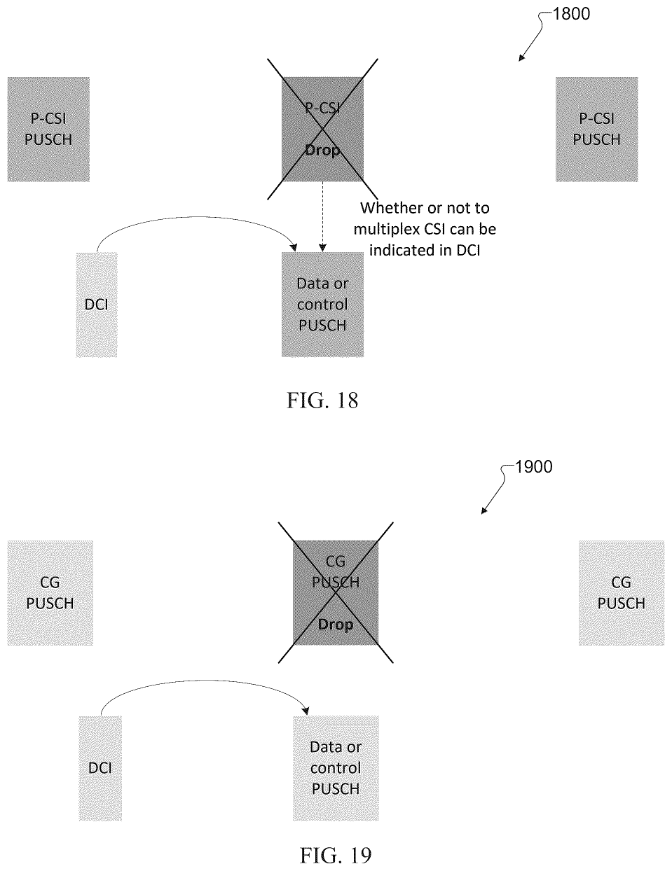

FIG. 18 illustrates a diagram of an example dynamic UL transmission configuration 1800 according to embodiments of the present disclosure. For example, UL transmission configuration 1800 can be implemented by any of the UEs 111-116 of FIG. 1, such as the UE 115 of FIG. 1. This example is for illustration only and other embodiments can be used without departing from the scope of the present disclosure.

FIG. 19 illustrates a diagram of an example dynamic UL transmission configuration 1900 according to embodiments of the present disclosure. For example, UL transmission configuration 1900 can be implemented by any of the UEs 111-116 of FIG. 1, such as the UE 116 of FIG. 1. This example is for illustration only and other embodiments can be used without departing from the scope of the present disclosure.

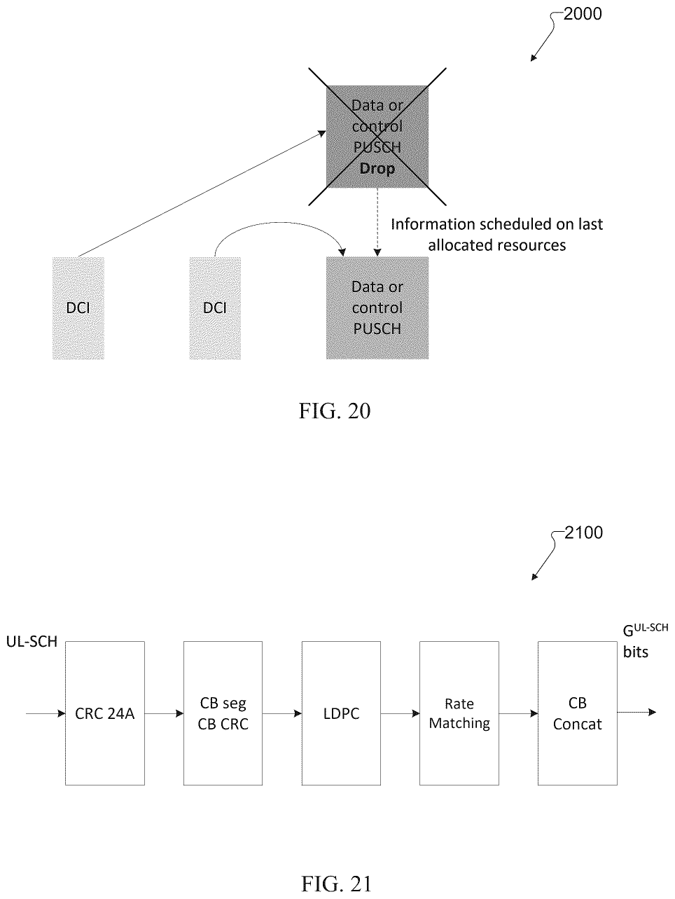

FIG. 20 illustrates a diagram of an example dynamic UL transmission configuration 2000 according to embodiments of the present disclosure. For example, UL transmission configuration 2000 can be implemented by the UE 116 of FIG. 3. This example is for illustration only and other embodiments can be used without departing from the scope of the present disclosure.

In one example, a UE is configured with periodic CSI (P-CSI) or is activated with semi-persistent CSI (SP-CSI). In one example, P-CSI is transmitted on PUSCH resources or PUSCH-like resources. In one example, P-CSI is transmitted on PUCCH resources or PUCCH-like resources. In one example, SP-CSI is transmitted on PUSCH resources or PUSCH-like resources. In one example, SP-CSI is transmitted on PUCCH resources or PUCCH-like resources. In one example, an uplink transmission is dynamically indicated to the UE, and the uplink transmission overlaps (e.g., in time) with the resources of P-CSI or SP-CSI. In one example, the uplink transmission that is dynamically indicated is on PUSCH. In one example, the uplink transmission that is dynamically indicated is on PUCCH. In one example, UL transmission is for UL-SCH or aperiodic CSI indicated by a DCI Format (e.g., DCI Format 0-0 or DCI Format 0-1 or DCI Format 0-2 or DCI Format 0-3). In one example, UL transmission is for HARQ-ACK feedback indicated by a DCI Format (e.g., DCI Format 1-0 or DCI Format 1-1 or DCI Format 1-2 or DCI Format 1-3). In one example, when overlap in time of the dynamic uplink transmission and periodic or semi-persistent resources occur, the UE uses the resources of the dynamic uplink transmission as illustrated in FIG. 18. In one example, the P-CSI or the SP-CSI that overlaps the dynamic UL transmission is dropped. In one example, the P-CSI or the SP-CSI that overlaps the dynamic UL transmission is multiplexed into the dynamic UL transmission. In one example, the DCI format scheduling or allocating resources for the dynamic UL transmission indicates (e.g., by a flag or a field in the DCI format) whether or not to multiplex the P-CSI or the SP-CSI with the dynamic uplink transmission as indicated in FIG. 18. In FIG. 18, the instances of P-CSI (e.g., on PUSCH) or SP-CSI that don't overlap a dynamically scheduled UL transmission are transmitted. The instances of P-CSI (e.g., on PUSCH) or SP-CSI that overlap a dynamically scheduled UL transmission are dropped. In one example, if P-CSI or SP-CSI is multiplexed on the dynamic UL transmission, the network allocates sufficient resources for the multiplexing to occur.

In one example, a UE is configured with configured grant PUSCH (CG-PUSCH) Type 1 or is activated configured grant PUSCH (CG-PUSCH) Type 2. In one example, an uplink transmission is dynamically indicated to the UE, and the uplink transmission overlaps (e.g., in time) with the resources CG-PUSCH (Type 1 or Type 2). In one example, the uplink transmission that is dynamically indicated is on PUSCH. In one example, the uplink transmission that is dynamically indicated is on PUCCH. In one example, UL transmission is for UL-SCH or aperiodic CSI indicated by a DCI Format (e.g., DCI Format 0-0 or DCI Format 0-1 or DCI Format 0-2 or DCI Format 0-3). In one example, UL transmission is for HARQ-ACK feedback indicated by a DCI Format (e.g., DCI Format 1-0 or DCI Format 1-1 or DCI Format 1-2 or DCI Format 1-3). In one example, when overlapping in time of the dynamic uplink transmission and CG-PUSCH (e.g., Type 1 or Type 2) occur, the UE uses the resources of the dynamic uplink transmission as illustrated in FIG. 19. In one example, the CG-PUSCH (e.g., Type 1 or Type 2) that overlaps the dynamic UL transmission is dropped. In FIG. 19, the instances of CG-PUSCH (e.g., Type 1 or Type 2) that don't overlap with a dynamically scheduled UL transmission are transmitted. The instances of CG-PUSCH (e.g., Type 1 or Type 2) that overlap with a dynamically scheduled UL transmission are dropped. In one example, if CG PUSCH (e.g., Type 1 or Type 2) overlaps with UL transmission with UCI (e.g., HARQ-ACK and/or CSI and/or UEI indicator), the UCI is multiplexed with CG PUSCH.

In one example, a UE is indicated (e.g., by dynamic signaling-dynamic signaling can be L1 control e.g., DCI or MAC CE) a first UL transmission on a first resources, a UE is indicated (e.g., by dynamic signaling) a second UL transmission on a second resources, wherein the first resource and the second resource at least overlap in time. The UE is indicated the first UL transmission at time T₁ and is indicated the second UL transmission at time T₂, where T₁ and T₂ can be the start time of the corresponding dynamic signaling (e.g., DCI Format or MAC CE), or the end time of the corresponding dynamic signaling. T₁<T₂, i.e., the first UL transmission is indicated before the second UL transmission as illustrated in FIG. 20. In one example, the first UL transmission is transmitted on PUSCH resources or PUSCH-like resources. In one example, the first UL transmission is transmitted on PUCCH resources or PUCCH-like resources. In one example, the second UL transmission is transmitted on PUSCH resources or PUSCH-like resources. In one example, the second UL transmission is transmitted on PUCCH resources or PUCCH-like resources.

In one example, the first UL transmission is for UL-SCH or aperiodic CSI and is indicated by a DCI Format (e.g., DCI Format 0-0 or DCI Format 0-1 or DCI Format 0-2 or DCI Format 0-3). In one example, first UL transmission is for HARQ-ACK feedback and is indicated by a DCI Format (e.g., DCI Format 1-0 or DCI Format 1-1 or DCI Format 1-2 or DCI Format 1-3). In one example, the second UL transmission is for UL-SCH or aperiodic CSI and is indicated by a DCI Format (e.g., DCI Format 0-0 or DCI Format 0-1 or DCI Format 0-2 or DCI Format 0-3). In one example, second UL transmission is for HARQ-ACK feedback and is indicated by a DCI Format (e.g., DCI Format 1-0 or DCI Format 1-1 or DCI Format 1-2 or DCI Format 1-3).

In one example, the UE drops the first UL transmission and transmits the second UL transmission, e.g., as illustrated in FIG. 20. In one example, the UE drops the information of the first UL transmission. In one example, the UE multiplexes the information of the first UL transmission into the second UL transmission. In one example, the DCI format scheduling or allocating resources for the second UL transmission indicates (e.g., by a flag or a field in the DCI format) whether or not to multiplex the information of the first (or an earlier indicated) UL transmission with the second uplink transmission. In one example, the DCI format scheduling or allocating resources for the first UL transmission indicates (e.g., by a flag or a field in the DCI format) whether or not to multiplex the information of the first transmission with the second (or a later overlapping) uplink transmission. In one example, if information of first UL transmission is multiplexed on the second UL transmission, the network allocates sufficient resources for the multiplexing to occur.

In a variant example of FIG. 20, whether to multiplex the information of the first UL transmission into the second UL transmission can depend on the priorities of the first and second UL transmissions. In one example, if the priority of the second UL transmission is higher than the priority of the first UL transmission, the information of the first UL transmission is dropped and the second UL transmission is transmitted. In one example, if the priority of the second UL transmission is higher, the information of the first UL transmission is dropped and the second UL transmission is transmitted. In one example, if the priority of the second UL transmission is equal to the priority of the first UL transmission, the information of the first UL transmission is multiplexed into the second UL transmission. In one example, if the priority of the first UL transmission is higher than the priority of the second UL transmission, the information of the second UL transmission is dropped and the first UL transmission is transmitted. In one example, if the priority of the first UL transmission is higher, the information of the second UL transmission is dropped and the first UL transmission is transmitted.

In one example, if a first UL transmission is associated with, or scheduled by or allocated by an UL-related (e.g., for UL grant) DCI Format (e.g., DCI Format 0-0 or DCI Format 0-1 or DCI Format 0-2 or DCI Format 0-3), and if a second UL transmission is associated with, or scheduled by or allocated by a non-UL-related or by a DL-related (e.g. for DL assignment) DCI Format (e.g., DCI Format 1-0 or DCI Format 1-1 or DCI Format 1-2 or DCI Format 1-3), and the first UL transmission and the second UL transmission overlap (e.g., in time), the information associated with the second UL transmission is multiplexed in the first UL transmission. In one example, whether to multiplex or not can be indicated by a field or flag in the DCI format associated with the first uplink transmission. In one example, whether to multiplex or not can be indicated by a field or flag in the DCI format associated with the second uplink transmission. In one example, if there is no multiplexing (e.g., based on field or flag), the first UL transmission is dropped. In one example, if there is no multiplexing (e.g., based on field or flag), the second UL transmission is dropped. In one example, if there is no multiplexing (e.g., based on field or flag), the first UL transmission and the second UL transmission are transmitted in parallel, e.g., using different frequency resources.

In one example, if a first uplink transmission with a small payload, and uses an uplink transmission format with multiplexing capability on the same resource (e.g., PUCCH Format 0 like or PUCCH Format 1 like or PUCCH Format 4 like) overlaps (e.g., in time) with a second uplink transmission with a large payload and uses an uplink transmission structure similar to PUSCH, the following examples can be evaluated:
The first UL transmission and the second UL transmission are transmitted in parallel. In one example, a UE (e.g., the UE 116) capability can indicate whether the UE supports parallel transmission or not. In one example, the UE can be configured whether or not to have parallel transmissions, when overlapping (e.g., in time) UL transmission occur.
In one example, if the UE doesn't support parallel transmissions, the UE can be indicated (e.g., by a DCI associated with the first transmission or a DCI associated with a second transmission) or configured which transmission to drop, and which transmission to transmit.
The information of the first UL transmission is multiplexed into the second UL transmission.
The first UL transmission is dropped and the second UL transmission is transmitted.
The second UL transmission is dropped and the first UL transmission is transmitted.
The transmission with a higher priority is transmitted and the other transmission is dropped.
If the second transmission has a lower priority than the first transmission, the second transmission is transmitted, and the information associated with the first transmission is multiplexed into the second transmission.

If the second transmission has equal priority to the first transmission, the second transmission is transmitted, and the information associated with the first transmission is multiplexed into the second transmission.

FIG. 21 illustrates a diagram of example channel coding 2100 for UL transmission according to embodiments of the present disclosure. For example, channel coding 2100 can be implemented by any of the UEs 111-116 of FIG. 1, such as the UE 111. This example is for illustration only and other embodiments can be used without departing from the scope of the present disclosure.

In NR, the physical uplink shared channel (PUSCH) can be used to transmit UL shared channel (UL-SCH) and UL control information (UCI). With reference to FIG. 21, the channel coding for UL-SCH is shown. The higher layers (e.g., MAC layer) provides up to two UL-SCH transport blocks (e.g., MAC PDUs) to the physical layer within a transmission time interval (TTI). Two transport blocks are used in case of spatial multiplexing with more than 4 layers. Each transport block is encoded and mapped to the PUSCH. A cyclic redundancy check (CRC), for error detection at the receiver, is appended to the transport block. The transport block is segmented into multiple code blocks (CBs) and each CB has its own CB CRC. The low-density parity check (LDPC) code supports a maximum block size of 8424 bits for base graph 1 and 3840 bits for base graph 2, CB segmentation allows the support of larger transport block sizes. CB-based CRC allows for code block group (CBG)-based HARQ-ACK feedback and CBG-based retransmissions, whereby only the CBGs with failed CB CRCs are retransmitted. Each CB is encoded using an error-correcting LDPC code. Rate matching adjusts the size of the encoded CB to fit within the resources allocated by the scheduler, rate matching also selects bits corresponding to different redundancy versions for hybrid-ARQ. The encoded CBs are then concatenated to provide an encoded bit stream for UL-SCH with GUL-SCH bits.

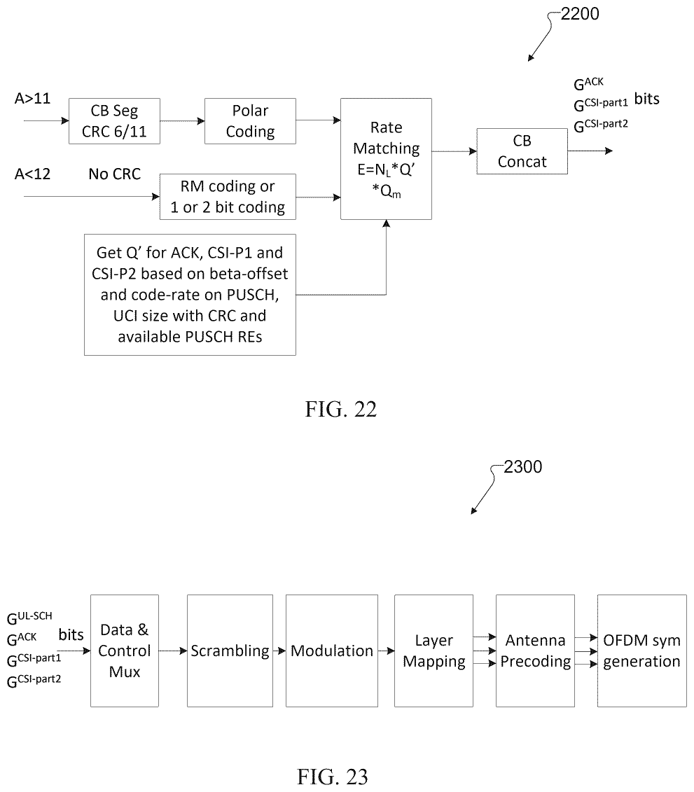

FIG. 22 illustrates a diagram of example channel coding 2200 for UL transmission according to embodiments of the present disclosure. For example, channel coding 2200 can be implemented by any of the UEs 111-116 of FIG. 1, such as the UE 112. This example is for illustration only and other embodiments can be used without departing from the scope of the present disclosure.

With reference to FIG. 22, the channel coding for UCI is shown. As mentioned herein, there can be multiple streams of control information that are encoded separately. For example, the streams can be for HARQ-ACK information, channel state information (CSI)-part1 and CSI-part2. For UCI blocks larger than 11 bits, a CRC is attached to the UCI payload, the CRC can be of size 6-bits for payloads between 12 and 19 bits, and a 11-bit CRC for payloads larger than or equal to 20 bit. Large blocks can be segmented into multiple smaller blocks. The data is then encoded, the coding scheme used depends on the block size. Blocks of size 1 bit (c₀) are encoded as shown in Table 2. Blocks of size 2 bit (c₀, c₁) are encoded as shown in Table 3, where c₂=(c₀+c₁) mod 2. In Tables 2 and 3, “x” and “y” are placeholder bits used during scrambling to maximize the Euclidian distance of modulation symbols carrying UCI bits.

TABLE 2

| Qₘ | Encoded Bits |
|---|---|
| 1 | [c₀] |
| 2 | [c₀ y] |
| 4 | [c₀ y x x] |
| 6 | [c₀ y x x x x] |
| 8 | [c₀ y x x x x x x] |

TABLE 3

| Qₘ | Encoded Bits |
|---|---|
| 1 | [c₀ c₁ c₂] |
| 2 | [c₀ c₁ c₂ c₀ c₁ c₂] |
| 4 | [c₀ c₁ x x c₂ c₀ x x c₁ c₂ x x] |
| 6 | [c₀ c₁ x x x x c₂ c₀ x x x x c₁ c₂ x x x x] |
| 8 | [c₀ c₁ x x x x x x c₂ c₀ x x x x x x c₁ c₂ x x x [symbol] |

[symbol]

indicates data missing or illegible when filed

Blocks with payload size between 3 and 11 bits are encoded using Reed-Muller coding with a 32-bit basis vector. Blocks larger than 11 bits use polar coding. Rate matching adjusts the size of the encoded data to fit within the allocated resources. This is then followed by CB concatenation for data that has been segmented into multiple blocks. The encoded bit streams for HARQ-ACK, CSI-part1 and CSI-part2 has size of GACK, GCSI-part1, GCSI-part2 bits respectively.

FIG. 23 illustrates a diagram of example PUSCH processing 2300 according to embodiments of the present disclosure. For example, PUSCH processing 2300 can be implemented by any of the UEs 111-116 of FIG. 1, such as the UE 113. This example is for illustration only and other embodiments can be used without departing from the scope of the present disclosure.

When UL-SCH and UCI are transmitted on the same PUSCH, the UL-SCH and UCI encoded bit streams are multiplexed based on the following rules.
UCI is not multiplexed on DMRS symbols
A RE across layers of the same transport block is either used for UL-SCH or for a UCI type.
If frequency hopping is enabled, the UCI symbols are split equally (or almost equally) between the frequency hops.
   Improves performance with frequency diversity.
ACK is multiplexed starting from the first non-DMRS symbol after first block of DMRS symbols in each frequency hop
   Improves performance (ACK is close to DMRS for better channel estimation)
   Reduces latency
CSI is multiplexed starting from first non-DMRS symbols of each hop
   Reduces latency
Multiplexing order: HARQ-ACK->CSI-part 1->CSI-part 2->UL-SCH
If the number of HARQ-ACK bits is 0, 1 or 2 bits reserved elements are calculated expecting 2 HARQ-ACK bits.

With reference to FIG. 23, the PUSCH processing starting with the multiplexing of UL-SCH and UCI is shown.

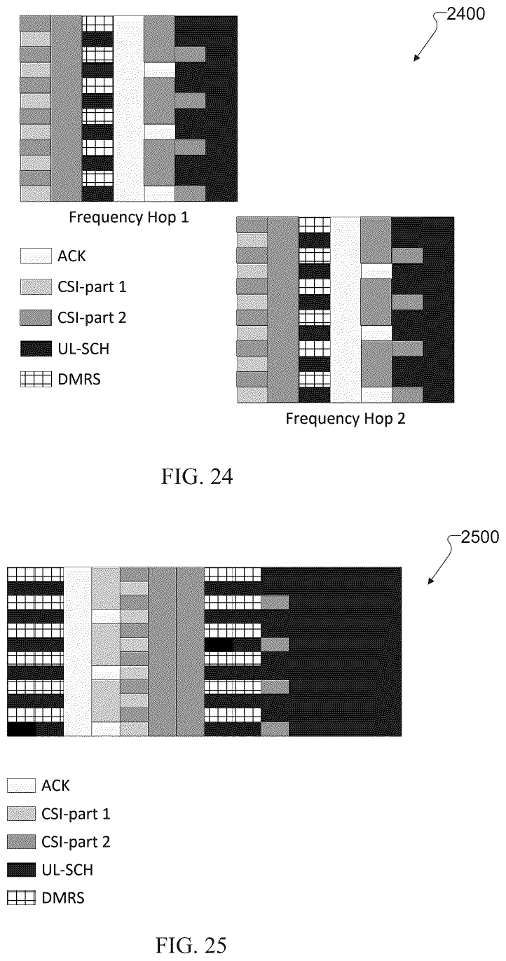

FIG. 24 illustrates a diagram of example multiplexing 2400 according to embodiments of the present disclosure. For example, multiplexing 2400 can be utilized by any of the UEs 111-116 of FIG. 1, such as the UE 114. This example is for illustration only and other embodiments can be used without departing from the scope of the present disclosure.

FIG. 25 illustrates a diagram of example multiplexing 2500 according to embodiments of the present disclosure. For example, multiplexing 2500 can be utilized by any of the UEs 111-116 of FIG. 1, such as the UE 115. This example is for illustration only and other embodiments can be used without departing from the scope of the present disclosure.

With reference to FIG. 24, an example of multiplexing ACK, CSI-part1, CSI-part2 and UL-SCH on a PUSCH with a non-front-end loaded DMRS, and with frequency hopping is shown.
First, ACK bits are mapped to the first non-DMRS symbol after the first block of DMRS symbols in each frequency hop. In the example of FIG. 24, the ACK REs fill the REs of the first symbol after the first block of DMRS symbols in each frequency hop, there are fewer remaining ACK REs than the REs of the second symbol after the first block of DMRS symbols in each frequency hop, the remaining ACK REs are disturbed within the second symbol after the first block of DMRS symbols in each frequency hop.
CSI-part1 is multiplexed starting from the first non-DMRS symbol of each frequency hop. In the example, of FIG. 24, CSI-part1 has fewer REs than the available REs in the first symbol of each frequency hop, the CSI-part1 REs are distributed within the first symbol of each frequency hop.
CSI-part2 is multiplexed starting from the first non-DMRS symbol of each frequency hop, using REs that have not been used by ACK, or CSI-part1, and not using symbols with DMRS.
The remaining REs are then used for UL-SCH.

With reference to FIG. 25, another example of multiplexing ACK, CSI-part1, CSI-part2 and UL-SCH on a PUSCH with a front-end loaded DMRS, and without frequency hopping is shown.

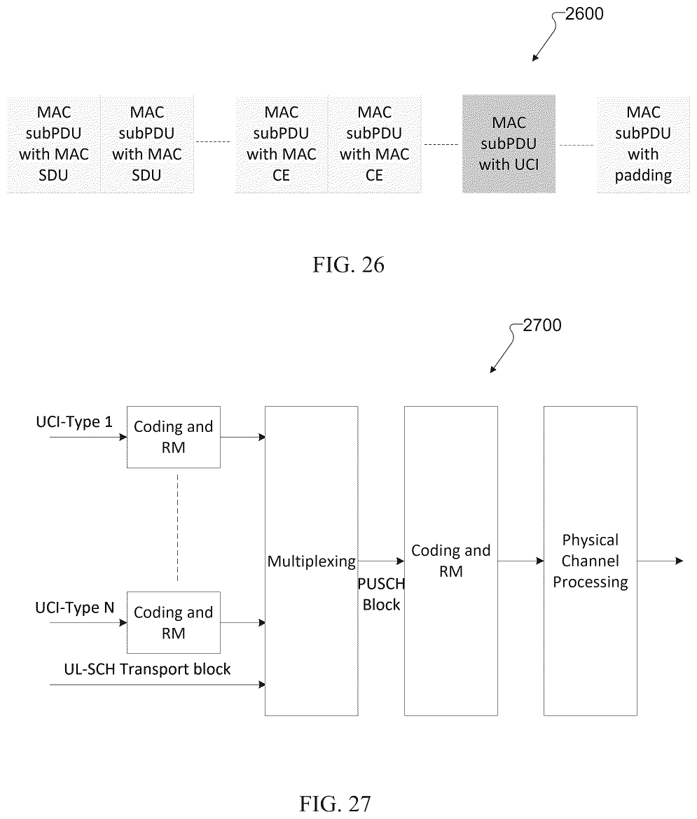

FIG. 26 illustrates a diagram of an example MAC PDU configuration 2600 according to embodiments of the present disclosure. For example, MAC PDU configuration 2600 can be implemented by any of the UEs 111-116 of FIG. 1, such as the UE 116. This example is for illustration only and other embodiments can be used without departing from the scope of the present disclosure.

In NR, the multiplexing of multiple streams with different encoding and mapping rules of the implementation increases the implementation complexity. In this disclosure, a method is presented to simplify the multiplexing of UL-SCH and UCI on the same PUSCH.

One alternative is to multiplex the UL control information (UCI) in layer-two (L2). For example, the physical layer provides L2 with UCI, such as HARQ-ACK or CSI and L2 transmits UCI in separate transport blocks or multiplexes with UL-SCH, e.g., in a MAC-PDU as illustrated in FIG. 26 or in an ASN.1 message (e.g., RRC message). FIG. 26 illustrates an example where a MAC subPDU with UCI information is multiplexed with other MAC subPDUs to form a MAC PDU, that becomes the transport block (TB) presented to the physical layer for encoding and transmission.

Embodiments of the present disclosure further recognizes a potential concern with multiplexing UCI information with other MAC subPDUs (or ASN.1 sub-blocks) (e.g., for UL-SCH or MAC CE), which is that the error rate of UCI becomes the same as the error rate of MAC PDU. In some cases, the target error rate for UCI is designed to be lower (e.g., 1%), than the UL error rate for UL-SCH (e.g., 10%). However, if there is a second level of encoding of UCI data before multiplexing into the MAC PDU, this can improve the error rate of the UCI compared to the UL-SCH. Another concern with multiplexing UCI information into the MAC PDU (or ASN.1 Message), is that extra latency associated with MAC (or ASN.1) processing. In one embodiment of this disclosure, using a second level of encoding for UCI Type(s) before multiplexing with UL-SCH is provided. In another embodiment of this disclosure, the encoded UCI-Type blocks are directly multiplexed with the encoded codeblocks of the transport (or UL-SCH), where multiplexing happens in the bit domain, as explained in this disclosure, the encoded data this is followed by the PUSCH processing.

The present disclosure relates to a 5G/NR and/or 6G communication system.

This disclosure provides aspects related to mapping and multiplexing of UL control information onto UL physical channels. This disclosure includes the following:
Multiplexing UCI blocks with un-encoded UL-SCH transport in the same PUSCH blocks.
Location of UCI blocks within PUSCH block.
Multiplexing UCI blocks with encoded UL-SCH transport in the same PUSCH blocks.
Location of UCI blocks within PUSCH block.

In the following, both FDD and TDD are regarded as a duplex method for DL and UL signaling. In addition, full duplex (XDD) operation is possible, e.g., sub-band full duplex (SBFD) or single frequency full duplex (SFFD).

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure provides several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based RRC signaling (e.g., SIB1 or other SIB) or (2) RRC dedicated signaling that is sent to a specific UE wherein the information can be common/cell-specific information or dedicated/UE-specific information or (3) UE-group RRC signaling.

In this disclosure MAC CE signaling can be UE-specific e.g., to one UE or can be UE common (e.g., to a group of UEs). MAC CE signaling can be DL MAC CE signaling or UL MAC CE signaling.

In this disclosure L1 control signaling includes: (1) DL control information (e.g., DCI on PDCCH or DL control information on PDSCH) and/or (2) UL control information (e.g., UCI on PUCCH or PUSCH). L1 control signaling be UE-specific e.g., to one UE or can be UE common (e.g., to a group of UEs).

In this disclosure a list with N elements can be denoted as L(i), where i can take N values, and L(i) can correspond to the element or entry associated with index i. In one example, i can take N arbitrary values. In one example, i=0, 1, . . . , N−1. In one example, i=1, 2, . . . , N. In one example, i is an identity of an element in the list.

In the present disclosure, the term “activation” describes an operation wherein a UE receives and decodes first information provided by a first signal from the network (or gNB (e.g., the BS 102)) and, based on the first information, the UE determines a starting point in time. The starting point can be a present or a future slot/subframe or symbol and the exact location is either implicitly or explicitly indicated or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and, based on the second information from the signal, the UE determines a stopping point in time. The stopping point can be a present or a future slot/subframe or symbol and the exact location is either implicitly or explicitly indicated or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

Terminology such as UCI, MAC CE, PUCCH, PUSCH, transport block and other terms are used for illustrative purposes and is therefore not normative. Other terms that refer to the same functions can also be used.

In this disclosure, UL control information can include the following UL control information types:
HARQ-ACK for DL transport blocks.
Scheduling request (SR).
Channel state information (CSI). In one example, CSI can be a single part CSI. In another example, CSI can be a two-part CSI, e.g., a first part CSI and a second part CSI.
Link recovery request (LRR), this can be similar to SR.
Beam indication/report (introduced in 3GPP Rel-19), e.g., UEI indicator and UEI beam report.
Transport format indication information, e.g., indicating modulation coding scheme (e.g., modulation order and/or code rate), and/or transport block size and/or resource allocation and/or HARQ related parameters and/or MIMO related parameters of data conveyed in the UL physical channel.

In one example, the information corresponding to each of the UL control information types mentioned herein can be transmitted independently, e.g., the information for each UL control information type is separately encoded and multiplexed or mapped onto the physical UL channel.

In another example, information corresponding to each of the UL control information types mentioned herein can be first multiplexed, and then jointly encoded, rate-matched, scrambled and/or modulated and mapped to resource elements of the corresponding physical UL channel. For example, in NR, when CSI has one part, the HARQ-ACK, SR and CSI information are multiplexed, and jointly pass through the encoding and transmission stages and are transmitted on PUCCH.

In another example, the UL control information types are divided into groups, where information corresponding to each group of UL control information types can be first multiplexed, and then jointly encoded, rate-matched, scrambled and/or modulated and mapped to resource elements of the corresponding physical UL channel. For example, in NR, when CSI has two parts, the HARQ-ACK, SR and first part CSI information are multiplexed to give first part of UCI and jointly pass through the encoding and transmission stages and are transmitted on PUCCH. The second part CSI can be separately encoded and mapped to the remaining PUCCH resources. UL control information types that are multiplexed together and jointly encoded and transmitted can have similar transport characteristics.

FIG. 27 illustrates a diagram of example UL multiplexing/processing 2700 according to embodiments of the present disclosure. For example, UL multiplexing/processing 2700 can be implemented by the UE 116 of FIG. 3. This example is for illustration only and other embodiments can be used without departing from the scope of the present disclosure.

Multiplexing of encoded UCI with un-encoded transport block is provided.

In one example, one or more UCI streams or blocks (e.g., N UCI stream(s) or block(s)) and UL-SCH transport block(s) are available for transmission on PUSCH as illustrated in FIG. 27.

The output of multiplexing in FIG. 27 is a referred to in this disclosure as a PUSCH block.

In one example, if there are two UL-SCH transport blocks on PUSCH, the UCI information (blocks) is split into two parts, e.g., equally or almost equally (e.g., due to rounding to an integer) and each part is multiplexed on a UL-SCH transport block, to provide a PUSCH block, as described in this disclosure.

In one example, if there are M UL-SCH transport blocks on PUSCH, the UCI information (blocks) is split into M parts, e.g., equally or almost equally (e.g., due to rounding to an integer) and each part is multiplexed on a UL-SCH transport block, to provide a PUSCH block, as described in this disclosure.

In one example, if there are more than one UL-SCH transport blocks on PUSCH, the UCI information is multiplexed on one of the UL-SCH transport blocks, to provide a PUSCH block, as described in this disclosure. The UL-SCH channel transport block on which UCI is multiplexed can be:
The first transport block.
The last transport block.
Transport with largest modulation coding scheme (MCS) index.
Transport with the smallest modulation coding scheme (MCS) index.
Transport with the largest initial modulation coding scheme (MCS) index. The initial MCS index is the MCS index of the first (initial) transmission of a transport block.
Transport with the smallest initial modulation coding scheme (MSC) index.
Transport with smallest initial modulation coding scheme (MCS) index. The initial MCS index, is the MCS index of the first (initial) transmission of a transport block.
Transport block is configured or indicated by the network (e.g., the network 130) (e.g., gNB). In one example, the transport block is configured and/or indicated by RRC message (e.g., ASN.1) and/or MAC CE and/or L1 control (e.g., DCI Format). In one example, the transport block to use for multiplexing is indicated by a DCI scheduling the corresponding UL transmission.

In one example, if there are more than one UL-SCH transport blocks on PUSCH, a first UCI information of or more UCI Types is multiplexed with a first UL-SCH transport blocks, to provide a first PUSCH block. A second UCI information of or more UCI Types is multiplexed with a second UL-SCH transport blocks, to provide a second PUSCH block, . . . . A transport block to multiplex a UCI information with is configured or indicated by the network (e.g., gNB). In one example, the transport block is configured and/or indicated by RRC message (e.g., ASN.1) and/or MAC CE and/or L1 control (e.g., DCI Format). In one example, the transport block to use for multiplexing a UCI information is indicated by a DCI scheduling the corresponding UL transmission.

With reference to FIG. 27, the PUSCH block goes through encoding and physical channel processing and then transmitted over the air, wherein the encoding and physical channel processing can include one or more of the following:
CRC for the PUSCH block.
CB segmentation of the PUSCH block (e.g., if size of PUSCH block is larger than that of encoder).
CB CRC for each CB segment.
Encoding of CB (e.g., using low-density parity-check (LPDC) coding).
Rate matching to fit within the resources of PUSCH. In one example, rate matching is performed separately for each CB, e.g., CB concatenation is after rate matching. In one example, rate matching is performed jointly for CBs, e.g., CB concatenation is before rate matching.
CB concatenation to combine the encoded CBs. In one example, CB concatenation is after rate matching. In one example, CB concatenation is before rate matching.
Scrambling
Modulation
Layer mapping
Antenna pre-coding
DFT-spread OFDM pre-coding, e.g., when DFT-spread OFDM is used.

OFDM symbol generation including iFTT and appending cyclic-prefix (CP).

In one example, N is the number of UCI-Types multiplexed with UL-SCH (e.g., TB(s) from L2).

In one example, N=1, and UCI-Type1 is ACK.

In one example, N=1, and UCI-Type1 is CSI or CSI-part1 or CSI-part2 (for example CSI-part1 can be transmitted in a separate channel).

In one example, N=1, and UCI-Type1 is ACK+CSI, or ACK+CSI-part1 or ACK+CSI-part2 (for example CSI-part1 can be transmitted in a separate channel).

In one example, N=1, and UCI-Type1 is ACK+CSI-part1+CSI-part2.

In one example, N=2, and UCI-Type1 is ACK, and UCI-Type2 is CSI.

In one example, N=2, and UCI-Type1 is ACK, and UCI-Type2 is CSI-part1.

In one example, N=2, and UCI-Type1 is ACK, and UCI-Type2 is CSI-part2 (for example CSI-part1 can be transmitted in a separate channel).

In one example, N=2, and UCI-Type1 is ACK, and UCI-Type2 is CSI-part1+CSI-part2.

In one example, N=2, and UCI-Type1 is ACK+CSI-part1, and UCI-Type2 is CSI-part2.

In one example, N=2, and UCI-Type1 is ACK+CSI-part2, and UCI-Type2 is CSI-part1.

In one example, N=2, and UCI-Type1 is ACK, and UCI-Type2 is CSI-part1+CSI-part2.

In one example, N=2, and UCI-Type1 is CSI-part1, and UCI-Type2 is CSI-part2.

In one example, N=3, and UCI-Type1 is ACK, and UCI-Type2 is CSI-part1, and UCI-Type2 is CSI-part2.

In one example, there can be other UCI-Types, e.g., power head room report or buffer status report or information to assist with decoding of the PUSCH (e.g., related MCS/payload size, etc. of the PUSCH transmission), or beam indication (UE initiated indicator)/report (introduced in 3GPP Rel-19), etc. . . .

In one example, a CRC is added to a UCI-Type block before channel coding. In one example, no CRC is added to a UCI-Type block before channel coding. In one example, if the payload size of a UCI-Type block is less than (or less than or equal to) A, no CRC is added, and if the payload size of a UCI-Type block is greater than or equal to (or greater than) A, a CRC is added, wherein A can be defined in the system specifications and/or configured or updated by RRC or MAC CE or L1 control (e.g., DCI Format) signaling. In one example, the size and/or polynomial of the CRC depends on the payload size of the UCI-Type block. In one example, if the UCI-Type block is greater than (or greater than or equal to) B, the block is segmented into multiple code blocks, with size not greater than Sₘₐₓ, B and/or Sₘₐₓ can be defined in the system specifications and/or configured or updated by RRC or MAC CE or L1 control (e.g., DCI Format) signaling.

In one example, the channel coding can be one of the following:
Simplex or repetition coding, where the information bits are repeated M times.
Block coding (e.g., (n,k) block), where k is the size of the UCI-Type block with CRC appended (or without CRC appended).
Convolutional coding.
Reed-Muller coding
Polar coding.
No channel coding

In one example, different UCI-types can have different channel coding methods

In one example, the channel coding method can depend on the UCI-Type payload size. For example:
Payload size <C1 channel coding method 0 is used, in some examples, channel coding method 0 may also depend on UCI-Type. In some example, there is no channel coding method 0, and the UCI payload isn't less than C1.
C1<=Payload size <C2 channel coding method 1 is used, in some examples, channel coding method 1 may also depend on UCI-Type
C2<=Payload size <C3 channel coding method 2 is used, in some examples, channel coding method 2 may also depend on UCI-Type
. . .
CK<=Payload size <C (K+1) channel coding method K is used, in some examples, channel coding method K may also depend on UCI-Type

In one example, C1 is 1 bit. In one example, C1 is 2 bits. In one example, C1 is 3 bits.

In one example C (K+1) is infinity, e.g., if CK<=Payload size channel coding method K is used, in some examples, channel coding method K may also depend on UCI-Type.

In one example, if Payload size <C1, common NR method is used for multiplexing UCI-Type into PUSCH, e.g., using reserved REs in PUSCH.

In one example, a beta offset or code rate for UCI (e.g., relative to code rate of UL-SCH) or similar parameter is configured. The number of bits for a UCI-Type can depend on the beta offset. For example, (Number of bits for encoded UCI Type can be number of bits presented to the multiplexing block of FIG. 27):

$$Number of encoded bits for UCI Type = D \cdot E$$

$$Or$$

$$Number of encoded bits for UCI Type = [ D \cdot E ]$$

$$Or$$

$$Number of encoded bits for UCI Type = [ D \cdot E ]$$

$$Or$$

$$Number of encoded bits for UCI Type = round [ D \cdot E ]$$

In one example, D is a parameter that controls the code rate of the UCI-Type relative to the code rate of the UL-SCH data. In one example, the parameter, D, is configured and/or updated by RRC and/or MAC CE and/or L1 control (e.g. DCI Format) signaling. In one example, the parameter, D, is or is based on a beta-offset (or the multiplicative inverse of a beta offset). In one example, the parameter, D, can be derived based on one or more of other parameters such as (the UCI Type is that for which the number of bits is for UCI Type is being calculated):
The code rate of the PUSCH channel.
The payload size of the UCI Type block.
The payload size of UL-SCH transport block multiplexed with the UCI Type in a same PUSCH block or in same PUSCH.
The payload size of other UCI Types multiplexed with the UCI Type in a same PUSCH block, or in a same PUSCH.
The modulation order of PUSCH.
The UCI Type.
A priority index of the UCI Type.
A priority index of the UL-SCH transport block multiplexed with the UCI Type in a same PUSCH block or in same PUSCH.
A priority index of other UCI Types multiplexed with the UCI Type in a same PUSCH block, or in a same PUSCH.
A parameter configured and/or updated by higher layer to control the code rate of the UCI Type.
A parameter configured and/or updated by higher layer to control the code rate of the UL-SCH transport block multiplexed with the UCI Type in a same PUSCH block or in same PUSCH.
A parameter configured and/or updated by higher layer to control the code rate of other UCI Types multiplexed with the UCI Type in a same PUSCH block, or in a same PUSCH.

In one example, E is the payload size of a UCI-Type+CRC size.

In one example, E is the payload size of a UCI-Type.

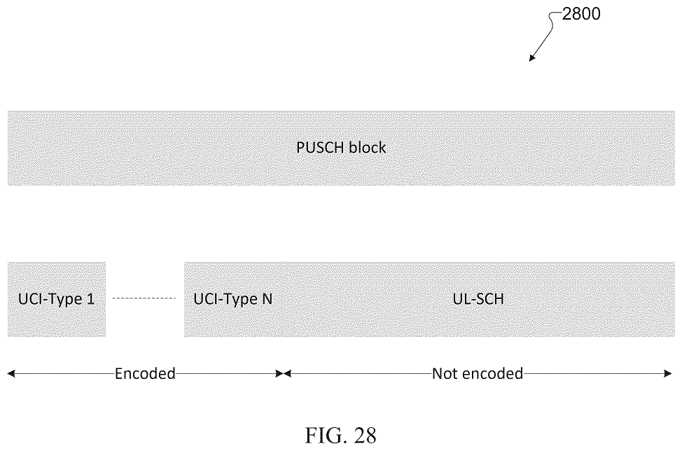

FIG. 28 illustrates a diagram of an example PUSCH block configuration 2800 according to embodiments of the present disclosure. For example, PUSCH block configuration 2800 can be implemented by any of the UEs 111-116 of FIG. 1, such as the UE 111. This example is for illustration only and other embodiments can be used without departing from the scope of the present disclosure.

In one example, the encoded UCI-Types are multiplexed before the UL-SCH transport block as shown in FIG. 28 to generate a PUSCH block. In one example, the mapping order of the coded and rate matched PUSCH block can be across frequency resources first (across sub-carriers of a symbol starting with the smallest sub-carrier), then across time resources second (across symbols of PUSCH starting with the earliest symbol). The mapping of UCI is on the earliest symbols of the PUSCH allocation.

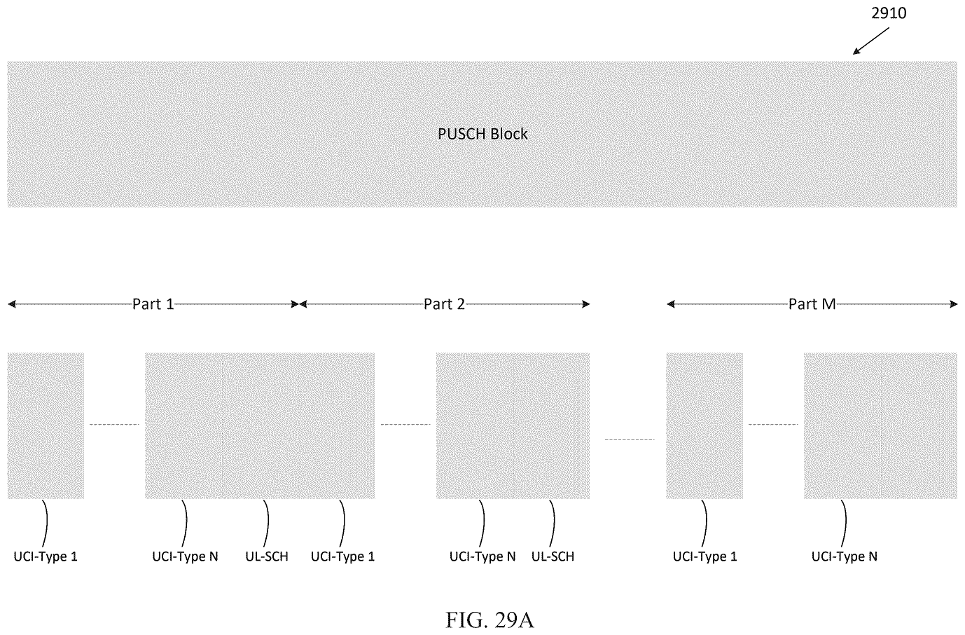

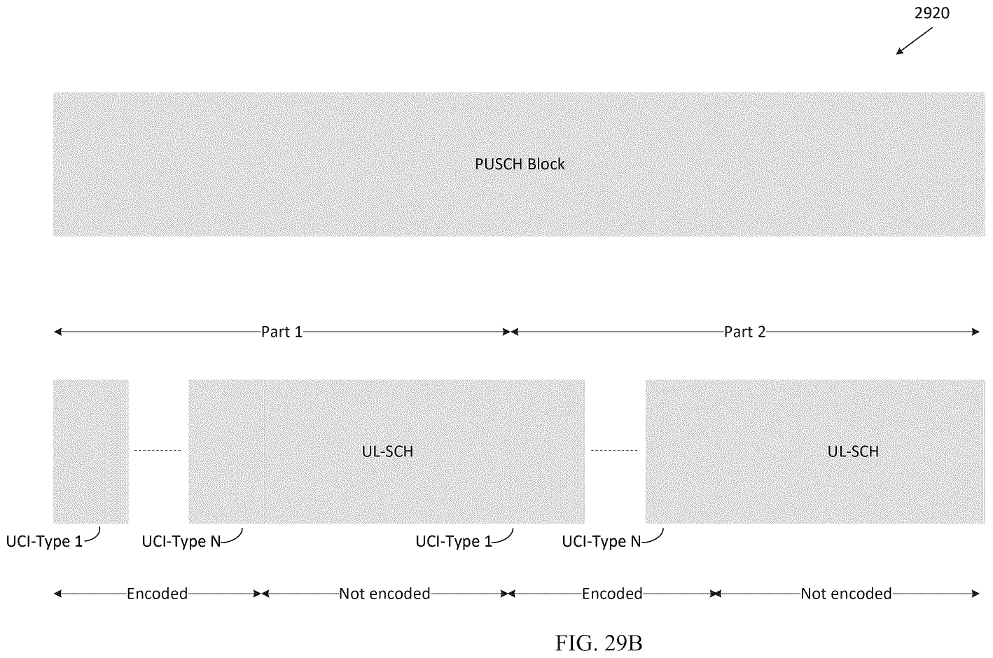

FIGS. 29A and 29B illustrate diagrams of example PUSCH block configurations 2910 and 2920 according to embodiments of the present disclosure. For example, PUSCH block configurations 2910 and 2920 can be implemented by any of the UEs 111-116 of FIG. 1, such as the UE 112. This example is for illustration only and other embodiments can be used without departing from the scope of the present disclosure.

In one example, the encoded UCI-Types are split into M-part and distributed throughout the UL-SCH transport block as shown in FIG. 29A to generate a PUSCH block.

In one example, the encoded UCI-Types are split into 2-parts (e.g., first frequency hop and second frequency hop) and distributed throughout the UL-SCH transport block as shown in FIG. 29B to generate a PUSCH block.

In one example, M=2, as illustrated in FIG. 29B, for example there are two parts corresponding to two frequency hops and the parts are equal or almost equal (e.g., due to rounding to an integer), wherein each part can correspond to a frequency hop. In one example, the mapping order of the coded and rate matched PUSCH block can be across frequency resources first (across sub-carriers of a symbol starting with the smallest sub-carrier), then across time resources second (across symbols of PUSCH starting with the earliest symbol), then across frequency hops. The mapping of UCI is on the earliest symbols of the PUSCH allocation in each frequency hop.

In one example, the multiplexing order of UCI-Type1, UCI-Type2, . . . . UCI-TypeN can be configured and/or updated by RRC and/or MAC CE and/or L1 control (e.g., DCI Format) signaling. In one example, this configuration can be by a parameter or field with a range of factorial N (N!) (e.g., from 0 to N!−1), e.g. as shown in Table 4 for N=3. In one example, only a subset of the alternatives of Table 4 is configured. In one example, the parameter or the field can be included in the PUSCH transmission. In one example, the parameter or the field can be included in an UL transmission associated with the PUSCH transmission. In one example, the parameter or the field can be included in a DCI scheduling the PUSCH transmission. In one example, the parameter or the field can be configured and/or updated by higher layers e.g., RRC message or MAC CE message.

TABLE 4

| Parameter or field value | Multiplexing order |
|---|---|
| 0 | UCI-Type1 −> UCI-Type2 −> UCI-Type3 |
| 1 | UCI-Type1 −> UCI-Type3 −> UCI-Type2 |
| 2 | UCI-Type2 −> UCI-Type1 −> UCI-Type3 |
| 3 | UCI-Type2 −> UCI-Type3 −> UCI-Type1 |
| 4 | UCI-Type3 −> UCI-Type1 −> UCI-Type2 |
| 5 | UCI-Type3 −> UCI-Type2 −> UCI-Type1 |

In one example, the multiplexing order of the UCI-Types can depend on PUSCH configuration, for example based on whether the PUSCH has a front-loaded DMRS or not, or on the location of the first DMRS. In one example, with a front-loaded DMRS, the multiplexing order can be (for N=3), UCI-Type1 (e.g., ACK)->UCI-Type2 (e.g., CSI-part1)->UCI-Type3 (e.g. CSI-part2), and with no front-loaded DMRS, the multiplexing order can be (for N=3), UCI-Type2 (e.g., CSI-part1)->UCI-Type3 (e.g., CSI-part2)->UCI-Type1 (e.g. ACK).

In one example, the multiplexing order of UCI-Type1, UCI-Type2, . . . . UCI-TypeN and UL-SCH can be configured and/or updated by RRC and/or MAC CE and/or L1 control (e.g., DCI Format) signaling. In one example, this configuration can be by a parameter or field with range factorial (N+1) ((N+1)!) (e.g., from 0 to (N+1)!−1), e.g. as shown in Table 5 for N=2. In one example, only a subset of the alternatives of Table 5 is configured. In one example, the parameter or the field can be included in the PUSCH transmission. In one example, the parameter or the field can be included in an UL transmission associated with the PUSCH transmission. In one example, the parameter or the field can be included in a DCI scheduling the PUSCH transmission. In one example, the parameter or the field can be configured and/or updated by higher layers e.g., RRC message or MAC CE message.

TABLE 5

| Parameter or field value | Multiplexing order |
|---|---|
| 0 | UCI-Type1 −> UCI-Type2 −> UL-SCH |
| 1 | UCI-Type1 −> UL-SCH −> UCI-Type2 |
| 2 | UCI-Type2 −> UCI-Type1 −> UL-SCH |
| 3 | UCI-Type2 −> UL-SCH −> UCI-Type1 |
| 4 | UL-SCH −> UCI-Type1 −> UCI-Type2 |
| 5 | UL-SCH −> UCI-Type2 −> UCI-Type1 |

In one example, a UCI type can be multiplex at a starting position in the PUSCH block determined by the location of the first DMRS symbol, or the first non-DMRS symbol after the first block of DMRS symbols.

In one example, with no frequency hopping and N=3:
Let the number of UCI-Type1 bits at the input to the multiplexing block of FIG. 27 be N_{UCI1}.
Let the number of UCI-Type2 bits at the input to the multiplexing block of FIG. 27 be N_{UCI2}.
Let the number of UCI-Type3 bits at the input to the multiplexing block of FIG. 27 be N_{UCI3}.
Let the number of UL-SCH bits at the input to the multiplexing block of FIG. 27 be N_{ULSCH1}.
Let the number of REs of a PUSCH channel be N_{PUSCH}.
In one example, let the number of REs of a PUSCH channel before the first non-DMRS symbol after first block of DMRS symbols be N_{PUSCH1}. In one example, let the number of REs of a PUSCH channel before the first DMRS symbol be N_{PUSCH1}.

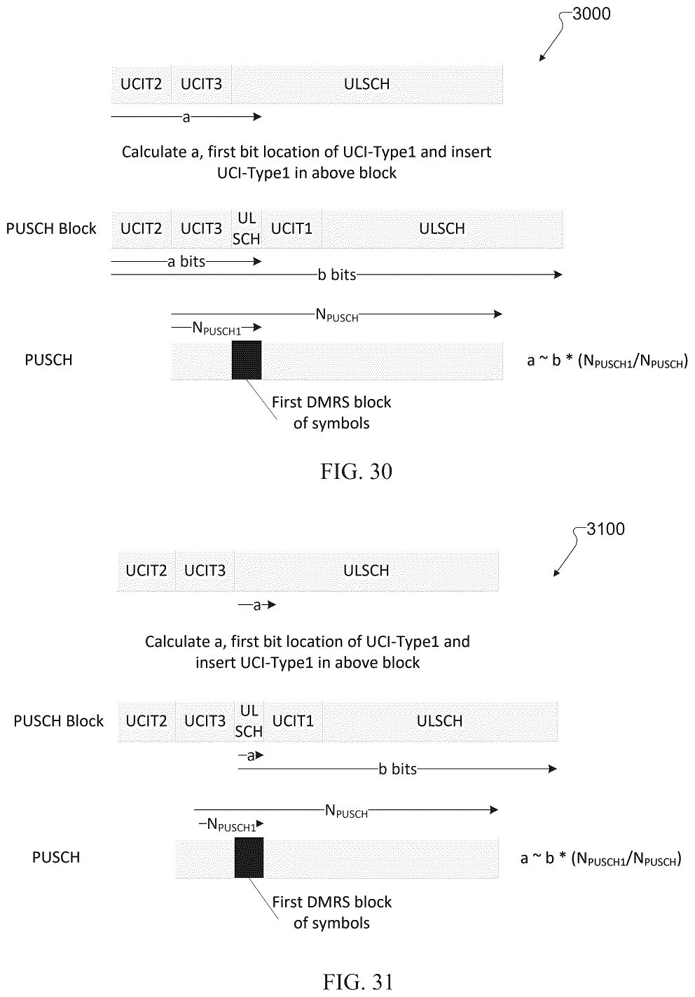

FIG. 30 illustrates a diagram of an example PUSCH block configuration 3000 according to embodiments of the present disclosure. For example, PUSCH block configuration 3000 can be implemented by any of the UEs 111-116 of FIG. 1, such as the UE 113. This example is for illustration only and other embodiments can be used without departing from the scope of the present disclosure.

FIG. 31 illustrates a diagram of an example PUSCH block configuration 3100 according to embodiments of the present disclosure. For example, PUSCH block configuration 3100 can be implemented by any of the UEs 111-116 of FIG. 1, such as the UE 114. This example is for illustration only and other embodiments can be used without departing from the scope of the present disclosure.

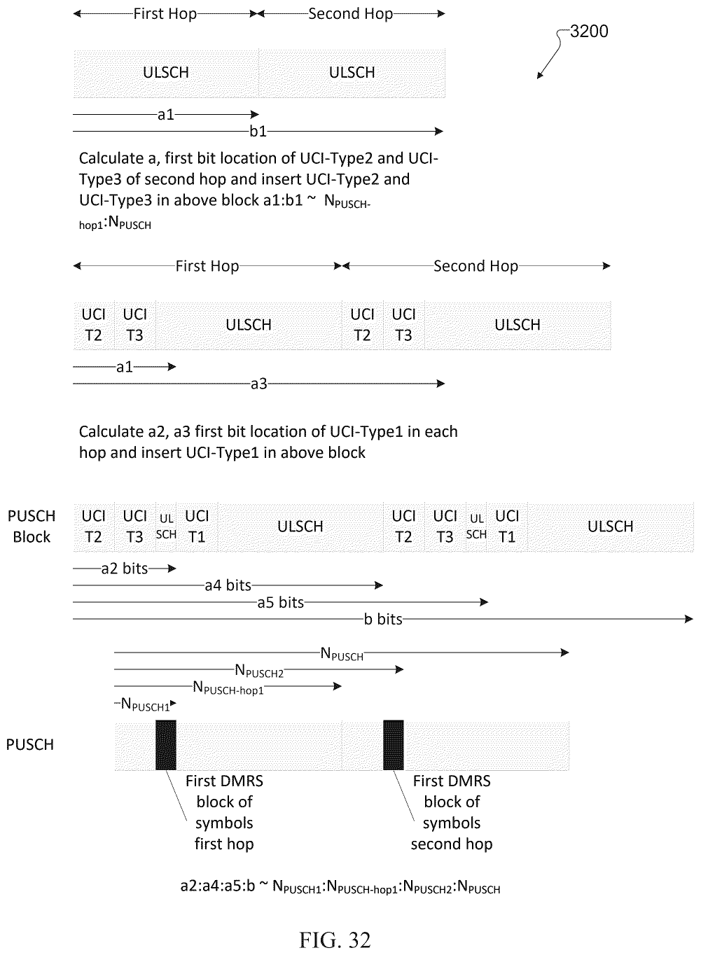

FIG. 32 illustrates a diagram of an example PUSCH block configuration 3200 according to embodiments of the present disclosure. For example, PUSCH block configuration 3200 can be implemented by any of the UEs 111-116 of FIG. 1, such as the UE 115. This example is for illustration only and other embodiments can be used without departing from the scope of the present disclosure.

In one example, UCI-Type2 and UCI-Type3 are multiplexed from the start of the PUSCH block followed by UL-SCH transport block. UCI-Type1 is inserted in the block including UCI-Type2, UCI-Type3 and UL-SCH starting from bit a, as illustrated in FIG. 30, where a is given by:

$$In one example a = ⌊ \frac{{N}_{PUSCH 1}}{{N}_{PUSCH 1} + {N}_{PUSCH}} ( {N}_{UCI 1} + {N}_{UCI 2} + {N}_{UCI 3} + {N}_{ULSCH} ) ⌋$$

$$In one example a = ⌈ \frac{{N}_{PUSCH 1}}{{N}_{PUSCH 1} + {N}_{PUSCH}} ( {N}_{UCI 1} + {N}_{UCI 2} + {N}_{UCI 3} + {N}_{ULSCH} ) ⌉$$

$$In one example a = round [ \frac{{N}_{PUSCH 1}}{{N}_{PUSCH 1} + {N}_{PUSCH}} ( {N}_{UCI 1} + {N}_{UCI 2} + {N}_{UCI 3} + {N}_{ULSCH} ) ]$$

$$In one example a = ⌊ \frac{{N}_{PUSCH 1}}{{N}_{PUSCH 1} + {N}_{PUSCH}} ( {N}_{UCI 2} + {N}_{UCI 3} + {N}_{ULSCH} ) ⌋$$

$$In one example a = ⌈ \frac{{N}_{PUSCH 1}}{{N}_{PUSCH 1} + {N}_{PUSCH}} ( {N}_{UCI 2} + {N}_{UCI 3} + {N}_{ULSCH} ) ⌉$$

$$In one example a = round [ \frac{{N}_{PUSCH 1}}{{N}_{PUSCH 1} + {N}_{PUSCH}} ( {N}_{UCI 2} + {N}_{UCI 3} + {N}_{ULSCH} ) ]$$

$$In one example a = ⌊ \frac{{N}_{PUSCH 1}}{{N}_{PUSCH}} ( {N}_{UCI 1} + {N}_{UCI 2} + {N}_{UCI 3} + {N}_{ULSCH} ) ⌋$$

$$In one example a = ⌈ \frac{{N}_{P U SCH 1}}{{N}_{PUSCH}} ( {N}_{UCI 1} + {N}_{UCI 2} + {N}_{UCI 3} + {N}_{ULSCH} ) ⌉$$

$$In one example a = round [ \frac{{N}_{P U SCH 1}}{{N}_{PUSCH}} ( {N}_{UCI 1} + {N}_{UCI 2} + {N}_{UCI 3} + {N}_{ULSCH} ) ]$$

$$In one example a = ⌊ \frac{{N}_{P U SCH 1}}{{N}_{PUSCH}} ( {N}_{UCI 2} + {N}_{UCI 3} + {N}_{ULSCH} ) ⌋$$

$$In one example a = ⌈ \frac{{N}_{P U SCH 1}}{{N}_{PUSCH}} ( {N}_{UCI 2} + {N}_{UCI 3} + {N}_{ULSCH} ) ⌉$$

$$In one example a = round [ \frac{{N}_{PUSCH 1}}{{N}_{PUSCH 1} + {N}_{PUSCH}} ( {N}_{UCI 2} + {N}_{UCI 3} + {N}_{ULSCH} ) ]$$

In one example, N_{PUSCH1} is the number of PUSCH REs available for data transmission (e.g., UL-SCH and UCI) before the first RE to which UCI-Type1 is mapped (e.g., REs available for data transmission before the first block of DMRS, or REs available for data transmission up to and including the first block of DMRS). In one example, N_{PUSCH} is the total number of REs available for data transmission in PUSCH. In a variant example, REs can be replaced by coded bits.

In one example, UCI-Type2 and UCI-Type3 are multiplexed from the start of the PUSCH block followed by UL-SCH transport block as illustrated in FIG. 31. UCI-Type1 is inserted in the UL-SCH transport block starting from bit a (a is counted within the UL-SCH transport block), where a is given by:

$$In one example a = ⌊ \frac{{N}_{P U SCH 1}}{{N}_{P U SCH 1} + {N}_{P U S C H}} ( {N}_{UCI 1} + {N}_{U L S C H} ) ⌋$$

$$In one example a = ⌈ \frac{{N}_{P U SCH 1}}{{N}_{P U SCH 1} + {N}_{P U S C H}} ( {N}_{UCI 1} + {N}_{U L S C H} ) ⌉$$

$$In one example a = round [ \frac{{N}_{P U SCH 1}}{{N}_{P U SCH 1} + {N}_{P U S C H}} ( {N}_{UCI 1} + {N}_{U L S C H} ) ]$$

$$In one example a = ⌊ \frac{{N}_{P U SCH 1}}{{N}_{P U SCH 1} + {N}_{P U S C H}} {N}_{U L S C H} ) ⌋$$

$$In one example a = ⌈ \frac{{N}_{P U SCH 1}}{{N}_{P U SCH 1} + {N}_{P U S C H}} {N}_{U L S C H} ) ⌉$$

$$In one example a = round [ \frac{{N}_{P U SCH 1}}{{N}_{P U SCH 1} + {N}_{P U S C H}} {N}_{U L S C H} ]$$

$$In one example a = ⌊ \frac{{N}_{P U SCH 1}}{{N}_{P U S C H}} ( {N}_{UCI 1} + {N}_{U L S C H} ) ⌋$$

$$In one example a = ⌈ \frac{{N}_{P U SCH 1}}{{N}_{P U S C H}} ( {N}_{UCI 1} + {N}_{U L S C H} ) ⌉$$

$$In one example a = round [ \frac{{N}_{P U SCH 1}}{{N}_{P U S C H}} ( {N}_{UCI 1} + {N}_{U L S C H} ) ]$$

$$In one example a = ⌊ \frac{{N}_{P U SCH 1}}{{N}_{P U S C H}} {N}_{U L S C H} ⌋$$

$$In one example a = ⌈ \frac{{N}_{P U SCH 1}}{{N}_{P U S C H}} {N}_{U L S C H} ⌉$$

$$In one example a = round [ \frac{{N}_{P U SCH 1}}{{N}_{P U S C H}} {N}_{U L S C H} ]$$

In one example, N_{PUSCH1} is the number of PUSCH REs available for data transmission, excluding UCI-Type2 and UCI-Type3, if any, (e.g., UL-SCH and UCI-Type1) before the first RE to which UCI-Type1 is mapped (e.g., REs available for data transmission before the first block of DMRS, or REs available for data transmission up to and including the first block of DMRS). In one example, N_{PUSCH} is the total number of REs available for data transmission (e.g., UL-SCH and UCI-Type1) in PUSCH. In a variant example, REs can be replaced by coded bits.

In one example, with frequency hopping and N=3:
Let the number of UCI-Type1 bits at the input to the multiplexing block of FIG. 27 be N_{UCI1}.
Let the number of UCI-Type2 bits at the input to the multiplexing block of FIG. 27 be N_{UCI2}.
Let the number of UCI-Type3 bits at the input to the multiplexing block of FIG. 27 be N_{UCI3}.
Let the number of UL-SCH bits at the input to the multiplexing block of FIG. 27 be N_{ULSCH1}.
In one example, UCI-Type1 is split into two parts one part for each hop. In one example, the size of UCI part of first hop is

$$⌊ \frac{{N}_{UCI 1}}{2} ⌋$$

and size of UCI part of second hop is

$$⌈ \frac{{N}_{UCI 1}}{2} ⌉ .$$

In one example, the size of UCI part of first hop is

$$⌈ \frac{{N}_{UCI 1}}{2} ⌉$$

and size of UCI part of second hop is

$$⌊ \frac{{N}_{UCI 1}}{2} ⌋ .$$

In one example, UCI-Type2 is split into two parts one part for each hop. In one example, the size of UCI part of first hop is

$$⌊ \frac{{N}_{UCI 2}}{2} ⌋$$

In one and size or UCI part or second hop is

$$⌈ \frac{{N}_{UCI 2}}{2} ⌉ .$$

In one example, the size of UCI part of first hop is

$$⌈ \frac{{N}_{UCI 2}}{2} ⌉$$

and size of UCI part of second hop is

$$⌊ \frac{{N}_{UCI 2}}{2} ⌋ .$$

In one example, UCI-Type3 is split into two parts one part for each hop. In one example, the size of UCI part of first hop is

$$⌊ \frac{{N}_{UCI 3}}{2} ⌋$$

and size of UCI part of second hop is

$$⌈ \frac{{N}_{UCI 3}}{2} ⌉ .$$

In one example, the size of UCI part of first hop is

$$⌈ \frac{{N}_{UCI 3}}{2} ⌉$$

and size of UCI part of second hop is

$$⌊ \frac{{N}_{UCI 3}}{2} ⌋ .$$

In one example, UL-SCH is split into two parts one part for each hop. In one example, the size of UCI part of first hop is

$$⌊ \frac{{N}_{ULSCH 1}}{2} ⌋$$

and size of UCI part of second hop is

$$⌈ \frac{{N}_{ULSCH 1}}{2} ⌉ .$$

In one example, the size of UCI part of first hop is

$$⌈ \frac{{N}_{ULSCH 1}}{2} ⌉$$

and size of UCI part of second hop is

$$⌊ \frac{{N}_{ULSCH 1}}{2} ⌋ .$$

Let the number of REs of a PUSCH channel be N_{PUSCH}.
Let the number of REs of a PUSCH channel in first hop be N_{PUSCH-hop1}
In one example, let the number of REs of a PUSCH channel before the first non-DMRS symbol after first block of DMRS symbols be N_{PUSCH1}. In one example, let the number of REs of a PUSCH channel before the first DMRS symbol be N_{PUSCH1}.
In one example, let the number of REs of a PUSCH channel before the first non-DMRS symbol after first block of DMRS symbols of second hop be N_{PUSCH2}. In one example, let the number of REs of a PUSCH channel before the first DMRS symbol of second hop be N_{PUSCH2}.

With reference to FIG. 32, the first part of UCI-Type2 and UCI-Type3 is inserted at the start of the PUSCH block. The second part of UCI-Type2 and UCI-Type3 is inserted starting at bit location a4. The first part of UCI-Type1 is inserted starting at bit location a2. The first part of UCI-Type1 is inserted starting at bit location a5. The size of the PUSCH is b. The following can be used to determine a2, a4 and a5:

$$a 2 : a 4 : a 5 : b ∼ {N}_{PUSCH 1} : {N}_{PUSCH - hop 1} : {N}_{PUSCH 2} : {N}_{PUSCH}$$

In one example, if the number of resource elements allocated to PUSCH is N_{RE}, for example,

$${N}_{R E} = {N}_{s c}^{PUSCH} \cdot {N}_{s y m}^{PUSCH} ,$$

wherein

$${N}_{s c}^{PUSCH}$$

is the number of sub-carriers allocated to PUSCH (e.g., the product of the number of RBs allocated to PUSCH and the number of sub-carriers per RB), and

$${N}_{s y m}^{PUSCH}$$

is the number of symbols allocated to PUSCH

In one example, N_{RE-Data} is the number of REs available for transmission of data (e.g., UCI and UL-SCH). In one example, N_{RE-Data}=N_{RE}−N_{RE-DMRS}, wherein N_{RE-DMRS} is the number of RES used for DMRS including REs used for DMRS code-division multiplexing (CDM) groups without data. In one example, N_{RE-Data}=N_{RE}−N_{RE-DMRS}−Nₒₕ, wherein Non is overhead due other channels or signals (e.g., phase tracking reference signal (PTRS)). In one example, number of coded bits available for transmission of data is given by N_{cbits-Data}=Qₘ·N_{L}·N_{RE-Data}, wherein Qₘ is the number of bits per modulation symbol, for example, for binary phase-shift keying (BPSK), Qₘ=1, for QPSK Qₘ=2, for 16-QAM, Qₘ=4, for 64-QAM, Qₘ=6, for 256-QAM, Qₘ=8. In general, for 2²ⁿ-QAM, Qₘ=2n. N_{L} is the number of layers for a PUSCH block.

In one example, a modulation-coding-scheme is signaled in a DCI Format or configured by higher layers to determine the modulation scheme (e.g., Qₘ) and a code rate R, wherein the code rate can be defined as:

$$R = \frac{N umber of uncoded bits}{N umber of coded bits}$$

In one example, the number of uncoded bits, N_{ucbits-Data}, is given by N_{ucbits-Data}≅R·N_{cbits-Data}, wherein the uncoded bits can be the input to the multiplexing block of FIG. 27.

$${N}_{ucbits - Data} = {\sum }_{i = 1}^{N} {N}_{UCI - i} + {N}_{ULSCH}$$

### Therefore,

$${N}_{ULSCH} ≇ R \cdot {N}_{cbits - Data} = {\sum }_{i = 1}^{N} {N}_{UCI - i}$$

N_{ULSCH} can be used to determine the UL-SCH transport block size. In one example, to determine the UL-SCH transport block size, the transport block CRC size is further subtracted from N_{ULSCH}. In one example, to determine the UL transport block size, the CRC size of the code blocks is further subtracted from N_{ULSCH}. In one example, to determine the UL transport block size, the CRC size of the transport block and code blocks is further subtracted from N_{ULSCH}.

In one example, the equations mentioned herein are for initial PUSCH transmission.

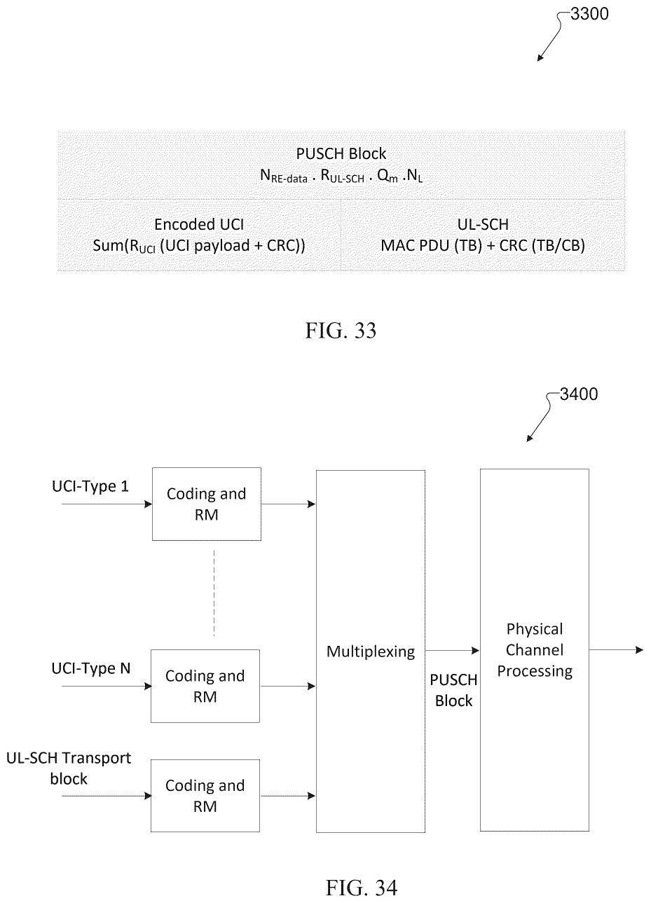

FIG. 33 illustrates a diagram of an example PUSCH block configuration 3300 according to embodiments of the present disclosure. For example, PUSCH block configuration 3300 can be implemented by any of the UEs 111-116 of FIG. 1, such as the UE 116. This example is for illustration only and other embodiments can be used without departing from the scope of the present disclosure.

With reference to FIG. 33, an example of partitioning a transport block is shown, e.g., corresponding to a PUSCH codeword among encode UCI and UL-SCH.

In one example, N_{RE-Data} is the number of REs available for transmission of data (e.g., UL-SCH). In one example, N_{RE-Data}=N_{RE}−N_{RE-DMRS}−Nₒₕ, Wherein N_{RE-DMRS} is the number of RES used for DMRS including REs used DMRS CDM groups without data, Non can represent REs used for transmissions other than UL-SCH and DMRS for example UCI. In one example, number of code bits available for transmission of data is given by N_{cbits-Data}=Qₘ·N_{L}·N_{RE-Data}, wherein Qₘ is the number of bits per modulation symbol as mentioned herein and N_{L} is the number of layers for a PUSCH block.

In one example, a modulation-coding-scheme is signaled in a DCI Format or configured by higher layers to determine the modulation scheme (e.g., Qₘ) and a code rate R, wherein the code rate can be defined as:

$$R = \frac{N umber of uncoded bits}{N umber of coded bits}$$

In one example, the number of uncoded bits, N_{ucbits-Data}, is given by N_{ucbits-Data}=R·N_{cbits-Data}, wherein the uncoded bits can be the UL-SCH bits.

$${N}_{ucbits - Data} = {N}_{ULSCH}$$

### Therefore,

$${N}_{ULSCH} ≅ R \cdot {N}_{c b its - Data}$$

N_{ULSCH} can be used to determine the UL-SCH transport block size. In one example, to determine the UL transport block size, the transport block CRC size is further subtracted from N_{ULSCH}. In one example, to determine the UL transport block size, the CRC size of the code blocks is further subtracted from N_{ULSCH}. In one example, to determine the UL transport block size, the CRC size of the transport block and code blocks is further subtracted from N_{ULSCH}.

In one example, the number of UCI bits at input to the multiplexer is approximately equal to:

$${\sum }_{i = 1}^{N} {N}_{UCI - i} ≅ R \cdot {Q}_{m} \cdot {N}_{L} \cdot {N}_{oh} .$$

In one example, if

$${\sum }_{i = 1}^{N} {N}_{UCI - i} > R \cdot {Q}_{m} \cdot {N}_{L} \cdot {N}_{oh} ,$$

UCI reports are dropped until

$${\sum }_{i = 1}^{N} {N}_{UCI - i} \leq R \cdot {Q}_{m} \cdot {N}_{L} \cdot {N}_{oh} ,$$

the dropped UCI reports can be in ascending priority order, starting with the lowest priority reports being dropped first.

In one example, if

$${\sum }_{i = 1}^{N} {N}_{UCI - i} > R \cdot {Q}_{m} \cdot {N}_{L} \cdot {N}_{oh} ,$$

a beta-offset parameter corresponding to a UCI-type (e.g., UCI-type with lowest priority, e.g., CSI-part2) is lowered to a lower configured value or values until

$${\sum }_{i = 1}^{N} {N}_{UCI - i} \leq R \cdot {Q}_{m} \cdot {N}_{L} \cdot {N}_{oh} .$$

If that condition can't be satisfied then either beta-offset values for other UCI-types are lowered or UCI reports for that UCI type are dropped in ascending priority order, until condition is satisfied.

For the PUSCH block, e.g., as illustrated in FIG. 28 or FIG. 29A, a CRC can be appended. In one example, the CRC is calculated over bits of the PUSCH block, i.e., UCI and UL-SCH bits. In one example, the CRC is calculated over the UL-SCH bits. In one example, if the size of the PUSCH block, e.g., as illustrated in FIG. 28 or FIG. 29A, e.g., after CRC has been appended, exceeds a maximum input size of the encoder (Sₘₐₓ) (e.g., LPDC encoder), the PUSCH block, e.g., after CRC has been appended, is segmented into multiple code blocks with size less than or equal to Sₘₐₓ, or Sₘₐₓ−S_{crc-CB}, where S_{crc-CB} is the size of the code block CRC.

In one example, code blocks have equal size, or almost equal size, within “one” bit for rounding. In one example, as illustrated in FIG. 28, the mapping of the UCI is to the earliest code blocks of a PUSCH transmission. In one example, as illustrated in FIG. 29A, the mapping of the UCI is to the earliest code blocks of a PUSCH transmission in each frequency hop.

In one example, a code block can be shared between UCI and UL-SCH. In one example, separate code blocks are used for UCI and UL-SCH. In one example, separate code blocks are used for each UCI type and UL-SCH. In one example a code block with only UCI data has no code block CRC. In one example, a code block with UCI data has no code block CRC. In one example, if only certain UCI types are present in a code block, there is no CRC, wherein UCI types with no code block CRC can be defined in the specifications or configured and/or updated by RRC and/or MAC CE and/or L1 control (e.g., DCI Format) signaling.

With regards to a retransmission of a PUSCH block, the following examples can apply:

In one example, UCI bits transmitted in an initial PUSCH transmission are retransmitted in a corresponding PUSCH re-transmission.

In one example, if the number of UCI bits in an initial PUSCH transmission at the input to the multiplexing block of FIG. 27 is N_{UCI}, the number of UCI bits in a corresponding PUSCH re-transmission at the input to the multiplexing block of FIG. 27 is N_{UCI}. In one example the UCI bits in the PUSCH retransmission can be different from the UCI bit of the corresponding initial PUSCH transmission. In one example the UCI bits in the PUSCH retransmission in a code block containing UL-SCH bits are the same as the corresponding bits in the corresponding initial transmission, and the UCI bits in the PUSCH retransmission in a code block not containing UL-SCH bits can be different from the UCI bits of the corresponding initial PUSCH transmission.

In one example:
the UCI bits in the PUSCH retransmission in a code block containing UL-SCH bits are the same as the corresponding bits in the corresponding initial transmission if the decoding of the code block fails, and
the UCI bits in the PUSCH retransmission in a code block containing UL-SCH bits can be different from the UCI bits of the corresponding initial PUSCH transmission if the decoding of the code block succeeds and the UE (e.g., the UE 116) receives an indication that the decoding of the code block has succeeded, and
the UCI bits in the PUSCH retransmission in a code block not containing UL-SCH bits can be different from the UCI bits of the corresponding initial PUSCH transmission.

In one example, if N_{UCI} of the initial PUSCH transmission is larger than N_{UCI} of corresponding re-transmission, one of the following examples can apply:
Bits are padded to the PUSCH re-transmission to have the same N_{UCI} as that of the corresponding initial PUSCH transmission.
Code blocks containing UL-SCH in the re-transmission have the same input bits as the corresponding code blocks of the corresponding initial PUSCH transmission. Other code blocks with UCI can have different input bits, including number of input bits.

In one example, if N_{UCI} of the initial PUSCH transmission is smaller than N_{UCI} of corresponding re-transmission, one of the following examples can apply:
Bits are drop from UCI of the re-transmission PUSCH, in order of priority as mentioned herein, to have the same N_{UCI} as that of the corresponding initial PUSCH transmission.
For code blocks containing UL-SCH with different number of UCI bits than initial transmission, UCI bits are dropped so as not to exceed the initial code rate on PUSCH, or so as not to exceed a second code rate for retransmissions on PUSCH. The remaining code blocks containing UL-SCH have the same UCI input bits as the corresponding code blocks of the corresponding initial PUSCH transmission. Other code blocks with UCI can have different input bits, including number of input bits.

FIG. 34 illustrates a diagram of example UL multiplexing/processing 3400 according to embodiments of the present disclosure. For example, UL multiplexing/processing 3400 can be implemented by the UE 116 of FIG. 3. This example is for illustration only and other embodiments can be used without departing from the scope of the present disclosure.

Multiplexing of encoded UCI with encoded transport block is provided.

In one example, one or more UCI streams or blocks (e.g., N UCI stream(s) or block(s)) and UL-SCH transport block(s) are available for transmission on PUSCH as illustrated in FIG. 34. In one example, the UCI and UL-SCH are mapped to separate code blocks. In one example, different UCI-Types are mapped to separate code blocks.

The output of multiplexing in FIG. 34 is referred to in this disclosure as a PUSCH block.

In one example, if there are two UL-SCH transport blocks on PUSCH, the UCI information (blocks) is split into two parts, e.g., equally or almost equally (e.g., due to rounding to an integer) and each part is multiplexed with a UL-SCH transport block, to provide a PUSCH block, as described in this disclosure.

In one example, if there are M UL-SCH transport blocks on PUSCH, the UCI information (blocks) is split into M parts, e.g., equally or almost equally (e.g., due to rounding to an integer) and each part is multiplexed with a UL-SCH transport block, to provide a PUSCH block, as described in this disclosure.

In one example, if there are more than one UL-SCH transport blocks on PUSCH, the UCI information is multiplexed with one of the UL-SCH transport blocks, to provide a PUSCH block, as described in this disclosure. The UL-SCH channel transport block with which UCI is multiplexed can be:
The first transport block.
The last transport block.
Transport with largest modulation coding scheme (MCS) index.
Transport with the smallest modulation coding scheme (MCS) index.
Transport with the largest initial modulation coding scheme (MCS) index. The initial MCS index, is the MCS index of the first (initial) transmission of a transport block.
Transport with the smallest initial modulation coding scheme (MCS) index.
Transport with smallest initial modulation coding scheme (MCS) index. The initial MCS index, is the MCS index of the first (initial) transmission of a transport block.
Transport block is configured or indicated by the network (e.g., the network 130) (e.g., gNB). In one example, the transport block is configured and/or indicated by RRC message (e.g., ASN.1) and/or MAC CE and/or L1 control (e.g., DCI Format). In one example, the transport block to use for multiplexing is indicated by a DCI scheduling the corresponding UL transmission.

In one example, if there are more than one UL-SCH transport blocks on PUSCH, a first UCI information of or more UCI Types is multiplexed with a first UL-SCH transport blocks, to provide a first PUSCH block. A second UCI information of or more UCI Types is multiplexed with a second UL-SCH transport blocks, to provide a second PUSCH block, . . . . A transport block to multiplex a UCI information with is configured or indicated by the network (e.g., gNB). In one example, the transport block is configured and/or indicated by RRC message (e.g., ASN.1) and/or MAC CE and/or L1 control (e.g., DCI Format). In one example, the transport block to use for multiplexing a UCI information is indicated by a DCI scheduling the corresponding UL transmission.

With reference to FIG. 34, each UCI-Type block is coded and rate matched separately (this also can include CRC addition and code block segmentation if applicable), the PUSCH block goes through physical channel processing and then transmitted over the air, wherein the physical channel processing can include one or more of the following:
Scrambling
Modulation
Layer mapping
Antenna pre-coding
DFT-spread OFDM pre-coding, e.g., when DFT-spread OFDM is used.
OFDM symbol generation including iFTT and appending cyclic-prefix (CP).

In one example, N is the number of UCI-Types multiplexed with UL-SCH (e.g., TB(s) from L2).

In one example, N=1, and UCI-Type1 is ACK.

In one example, N=1, and UCI-Type1 is CSI or CSI-part1 or CSI-part2 (for example CSI-part1 can be transmitted in a separate channel).

In one example, N=1, and UCI-Type1 is ACK+CSI, or ACK+CSI-part1 or ACK+CSI-part2 (for example CSI-part1 can be transmitted in a separate channel).

In one example, N=1, and UCI-Type1 is ACK+CSI-part1+CSI-part2.

In one example, N=2, and UCI-Type1 is ACK, and UCI-Type2 is CSI.

In one example, N=2, and UCI-Type1 is ACK, and UCI-Type2 is CSI-part1.

In one example, N=2, and UCI-Type1 is ACK, and UCI-Type2 is CSI-part2 (for example CSI-part1 can be transmitted in a separate channel).

In one example, N=2, and UCI-Type1 is ACK, and UCI-Type2 is CSI-part1+CSI-part2.

In one example, N=2, and UCI-Type1 is ACK+CSI-part1, and UCI-Type2 is CSI-part2.

In one example, N=2, and UCI-Type1 is ACK+CSI-part2, and UCI-Type2 is CSI-part1.

In one example, N=2, and UCI-Type1 is ACK, and UCI-Type2 is CSI-part1+CSI-part2.

In one example, N=2, and UCI-Type1 is CSI-part1, and UCI-Type2 is CSI-part2.

In one example, N=3, and UCI-Type1 is ACK, and UCI-Type2 is CSI-part1, and UCI-Type2 is CSI-part2.

In one example, there can be other UCI-Types, e.g., power head room report or buffer status report or information to assist with decoding of the PUSCH (e.g., related MCS/payload size, etc. of the PUSCH transmission), or beam indication (UE initiated indicator)/report (introduced in 3GPP Rel-19), etc. . . .

In one example, a CRC is added to a UCI-Type block before channel coding. In one example, no CRC is added to a UCI-Type block before channel coding. In one example, if the payload size of a UCI-Type block is less than (or less than or equal to) A, no CRC is added, and if the payload size of a UCI-Type block is greater than or equal to (or greater than A) A, a CRC is added, wherein A can be defined in the system specifications and/or configured or updated by RRC or MAC CE or L1 control (e.g., DCI Format) signaling. In one example, the size and/or polynomial of the CRC depends on the payload size of the UCI-Type block. In one example, if the UCI-Type block is greater than (or greater than or equal to) B, the block is segmented into multiple code blocks, with size not greater than Sₘₐₓ, B and/or Sₘₐₓ can be defined in the system specifications and/or configured or updated by RRC or MAC CE or L1 control (e.g., DCI Format) signaling.

In one example, the channel coding can be one of the following:
Simplex or repetition coding, where the information bits are repeated M times.
Block coding (e.g., (n,k) block), where k is the size of the UCI-Type block with CRC appended (or without CRC appended).
Convolutional coding.
Reed-Muller coding
Polar coding.
LDPC coding.
No channel coding

In one example, different UCI-types can have different channel coding methods

In one example, the channel coding method can depend on the UCI-Type payload size. For example:
Payload size <C1 channel coding method 0 is used, in some examples, channel coding method 0 may also depend on UCI-Type. In some example, there is no channel coding method 0, and the UCI payload isn't less than C1.
C1<=Payload size <C2 channel coding method 1, in some examples, channel coding method 1 may also depend on UCI-Type
C2<=Payload size <C3 channel coding method 2, in some examples, channel coding method 2 may also depend on UCI-Type
. . .
CK<=Payload size <C (K+1) channel coding method K, in some examples, channel coding method K may also depend on UCI-Type
In one example, C1 is 1 bit. In one example, C1 is 2 bits. In one example, C1 is 3 bits.

In one example C (K+1) is infinity, e.g., CK<=Payload size channel coding method K is used, in some examples, channel coding method K may also depend on UCI-Type.

In one example, if Payload size <C1, common NR method is used for multiplexing UCI-Type into PUSCH, e.g., using reserved REs in PUSCH.

In one example, the number of encoded and rate matched bits (e.g., at the input of the multiplexing block of FIG. 34) of a UCI Type or UL-SCH is an integer multiple of Qₘ·N_{L}, where Qₘ is a modulation order as mentioned herein and N_{L} is a number of layers used for the PUSCH block.

$$\begin{matrix}Number of bits for UCI Type = {Q}_{m} \cdot {N}_{L} \cdot {N}_{RE - UCI} \\ Number of bits for U ; L - SCH = {Q}_{m} \cdot {N}_{L} \cdot {N}_{RE - ULSCH}\end{matrix}$$

Where, N_{RE-UCI} is the number of PUSCH REs used for a UCI Type(s), and N_{RE-ULSCH} is the number of PUSCH REs used for UL-SCH transport block. In one example, the number of REs for the UCI-Type1 is N_{RE-UCI1}, the number of REs for the UCI-Type2 is N_{RE-UCI2}, . . . , the number of REs for the UCI-TypeN is N_{RE-UCIN}.

In one example, a beta offset or code rate for UCI or similar parameter is configured. The number of bits for a UCI-Type can depend on the beta offset. For example, Number of encoded bits for UCI Type can be number of bits presented to the multiplexing block for a UCI Type of FIG. 34 is:

$$Number of encoded bits for UCI Type = D \cdot E$$

$$Or$$

$$Number of encoded bits for UCI Type = ⌈ D \cdot E ⌉$$

$$Or$$

$$Number of encoded bits for UCI Type = ⌊ D \cdot E ⌋$$

$$Or$$

$$Number of encoded bits for UCI Type = round [ D \cdot E ]$$

$$Or$$

$$Number of bits UCI Type = {Q}_{m} \cdot {N}_{L} ⌊ \frac{D \cdot E}{{Q}_{m} \cdot {N}_{L}} ⌋$$

UCI blocks are mapped at RE level

### Or

$$Number of bits UCI Type = {Q}_{m} \cdot {N}_{L} ⌊ \frac{D \cdot E}{{Q}_{m} \cdot {N}_{L}} ⌋$$

UCI blocks are mapped at RE level

### Or

$$Number of bits UCI Type = {Q}_{m} \cdot {N}_{L} \cdot round [ \frac{D \cdot E}{{Q}_{m} \cdot {N}_{L}} ]$$

UCI blocks are mapped at RE level

### Or

$$Number of bits for UCI Type = {Q}_{m} \cdot {N}_{L} \cdot {N}_{sc}^{RB} ⌈ \frac{D \cdot E}{{Q}_{m} \cdot {N}_{L} \cdot {N}_{sc}^{RB}} ⌉$$

UCI blocks are mapped at PRB level.

$${N}_{sc}^{RB}$$

is the number of sub-carriers per resource block (e.g., 12)

### Or

$$Number of bits for UCI Type = {Q}_{m} \cdot {N}_{L} \cdot {N}_{sc}^{RB} ⌊ \frac{D \cdot E}{{Q}_{m} \cdot {N}_{L} \cdot {N}_{sc}^{RB}} ⌋$$

UCI blocks are mapped at PRB level.

$${N}_{sc}^{RB}$$

is the number of sub-carriers per resource block (e.g., 12)

### Or

$$Number of bits for UCI Type = {Q}_{m} \cdot {N}_{L} \cdot {N}_{sc}^{RB} \cdot round [ \frac{D \cdot E}{{Q}_{m} \cdot {N}_{L} \cdot {N}_{sc}^{RB}} ]$$

UCI blocks are mapped at PRB level.

$${N}_{sc}^{RB}$$

is the number of sub-carriers per resource block (e.g., 12).

In one example, D is a parameter that controls the code rate of the UCI-Type relative to the code rate of the UL-SCH data. In one example, the parameter, D, is configured and/or updated by RRC and/or MAC CE and/or La control (e.g. DCI Format) signaling. In one example, the parameter, D, is or is based on a beta-offset (or the multiplicative inverse of a beta offset). In one example, the parameter, D, determines the code rate of a UCI-Type. In one example, the parameter, D, can be derived based on one or more of other parameters such as (the UCI Type is that for which the number of bits is for UCI Type is being calculated):
The code rate of the PUSCH channel.
The payload size of the UCI Type block.
The payload size of UL-SCH transport block multiplexed with the UCI Type in a same PUSCH block or in same PUSCH.
The payload size of other UCI Types multiplexed with the UCI Type in a same PUSCH block, or in a same PUSCH.
The modulation order of PUSCH.
The UCI Type.
A priority index of the UCI Type.
A priority index of the UL-SCH transport block multiplexed with the UCI Type in a same PUSCH block or in same PUSCH.
A priority index of other UCI Types multiplexed with the UCI Type in a same PUSCH block, or in a same PUSCH.
A parameter configured and/or updated by higher layer to control the code rate of the UCI Type.
A parameter configured and/or updated by higher layer to control the code rate of the UL-SCH transport block multiplexed with the UCI Type in a same PUSCH block or in same PUSCH.
A parameter configured and/or updated by higher layer to control the code rate of other UCI Types multiplexed with the UCI Type in a same PUSCH block, or in a same PUSCH.

In one example, E is the payload size of a UCI-Type+ CRC size.

In one example, E is the payload size of a UCI-Type.

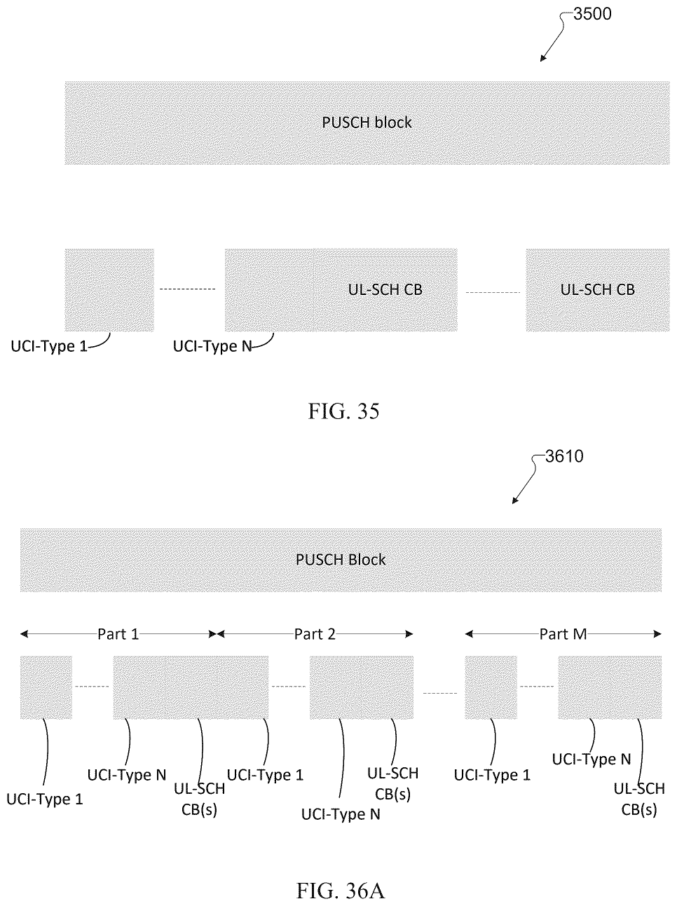

FIG. 35 illustrates a diagram of an example PUSCH block configuration 3500 according to embodiments of the present disclosure. For example, PUSCH block configuration 3500 can be implemented by any of the UEs 111-116 of FIG. 1, such as the UE 111. This example is for illustration only and other embodiments can be used without departing from the scope of the present disclosure.

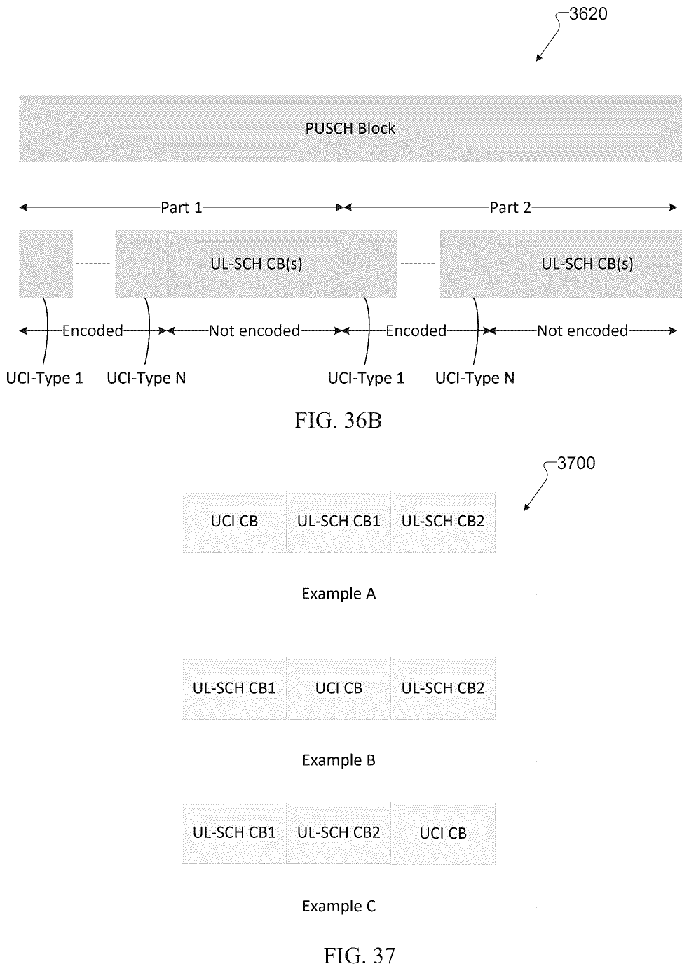

FIGS. 36A and 36B illustrate diagrams of example PUSCH block configurations 3610 and 3620 according to embodiments of the present disclosure. For example, PUSCH block configurations 3610 and 3620 can be implemented by any of the UEs 111-116 of FIG. 1, such as the UE 112. This example is for illustration only and other embodiments can be used without departing from the scope of the present disclosure.

In one example, the encoded UCI-Types are multiplexed before the encoded UL-SCH code block(s) as shown in FIG. 35 to generate a PUSCH block. In one example, the mapping order of the multiplexed PUSCH block can be across frequency resources first (across sub-carriers of a symbol starting with the smallest sub-carrier), then across time resources second (across symbols of PUSCH starting with the earliest symbol). The mapping of UCI is on the earliest symbols of the PUSCH allocation.

In one example, the UCI bits for each UCI-Type and the UL-SCH bits (TB bit(s)) are split into M-parts, wherein each part of UCI-Type or UL-SCH is encoded to generate corresponding one or more blocks. The encoded UCI-Types are multiplexed with the UL-SCH code blocks in each part as shown in FIG. 36A to generate a PUSCH block.

In one example, the UCI bits for each UCI-Type and the UL-SCH bits (TB bit(s)) are split into 2-parts (e.g., first frequency hop and second frequency hop), wherein each part of UCI-Type or UL-SCH is encoded to generate corresponding one or more blocks. The encoded UCI-Types are multiplexed with the UL-SCH codeblocks as shown in FIG. 36B to generate a PUSCH block.

In one example, M=2, as illustrated in FIG. 36B, for example there are two parts corresponding to two frequency hops and the parts are equal or almost equal (e.g., due to rounding to an integer), wherein each part can correspond to a frequency hop. In one example, the mapping order of the multiplexed PUSCH block can be across frequency resources first (across sub-carriers of a symbol starting with the smallest sub-carrier), then across time resources second (across symbols of PUSCH starting with the earliest symbol), then across frequency hops. The mapping of UCI is on the earliest symbols of the PUSCH allocation in each frequency hop.

In one example, the multiplexing order of UCI-Type1, UCI-Type2, . . . . UCI-TypeN can be configured and/or updated by RRC and/or MAC CE and/or L1 control (e.g., DCI Format) signaling. In one example, this configuration can be by a parameter or field with a range of factorial N (N!) (e.g., from 0 to N!−1), e.g. as shown in Table 6 for N=3. In one example, only a subset of the alternatives of Table 6 is configured. In one example, the parameter or the field can be included in the PUSCH transmission. In one example, the parameter or the field can be included in an UL transmission associated with the PUSCH transmission. In one example, the parameter or the field can be included in a DCI scheduling the PUSCH transmission. In one example, the parameter or the field can be configured and/or updated by higher layers e.g., RRC message or MAC CE message.

TABLE 6

| Parameter or field value | Multiplexing order |
|---|---|
| 0 | UCI-Type1 −> UCI-Type2 −> UCI-Type3 |
| 1 | UCI-Type1 −> UCI-Type3 −> UCI-Type2 |
| 2 | UCI-Type2 −> UCI-Type1 −> UCI-Type3 |
| 3 | UCI-Type2 −> UCI-Type3 −> UCI-Type1 |
| 4 | UCI-Type3 −> UCI-Type1 −> UCI-Type2 |
| 5 | UCI-Type3 −> UCI-Type2 −> UCI-Type1 |

In one example, the multiplexing order of the UCI-Types can depend on PUSCH configuration, for example based on whether the PUSCH has a front-loaded DMRS or not, or on the location of the first DMRS. In one example, with a front-loaded DMRS, the multiplexing order can be (for N=3), UCI-Type1 (e.g., ACK)->UCI-Type2 (e.g., CSI-part1)->UCI-Type3 (e.g. CSI-part2), and with no front-loaded DMRS, the multiplexing order can be (for N=3), UCI-Type2 (e.g., CSI-part1)->UCI-Type3 (e.g., CSI-part2)->UCI-Type1 (e.g. ACK).

In one example, the multiplexing order of UCI-Type1, UCI-Type2, . . . . UCI-TypeN and UL-SCH can be configured and/or updated by RRC and/or MAC CE and/or L1 control (e.g., DCI Format) signaling. In one example, this configuration can be by a parameter or field with range factorial (N+1) ((N+1)!) (e.g., from 0 to (N+1)!−1), e.g. as shown in Table 7 for N=2. In one example, only a subset of the alternatives of Table 7 is configured. In one example, the parameter or the field can be included in the PUSCH transmission. In one example, the parameter or the field can be included in an UL transmission associated with the PUSCH transmission. In one example, the parameter or the field can be included in a DCI scheduling the PUSCH transmission. In one example, the parameter or the field can be configured and/or updated by higher layers e.g., RRC message or MAC CE message.

TABLE 7

| Parameter or field value | Multiplexing order |
|---|---|
| 0 | UCI-Type1 −> UCI-Type2 −> UL-SCH |
| 1 | UCI-Type1 −> UL-SCH −> UCI-Type2 |
| 2 | UCI-Type2 −> UCI-Type1 −> UL-SCH |
| 3 | UCI-Type2 −> UL-SCH −> UCI-Type1 |
| 4 | UL-SCH −> UCI-Type1 −> UCI-Type2 |
| 5 | UL-SCH −> UCI-Type2 −> UCI-Type1 |

FIG. 37 illustrates diagrams of example of multiplexing UL-SCH and UCI types 3700 according to embodiments of the present disclosure. For example, multiplexing 3700 can be utilized by any of the UEs 111-116 of FIG. 1, such as the UE 113. This example is for illustration only and other embodiments can be used without departing from the scope of the present disclosure.

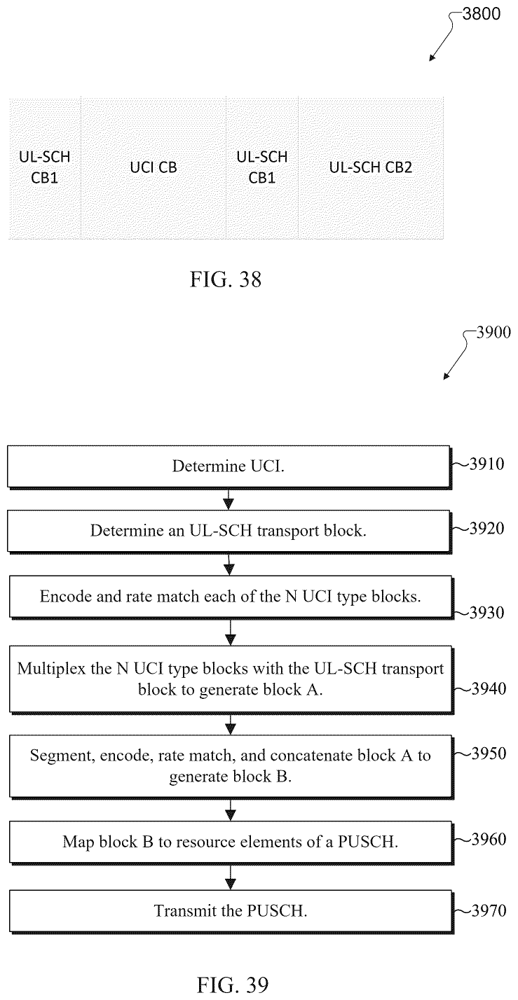

FIG. 38 illustrates a diagram of an example of multiplexing UL-SCH and UCI type 3800 according to embodiments of the present disclosure. For example, multiplexing 3800 can be utilized by any of the UEs 111-116 of FIG. 1, such as the UE 114. This example is for illustration only and other embodiments can be used without departing from the scope of the present disclosure.

In one example, a UCI type can be multiplex at a starting position in the PUSCH block determined by the location of the first DMRS symbol, or the first non-DMRS symbol after the first block of DMRS symbols. In one example, a UCI type can be multiplexed in between or before or after UL-SCH code block as shown in FIG. 37. In the example, of FIG. 37, there is one UCI code block and two UL-SCH codeblocks mapped to the PUSCH channel (e.g., to the layers corresponding to one codeword of the PUSCH channel). In one example (Example A of FIG. 37), the UCI codeblock is followed by the first UL-SCH codeblock and is then followed by the second UL-SCH codeblock. In one example (Example B of FIG. 37), the first UL-SCH codeblock is followed by the UCI codeblock and is then followed by the second UL-SCH codeblock. In one example (Example C of FIG. 37), the first UL-SCH codeblock is followed by the second UL-SCH codeblock and is then followed by the UCI codeblock. In one example, the UCI codeblock(s) can be multiplexed close to or right after DMRS symbols (or first DMRS symbols). In one example, UCI codeblock are multiplexed at the start of the PUSCH. In this disclosure multiplexing of codeblocks can refer to concatenation of codeblocks.

In one example, let the number of UL-SCH codeblocks to be concatenated be C0, where the bits of the rth codeblock for UL-SCH is f0ᵣₖ, wherein r=0, 1, . . . . C0−1, and k=0, 1, . . . , E0ᵣ−1 and E0ᵣ is the number of bits for UL-SCH codeblock r.

In one example, let the number of UCI Type-n codeblocks to be concatenated be Cn, where the bits of the rth codeblock for UCI Type-n is fnᵣₖ, wherein r=0, 1, . . . . Cn−1, and k=0, 1, . . . , Enᵣ−1 and Enᵣ is the number of bits for UCI type-n codeblock r, and where n=1, . . . . N, and N is the number of UCI-Types.

Let the total number of codeblocks to be multiplexed or concatenated be:

$$C = {\sum }_{n = 0}^{N} Cn$$

The multiplexing of codeblocks can be according to the following example:

Set k=0 (e.g., index of bit at the output of the multiplexing block). Set r₀=0, r₁=0, . . . , r_{N}=0, (e.g., index of codeblock being multiplexed for UL-SCH (n=0), and UCI-Type-n for n=1, . . . , N respectively). Set r=0 (e.g., index of output codeblock)

```
While r < C
  Find next codeblock type to multiplexed or concatenated, set n to equal 0 for UL-SCH or the
  UCI-Type being multiplexed.
  Set j = 0 (e.g., index of bit in codeblock being multiplexed or concatenated.)
  While j < Enᵣ
    gₖ = fnᵣ_{ₙ}ⱼ
    k = k + 1
    j = j + 1
  End while
  r = r + 1
  rₙ = rₙ + 1
End while
```

In a variant example, the multiplexing or concatenation is at the coded modulation symbol level, e.g., fnᵣₖ are coded modulation symbols, with modulation order Qₘ. In one example, Enᵣ is a multiple of Qₘ for n=0, 1, . . . . N.

In a variant example, the multiplexing or concatenation is at the coded modulation symbol level across N_{L} layers, e.g., fnᵣₖ are coded modulation symbols cross N_{L} layers, with modulation order Qₘ, and N_{L} is the number of layers (e.g., of PUSCH or the codeword of PUSCH on which the UCI is being multiplexed or concatenated). In one example, Enᵣ is a multiple of Qₘ·N_{L} for n=0, 1, . . . . N.

In one example, in case of frequency hopping, e.g., across two frequency hops, the number of codeblocks for UL-SCH and each UCI-Type-n is even, wherein half the codeblocks, for UL-SCH and for each UCI-Type-n, are mapped to the first frequency hop and the second half of the codeblocks, for UL-SCH and for each UCI-Type-n, are mapped to the second frequency hop.

In one example, in case of frequency hopping, e.g., across M frequency hops, the number of codeblocks for UL-SCH and each UCI-Type-n is a multiple of M, wherein a first 1/M of the codeblocks, for UL-SCH and for each UCI-Type-n, are mapped to a first frequency hop and a second 1/M of the codeblocks, for UL-SCH and for each UCI-Type-n, are mapped to a second frequency hop,

. . .

In one example UCI type can be multiplexed in the middle (or inside) of a UL-SCH code block as shown in FIG. 38. In the example, of FIG. 38, there is one UCI code block and two UL-SCH codeblocks mapped to the PUSCH channel (e.g., to the layers corresponding to one codeword of the PUSCH channel). The UCI codeblock is mapped in the middle (or inside) of the first UL-SCH codeblock, e.g, after m bits of the first UL-SCH codeblock. In one example, m is a multiple of Qₘ, wherein Qₘ is the modulation order. In one example, m is a multiple of Qₘ·N_{L}, wherein Qₘ is the modulation order and N_{L} is the number of layers (e.g., of PUSCH or the codeword of PUSCH on which the UCI is being multiplexed or concatenated). In one example, m depends on the location of a DMRS, e.g., first DMRS of PUISCH. In one example, m is configured or indicated to the UE, or is determined based on a configured or indicated parameter. In one example, the UCI codeblock(s) can be multiplexed or concatenated close to or right after DMRS symbols (or first DMRS symbols). In one example, UCI codeblock are multiplexed or concatenated at the start of the PUSCH.

In a variant example, the multiplexing or concatenation is at the coded modulation symbol level, e.g., fnᵣₖ are coded modulation symbols, with modulation order Qₘ. In one example Enᵣ is a multiple of Qₘ for n=0, 1, . . . . N.

In a variant example, the multiplexing or concatenation is at the coded modulation symbol level across N_{L} layers, e.g., fnᵣₖ are coded modulation symbols cross N_{L} layers, with modulation order Qₘ, and N_{L} is the number of layers (e.g., of PUSCH or the codeword of PUSCH on which the UCI is being multiplexed or concatenated). In one example, Enᵣ is a multiple of Qₘ·N_{L} for n=0, 1, . . . . N.

In one example, with no frequency hopping and N=3:
Let the number of UCI-Type1 bits at the input to the multiplexing block of FIG. 34 be N_{UCI1}.
Let the number of UCI-Type2 bits at the input to the multiplexing block of FIG. 34 be N_{UCI2}.
Let the number of UCI-Type3 bits at the input to the multiplexing block of FIG. 34 be N_{UCI3}.
Let the number of UL-SCH bits at the input to the multiplexing block of FIG. 34 be N_{ULSCH1}.
Let the number of REs of a PUSCH channel be N_{PUSCH}. In one example, N_{UCI1}1+N_{UCI}2+N_{UCI}3+N_{ULSCH1}=Qₘ·N_{L}·N_{PUSCH}.

In one example, let the number of REs of a PUSCH channel before the first non-DMRS symbol after first block of DMRS symbols be N_{PUSCH1}. In one example, let the number of REs of a PUSCH channel before the first DMRS symbol be N_{PUSCH1}.

In one example, UCI-Type1 is multiplexed in the PUSCH block starting from the first RE of a first non-DMRS symbol after a first block of DMRS symbols, i.e., UCI-Type1 is multiplexed starting from bit position Qₘ·N_{L}·N_{PUSCH1}. Then UCI-Type2 followed by UCI-Type3 are multiplexed starting from the beginning of the PUSCH block, but skipping over bits or REs already assigned to UCI-Type1 or DMRS, then UL-SCH is assigned to the remaining bits or REs of the PUSCH block.

In one example, UCI-Type1 is multiplexed in the PUSCH block starting at bit position “x” such that “x” is at the end of a UL-SCH CB or UCI code block, and “x” is the nearest bit position to Qₘ·N_{L}·N_{PUSCH1}, or “x” is the first bit position before Qₘ·N_{L}·N_{PUSCH1}, or “x” is the first bit position after Qₘ·N_{L}·N_{PUSCH1}.

In one example, if the number of resource elements allocated to PUSCH is N_{RE}, for example,

$${N}_{RE} = {N}_{sc}^{PUSCH} \cdot {N}_{sym}^{PUSCH} ,$$

wherein

$${N}_{sc}^{PUSCH}$$

is the number of sub-carriers allocated to PUSCH (e.g., the product of the number of RBs allocated to PUSCH and the number of sub-carriers per PRB), and

$${N}_{sym}^{PUSCH}$$

is the number of symbols allocated to PUSCH.

In one example, N_{RE-Data} is the number of REs available for transmission of data (e.g., UCI and UL-SCH). In one example, N_{RE-Data}=N_{RE}−N_{RE-DMRS}, Wherein N_{RE-DMRS} is the number of REs used for DMRS including REs used for DMRS CDM groups without data. In one example, N_{RE-Data}=N_{RE}−N_{RE-DMRS}−Nₒₕ, wherein N_{RE-DMRS} is the number of REs used for DMRS including REs used for DMRS CDM groups without data, and Non is the overhead REs, e.g., used for phase tracking reference signal (PTRS). In one example, number of code bits available for transmission of data is given by N_{cbits-Data}=Qₘ·N_{L}·N_{RE-Data}, wherein Qₘ is the number of bits per modulation symbol as mentioned herein, N_{L} is the number of layers for a PUSCH block.

In one example, a modulation-coding-scheme is signaled in a DCI Format or configured by higher layers to determine the modulation scheme (e.g., Qₘ) and a code rate R, wherein the code rate can be defined as:

$$R = \frac{Number of uncoded bits}{Number of coded bits}$$

Number of coded UL-SCH bits can be given by:

$${N}_{ULSCH} = {N}_{cbits - Data} - {\sum }_{i = 1}^{N} {N}_{UCI - i}$$

The UL-SCH transport block size is approximately given by:

$${N}_{ULSCH - TB} ≅ R ( {N}_{cbits - Data} - {\sum }_{i = 1}^{N} {N}_{UCI - i} )$$

N_{ULSCH-TB} can be used to determine the UL-SCH transport block size. In one example, to determine the UL-SCH transport block size, the transport block CRC size is further subtracted from N_{ULSCH-TB}. In one example, to determine the UL transport block size, the CRC size of the code blocks is further subtracted from N_{ULSCH-TB}. In one example, to determine the UL transport block size, the CRC size of the transport block and code blocks is further subtracted from N_{ULSCH-TB}.

In one example, the equations mentioned herein are for initial PUSCH transmission.

In one example, N_{RE-Data} is the number of REs available for transmission of data (e.g., UL-SCH). In one example, N_{RE-Data}=N_{RE}−N_{RE-DMRS}−Nₒₕ, wherein N_{RE-DMRS} is the number of REs used for DMRS including REs used DMRS CDM groups without data, Non can represent REs used for transmissions other than UL-SCH and DMRS for example UCI. In one example, number of code bits available for transmission of data is given by N_{cbits-Data}=Qₘ·N₁·N_{RE-Data}, wherein Qₘ is the number of bits per modulation symbol as mentioned herein and N_{L} is the number of layers for a PUSCH block.

In one example, a modulation-coding-scheme is signaled in a DCI Format or configured by higher layers to determine the modulation scheme (e.g., Qₘ) and a code rate R, wherein the code rate can be defined as:

$$R = \frac{Number of uncoded bits}{Number of coded bits}$$

In one example, the number of uncoded bits, N_{ucbits-Data}, is given by N_{ucbits-Data}=R. N_{cbits-Data}, wherein the uncoded bits can be the UL-SCH bits.

$${N}_{ucbits - Data} = {N}_{ULSCH - TB}$$

### Therefore,

$${N}_{ULSCH - TB} ≅ R \cdot {N}_{cbits - Data}$$

N_{ULSCH-TB} can be used to determine the UL-SCH transport block size. In one example, to determine the UL transport block size, the transport block CRC size is further subtracted from N_{ULSCH-TB}. In one example, to determine the UL transport block size, the CRC size of the code blocks is further subtracted from N_{ULSCH-TB}. In one example, to determine the UL transport block size, the CRC size of the transport block and code blocks is further subtracted from N_{ULSCH-TB}.

In one example, the number of UCI bits at input to the multiplexer is equal to:

$${\sum }_{i = 1}^{N} {N}_{UCI - i} = {Q}_{m} \cdot {N}_{L} \cdot {N}_{oh} .$$

In one example, if

$${\sum }_{i = 1}^{N} {N}_{UCI - i} > {Q}_{m} \cdot {N}_{L} \cdot {N}_{oh} ,$$

UCI reports are dropped until

$${\sum }_{i = 1}^{N} {N}_{UCI - i} \leq {Q}_{m} \cdot {N}_{L} \cdot {N}_{oh} ,$$

the dropped UCI reports can be in ascending priority order, starting with the lowest priority reports being dropped first.

In one example, if

$${\sum }_{i = 1}^{N} {N}_{UCI - i} > {Q}_{m} \cdot {N}_{L} \cdot {N}_{oh} ,$$

a beta-offset parameter corresponding to a UCI-type (e.g., UCI-type with lowest priority, e.g., CSI-part2) is lowered to a lower configured value or values until

$${\sum }_{i = 1}^{N} {N}_{UCI - i} \leq {Q}_{m} \cdot {N}_{L} \cdot {N}_{oh} .$$

If that condition can't be satisfied then either beta-offset values for other UCI-types are lowered or UCI reports for that UCI type are dropped in ascending priority order, until condition is satisfied.

In one example, code blocks of UL-SCH have equal size, or almost equal size, within “one” bit for rounding. In one example, the code block(s) for UCI-Type(s) can have different size than the code block(s) of UL-SCH. In one example, as illustrated in FIG. 35, the mapping of the UCI is to the earliest code blocks of a PUSCH transmission. In one example, as illustrated in FIG. 36A and FIG. 36B, the mapping of the UCI is to the earliest code blocks of a PUSCH transmission in each frequency hop.

In one example, an information block can be appended to the PUSCH with a fixed size to provide information about the structure (e.g., number of code blocks for UL-SCH and different UCI Types and size of code blocks) of the PUSCH block.

With regards to a retransmission of a PUSCH block, the following examples can apply:
In one example, UCI bits transmitted in an initial PUSCH transmission are retransmitted in a corresponding PUSCH re-transmission.
In one example, if the number of UCI bits in an initial PUSCH transmission at the input to the multiplexing block of FIG. 34 is N_{UCI}, the number of UCI bits in a corresponding PUSCH re-transmission at the input to the multiplexing block of FIG. 34 is N_{UCI}. In one example the UCI bits in the PUSCH retransmission can be different from the UCI bit of the corresponding initial PUSCH transmission.
In one example, if N_{UCI} of the initial PUSCH transmission is larger than N_{UCI} of corresponding re-transmission, one of the following examples can apply:
   Bits are padded to the PUSCH re-transmission to have the same N_{UCI} as that of the corresponding initial PUSCH transmission.
   Code blocks containing UL-SCH in the re-transmission have the same input bits as the corresponding code blocks of the corresponding initial PUSCH transmission. Other code blocks with UCI can have different input bits, including number of input bits.

In one example, if N_{UCI} of the initial PUSCH transmission is smaller than N_{UCI} of corresponding re-transmission, one of the following examples can apply:
Bits are drop from UCI of the re-transmission PUSCH, in order of priority as mentioned herein, to have the same N_{UCI} as that of the corresponding initial PUSCH transmission.
For code blocks containing UL-SCH with different number of UCI bits than initial transmission, UCI bits are dropped so as not to exceed the initial code rate on PUSCH, or so as not to exceed a second code rate for retransmissions on PUSCH. The remaining code blocks containing UL-SCH have the same input bits as the corresponding code blocks of the corresponding initial PUSCH transmission. Other code blocks with UCI can have different input bits, including number of input bits.

FIG. 39 illustrates an example method 3900 performed by a UE in a wireless communication system according to embodiments of the present disclosure. The method 3900 of FIG. 39 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 3900 is for illustration only and other embodiments can be used without departing from the scope of the present disclosure.

The method 3900 begins with the UE determining UCI (3910). For example, in 3910 the UCI is organized into N UCI type blocks, where N≥1 and each of the N UCI type blocks include one or more UCIs. The UE then determines an UL-SCH transport block (3920). The UE then encodes and rate matches each of the N UCI type blocks (3930). The UE then multiplexes the N UCI type blocks with the UL-SCH transport block to generate block A (3940).

The UE then segments, encodes, rates match, and concatenates block A to generate block B (3950). The UE then maps block B to resource elements of a PUSCH (3960). The UE then transmits the PUSCH (3970).

In various embodiments, a size of an encoded and rated match information block n is based on a size of UCI type block n and a parameter indicating a relative code rate between UCI type block n and the UL-SCH transport block.

In various embodiments, the UE divides the N UCI type blocks into a first part and a second part and divides the UL-SCH transport block into a first part and a second part. The UE then transmits a portion of block B corresponding to the first part of the N UCI type blocks and the first part of the UL-SCH transport block in a first frequency hop of the PUSCH and a portion of block B corresponding to the second part of the N UCI type blocks and the second part of the UL-SCH transport block in a second frequency hop of the PUSCH.

In various embodiments, the UE receives information indicating a multiplexing order of the N UCI type blocks. In various embodiments, the UE determines a starting position of each encoded and rated matched UCI type block n within block A, the starting position is based on a position of a first demodulation reference signal (DM-RS) symbol in the PUSCH.

In various embodiments, the UE determines M UCI code blocks, determines K UL-SCH code blocks, determines a multiplexing order of the M UCI code blocks and the K UL-SCH code blocks, and multiplexes the M UCI code blocks and the K UL-SCH code blocks according to the multiplexing order to generate block B.

In various embodiments, the UE multiplexes a UCI code block m, for m=1, . . . , M, within a UL-SCH code block k, for k=1, . . . , K, the multiplexing of UCI code block m starts at a bit position b within UL-SCH code block k, and the bit position b is a multiple of a product of a modulation order and a number of transmission layers of the PUSCH.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a processor configured to:
determine uplink control information (UCI), wherein:
the UCI is organized into N UCI type blocks, where N≥1, and
each of the N UCI type blocks includes one or more UCIs,
determine an uplink shared channel (UL-SCH) transport block,
encode and rate match each of the N UCI type blocks,
multiplex the encoded and rate matched N UCI type blocks with the UL-SCH transport block to generate block A, and
segment, encode, rate match and concatenate block A to generate block B; and
a transceiver operably coupled to the processor, the transceiver configured to:
map block B to resource elements of a physical uplink shared channel (PUSCH), and
transmit the PUSCH.

2. The UE of claim 1, wherein a size of an encoded and rated match information block n is based on:
a size of UCI type block n, and
a parameter indicating a relative code rate between UCI type block n and the UL-SCH transport block.

3. The UE of claim 1, wherein:
the processor is further configured to:
divide each of the N UCI type blocks into a first part and a second part, and
divide the UL-SCH transport block into a first part and a second part, and
the transceiver is further configured to transmit:
a portion of block B corresponding to the first part of each of the N UCI type blocks and the first part of the UL-SCH transport block in a first frequency hop of the PUSCH, and
a portion of block B corresponding to the second part of each of the N UCI type blocks and the second part of the UL-SCH transport block in a second frequency hop of the PUSCH.

4. The UE of claim 1, wherein the transceiver is further configured to receive information indicating a multiplexing order of the N UCI type blocks.

5. The UE of claim 1, wherein:
the processor is further configured to determine a starting position of each encoded and rated matched UCI type block n within block A, and
the starting position is based on a position of a first demodulation reference signal (DM-RS) symbol in the PUSCH.

6. The UE of claim 1, wherein the processor is further configured to:
determine M UCI code blocks,
determine K UL-SCH code blocks,
determine a multiplexing order of the M UCI code blocks and the K UL-SCH code blocks, and
multiplex the M UCI code blocks and the K UL-SCH code blocks according to the multiplexing order to generate block B.

7. The UE of claim 1, wherein
the processor is further configured to multiplex a UCI code block m, for m=1, . . . , M, within a UL-SCH code block k, for k=1, . . . , K,
the multiplexing of UCI code block m starts at a bit position b within UL-SCH code block k, and
the bit position b is a multiple of a product of a modulation order and a number of transmission layers of the PUSCH.

8. A base station (BS), comprising:
a transceiver configured to:
receive a physical uplink control channel (PUSCH), and
extract from the PUSCH a block B corresponding to uplink control information (UCI); and
a processor operably coupled to the transceiver, the processor configured to:
de-concatenate, de-rate match, decode and de-segment, block B to generate block A,
de-multiplex block A to generate N UCI type blocks and an uplink shared channel (UL-SCH) transport block,
de-rate match and decode each of the N UCI type blocks, and
extract one or more UCIs from each of the de-rate matched and decoded N UCI type blocks.

9. The BS of claim 8, wherein a size of an encoded and rated match information block n is based on:
a size of UCI type block n, and
a parameter indicating a relative code rate between UCI type block n and the UL-SCH transport block.

10. The BS of claim 8, wherein:
the transceiver is further configured to receive:
a portion of block B corresponding to a first part of each of the N UCI type blocks and a first part of the UL-SCH transport block in a first frequency hop of the PUSCH, and
a portion of block B corresponding to a second part of each of the N UCI type blocks and a second part of the UL-SCH transport block in a second frequency hop of the PUSCH; and
the processor is further configured to:
combine the first part of a UCI type block and the second part of the corresponding UCI type block to generate the corresponding UCI type block, and
combine the first part of UL-SCH transport block and the second part of UL-SCH transport block to generate UL-SCH transport block.

11. The BS of claim 8, wherein the transceiver is further configured to transmit information indicating a multiplexing order of the N UCI type blocks.

12. The BS of claim 8, wherein:
the processor is further configured to determine a starting position of each encoded and rated matched UCI type block n within block A, and
the starting position is based on a position of a first demodulation reference signal (DM-RS) symbol in the PUSCH.

13. The BS of claim 8, wherein the processor is further configured to:
determine M UCI code blocks,
determine K UL-SCH code blocks,
determine a multiplexing order of the M UCI code blocks and the K UL-SCH code blocks, and
de-multiplex block B to generate the M UCI code blocks and the K UL-SCH code blocks according to the multiplexing order.

14. The BS of claim 8, wherein
the processor is further configured to de-multiplex a UCI code block m, for m=1, . . . , M, within a UL-SCH code block k, for k=1, . . . , K,
the de-multiplexing of UCI code block m starts at a bit position b within UL-SCH code block k, and
the bit position b is a multiple of a product of a modulation order and a number of transmission layers of the PUSCH.

15. A method of operating a user equipment (UE), the method comprising:
determining uplink control information (UCI), wherein:
the UCI is organized into N UCI type blocks, where N≥1, and
each of the N UCI type blocks include one or more UCIs;
determining an uplink shared channel (UL-SCH) transport block;
encoding and rate matching each of the N UCI type blocks;
multiplexing the encoded and rate matched N UCI type blocks with the UL-SCH transport block to generate block A;
segmenting, encoding, rating match and concatenating block A to generate block B;
mapping block B to resource elements of a physical uplink shared channel (PUSCH); and
transmitting the PUSCH.

16. The method of claim 15, wherein a size of an encoded and rated match information block n is based on:
a size of UCI type block n, and
a parameter indicating a relative code rate between UCI type block n and the UL-SCH transport block.

17. The method of claim 15, wherein the method further comprises:
dividing each of the N UCI type blocks into a first part and a second part,
dividing the UL-SCH transport block into a first part and a second part,
transmitting a portion of block B corresponding to the first part of each of the N UCI type blocks and the first part of the UL-SCH transport block in a first frequency hop of the PUSCH, and
transmitting a portion of block B corresponding to the second part of each of the N UCI type blocks and the second part of the UL-SCH transport block in a second frequency hop of the PUSCH.

18. The method of claim 15, further comprising determining a starting position of each encoded and rated matched UCI type block n within block A,
wherein the starting position is based on a position of a first demodulation reference signal (DM-RS) symbol in the PUSCH.

19. The method of claim 15, further comprising:
determining M UCI code blocks;
determining K UL-SCH code blocks;
determining a multiplexing order of the M UCI code blocks and the K UL-SCH code blocks; and
multiplexing the M UCI code blocks and the K UL-SCH code blocks according to the multiplexing order to generate block B.

20. The method of claim 15, further comprising multiplexing a UCI code block m, for m=1, . . . , M, within a UL-SCH code block k, for k=1, . . . , K,
wherein the multiplexing of UCI code block m starts at a bit position b within UL-SCH code block k, and
wherein the bit position b is a multiple of a product of a modulation order and a number of transmission layers of the PUSCH.
